(19) United States
(12) Patent Application Publication
(10) Pub. No.: US 2026/0367857 A1
(43) Pub. Date: Nov. 19, 2026

(54) USER INTERFACES FOR INTERACTING WITH A SECONDARY DISPLAY

(71) Applicant: Apple Inc., Cupertino, CA (US)

(72) Inventor: Richard R. DELLINGER, San Jose, CA (US)

(21) Appl. No.: 19/679,099

(22) Filed: May 15, 2026

Related U.S. Application Data
(60) Provisional application No. 63/819,872, filed on Jun. 8, 2025.
(60) Provisional application No. 63/808,522, filed on May 19, 2025.

(51) Int. Cl. G06F 3/14; G06F 3/0482; G06F 3/0484

(52) U.S. Cl. CPC G06F 3/1454; G06F 3/0482; G06F 3/0484

(57) ABSTRACT

The present disclosure generally relates to user interfaces. In some embodiments, the user interfaces are displayed on a secondary display.

### CROSS-REFERENCE TO RELATED APPLICATIONS

This application claims priority to U.S. Patent Application No. 63/819,872, entitled “USER INTERFACES FOR INTERACTING WITH A SECONDARY DISPLAY,” filed on Jun. 8, 2025, and U.S. Patent Application No. 63/808,522, entitled “USER INTERFACES FOR INTERACTING WITH A SECONDARY DISPLAY,” filed on May 19, 2025, the content of which is hereby incorporated by reference in its entirety.

### FIELD

The present disclosure relates generally to computer user interfaces, and more specifically to techniques for managing processes related to a secondary display.

### BACKGROUND

Computer systems often include an integrated display. Some computer systems additionally communicate with a secondary display, optionally displaying information using the secondary display.

### BRIEF SUMMARY

Some techniques for managing processes related to secondary displays using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for managing processes related to secondary displays. Such methods and interfaces optionally complement or replace other methods for managing processes related to secondary displays. Such methods and interfaces reduce the cognitive burden on a user and produce a more efficient human-machine interface. For battery-operated computing devices, such methods and interfaces conserve power and increase the time between battery charges.

In accordance with some embodiments, a method is described. The method is performed at a computer system that is in communication with a first set of one or more display generation components and one or more input devices. The method comprises: displaying, via the first set of one or more display generation components, a widget editing user interface that includes one or more options corresponding to a first stack of widgets and one or more options corresponding to a second stack of widgets, wherein a configuration of the first stack of widgets specifies an arrangement of the first stack of widgets when the first stack of widgets is displayed via a second set of one or more display generation components that is different from the first set of one or more display generation components, and wherein a configuration of the second stack of widgets, different from the configuration of the first stack of widgets, specifies an arrangement of the second stack of widgets when the second stack of widgets is displayed via the second set of one or more display generation components; while displaying the widget editing user interface, detecting, via the one or more input devices, a first set of one or more inputs; in response to detecting the first set of one or more inputs, modifying the configuration of the first stack of widgets to specify a modified arrangement of the first stack of widgets; while displaying the widget editing user interface, detecting, via the one or more input devices, a second set of one or more inputs; in response to detecting the second set of one or more inputs, modifying the configuration of the second stack of widgets to specify a modified arrangement of the second stack of widgets; and subsequent to detecting the first set of one or more inputs and the second set of one or more inputs, concurrently displaying, via the second set of one or more display generation components, the first stack of widgets using the modified arrangement of the first stack of widgets and the second stack of widgets using the modified arrangement of the second stack of widgets.

In accordance with some embodiments, a non-transitory computer-readable storage medium is described. The non-transitory computer-readable storage medium stores one or more programs configured to be executed by one or more processors of a computer system that is in communication with a first set of one or more display generation components and one or more input devices, the one or more programs including instructions for: displaying, via the first set of one or more display generation components, a widget editing user interface that includes one or more options corresponding to a first stack of widgets and one or more options corresponding to a second stack of widgets, wherein a configuration of the first stack of widgets specifies an arrangement of the first stack of widgets when the first stack of widgets is displayed via a second set of one or more display generation components that is different from the first set of one or more display generation components, and wherein a configuration of the second stack of widgets, different from the configuration of the first stack of widgets, specifies an arrangement of the second stack of widgets when the second stack of widgets is displayed via the second set of one or more display generation components; while displaying the widget editing user interface, detecting, via the one or more input devices, a first set of one or more inputs; in response to detecting the first set of one or more inputs, modifying the configuration of the first stack of widgets to specify a modified arrangement of the first stack of widgets; while displaying the widget editing user interface, detecting, via the one or more input devices, a second set of one or more inputs; in response to detecting the second set of one or more inputs, modifying the configuration of the second stack of widgets to specify a modified arrangement of the second stack of widgets; and subsequent to detecting the first set of one or more inputs and the second set of one or more inputs, concurrently displaying, via the second set of one or more display generation components, the first stack of widgets using the modified arrangement of the first stack of widgets and the second stack of widgets using the modified arrangement of the second stack of widgets.

In accordance with some embodiments, a transitory computer-readable storage medium is described. The transitory computer-readable storage medium stores one or more programs configured to be executed by one or more processors of a computer system that is in communication with a first set of one or more display generation components and one or more input devices, the one or more programs including instructions for: displaying, via the first set of one or more display generation components, a widget editing user interface that includes one or more options corresponding to a first stack of widgets and one or more options corresponding to a second stack of widgets, wherein a configuration of the first stack of widgets specifies an arrangement of the first stack of widgets when the first stack of widgets is displayed via a second set of one or more display generation components that is different from the first set of one or more display generation components, and wherein a configuration of the second stack of widgets, different from the configuration of the first stack of widgets, specifies an arrangement of the second stack of widgets when the second stack of widgets is displayed via the second set of one or more display generation components; while displaying the widget editing user interface, detecting, via the one or more input devices, a first set of one or more inputs; in response to detecting the first set of one or more inputs, modifying the configuration of the first stack of widgets to specify a modified arrangement of the first stack of widgets; while displaying the widget editing user interface, detecting, via the one or more input devices, a second set of one or more inputs; in response to detecting the second set of one or more inputs, modifying the configuration of the second stack of widgets to specify a modified arrangement of the second stack of widgets; and subsequent to detecting the first set of one or more inputs and the second set of one or more inputs, concurrently displaying, via the second set of one or more display generation components, the first stack of widgets using the modified arrangement of the first stack of widgets and the second stack of widgets using the modified arrangement of the second stack of widgets.

In accordance with some embodiments, a computer system is described. The computer system is configured to communicate with a first set of one or more display generation components and one or more input devices. The computer system comprises: one or more processors; and memory storing one or more programs configured to be executed by the one or more processors, the one or more programs including instructions for: displaying, via the first set of one or more display generation components, a widget editing user interface that includes one or more options corresponding to a first stack of widgets and one or more options corresponding to a second stack of widgets, wherein a configuration of the first stack of widgets specifies an arrangement of the first stack of widgets when the first stack of widgets is displayed via a second set of one or more display generation components that is different from the first set of one or more display generation components, and wherein a configuration of the second stack of widgets, different from the configuration of the first stack of widgets, specifies an arrangement of the second stack of widgets when the second stack of widgets is displayed via the second set of one or more display generation components; while displaying the widget editing user interface, detecting, via the one or more input devices, a first set of one or more inputs; in response to detecting the first set of one or more inputs, modifying the configuration of the first stack of widgets to specify a modified arrangement of the first stack of widgets; while displaying the widget editing user interface, detecting, via the one or more input devices, a second set of one or more inputs; in response to detecting the second set of one or more inputs, modifying the configuration of the second stack of widgets to specify a modified arrangement of the second stack of widgets; and subsequent to detecting the first set of one or more inputs and the second set of one or more inputs, concurrently displaying, via the second set of one or more display generation components, the first stack of widgets using the modified arrangement of the first stack of widgets and the second stack of widgets using the modified arrangement of the second stack of widgets.

In accordance with some embodiments, a computer system is described. The computer system is configured to communicate with a first set of one or more display generation components and one or more input devices. The computer system comprises: means for displaying, via the first set of one or more display generation components, a widget editing user interface that includes one or more options corresponding to a first stack of widgets and one or more options corresponding to a second stack of widgets, wherein a configuration of the first stack of widgets specifies an arrangement of the first stack of widgets when the first stack of widgets is displayed via a second set of one or more display generation components that is different from the first set of one or more display generation components, and wherein a configuration of the second stack of widgets, different from the configuration of the first stack of widgets, specifies an arrangement of the second stack of widgets when the second stack of widgets is displayed via the second set of one or more display generation components; means, while displaying the widget editing user interface, for detecting, via the one or more input devices, a first set of one or more inputs; means, responsive to detecting the first set of one or more inputs, for modifying the configuration of the first stack of widgets to specify a modified arrangement of the first stack of widgets; means, while displaying the widget editing user interface, for detecting, via the one or more input devices, a second set of one or more inputs; means, responsive to detecting the second set of one or more inputs, for modifying the configuration of the second stack of widgets to specify a modified arrangement of the second stack of widgets; and means, subsequent to detecting the first set of one or more inputs and the second set of one or more inputs, for concurrently displaying, via the second set of one or more display generation components, the first stack of widgets using the modified arrangement of the first stack of widgets and the second stack of widgets using the modified arrangement of the second stack of widgets.

In accordance with some embodiments, a computer program product is described. The computer program product comprises one or more programs configured to be executed by one or more processors of a computer system that is in communication with a first set of one or more display generation components and one or more input devices, the one or more programs including instructions for: displaying, via the first set of one or more display generation components, a widget editing user interface that includes one or more options corresponding to a first stack of widgets and one or more options corresponding to a second stack of widgets, wherein a configuration of the first stack of widgets specifies an arrangement of the first stack of widgets when the first stack of widgets is displayed via a second set of one or more display generation components that is different from the first set of one or more display generation components, and wherein a configuration of the second stack of widgets, different from the configuration of the first stack of widgets, specifies an arrangement of the second stack of widgets when the second stack of widgets is displayed via the second set of one or more display generation components; while displaying the widget editing user interface, detecting, via the one or more input devices, a first set of one or more inputs; in response to detecting the first set of one or more inputs, modifying the configuration of the first stack of widgets to specify a modified arrangement of the first stack of widgets; while displaying the widget editing user interface, detecting, via the one or more input devices, a second set of one or more inputs; in response to detecting the second set of one or more inputs, modifying the configuration of the second stack of widgets to specify a modified arrangement of the second stack of widgets; and subsequent to detecting the first set of one or more inputs and the second set of one or more inputs, concurrently displaying, via the second set of one or more display generation components, the first stack of widgets using the modified arrangement of the first stack of widgets and the second stack of widgets using the modified arrangement of the second stack of widgets.

In accordance with some embodiments, a method is described. The method is performed at a computer system that is in communication with one or more display generation components and one or more input devices. The method comprises: displaying, via the one or more display generation components, a map user interface; while displaying the map user interface, detecting, via the one or more input devices, a user input; in response to detecting the user input and in accordance with a determination that the user input corresponds to a first type of request, replacing display, via the one or more display generation components, of the map user interface with a widgets user interface, wherein the widgets user interface includes a plurality of stacks of widgets, including a first stack of widgets that includes a first plurality of widgets and a second stack of widgets that includes a second plurality of widgets that are different from the first plurality of widgets; while displaying the widgets user interface that includes the plurality of stacks of widgets, detecting, via the one or more input devices, a user input directed to a respective stack of widgets of the plurality of stacks of widgets; and in response to detecting the user input directed to a respective stack of widgets of the plurality of stacks of widgets: in accordance with a determination that the user input directed to the respective stack of widgets is directed to the first stack of widgets, updating display, via the one or more display generation components, of the first stack of widgets from a first widget of the first stack of widgets to a second widget of the first stack of widgets without updating display of the second stack of widgets from a first widget of the second stack of widgets to a second widget of the second stack of widgets; and in accordance with a determination that the user input directed to the respective stack of widgets is directed to the second stack of widgets, updating display, via the one or more display generation components, of the second stack of widgets from the first widget of the second stack of widgets to the second widget of the second stack of widgets without updating display of the first stack of widgets from the first widget of the first stack of widgets to the second widget of the first stack of widgets.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: displaying, via the one or more display generation components, a map user interface; while displaying the map user interface, detecting, via the one or more input devices, a user input; in response to detecting the user input and in accordance with a determination that the user input corresponds to a first type of request, replacing display, via the one or more display generation components, of the map user interface with a widgets user interface, wherein the widgets user interface includes a plurality of stacks of widgets, including a first stack of widgets that includes a first plurality of widgets and a second stack of widgets that includes a second plurality of widgets that are different from the first plurality of widgets; while displaying the widgets user interface that includes the plurality of stacks of widgets, detecting, via the one or more input devices, a user input directed to a respective stack of widgets of the plurality of stacks of widgets; and in response to detecting the user input directed to a respective stack of widgets of the plurality of stacks of widgets: in accordance with a determination that the user input directed to the respective stack of widgets is directed to the first stack of widgets, updating display, via the one or more display generation components, of the first stack of widgets from a first widget of the first stack of widgets to a second widget of the first stack of widgets without updating display of the second stack of widgets from a first widget of the second stack of widgets to a second widget of the second stack of widgets; and in accordance with a determination that the user input directed to the respective stack of widgets is directed to the second stack of widgets, updating display, via the one or more display generation components, of the second stack of widgets from the first widget of the second stack of widgets to the second widget of the second stack of widgets without updating display of the first stack of widgets from the first widget of the first stack of widgets to the second widget of the first stack of widgets.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: displaying, via the one or more display generation components, a map user interface; while displaying the map user interface, detecting, via the one or more input devices, a user input; in response to detecting the user input and in accordance with a determination that the user input corresponds to a first type of request, replacing display, via the one or more display generation components, of the map user interface with a widgets user interface, wherein the widgets user interface includes a plurality of stacks of widgets, including a first stack of widgets that includes a first plurality of widgets and a second stack of widgets that includes a second plurality of widgets that are different from the first plurality of widgets; while displaying the widgets user interface that includes the plurality of stacks of widgets, detecting, via the one or more input devices, a user input directed to a respective stack of widgets of the plurality of stacks of widgets; and in response to detecting the user input directed to a respective stack of widgets of the plurality of stacks of widgets: in accordance with a determination that the user input directed to the respective stack of widgets is directed to the first stack of widgets, updating display, via the one or more display generation components, of the first stack of widgets from a first widget of the first stack of widgets to a second widget of the first stack of widgets without updating display of the second stack of widgets from a first widget of the second stack of widgets to a second widget of the second stack of widgets; and in accordance with a determination that the user input directed to the respective stack of widgets is directed to the second stack of widgets, updating display, via the one or more display generation components, of the second stack of widgets from the first widget of the second stack of widgets to the second widget of the second stack of widgets without updating display of the first stack of widgets from the first widget of the first stack of widgets to the second widget of the first stack of widgets.

In accordance with some embodiments, a computer system is described. The computer system is configured to communicate with one or more display generation components and one or more input devices. The computer system comprises: one or more processors; and memory storing one or more programs configured to be executed by the one or more processors, the one or more programs including instructions for: displaying, via the one or more display generation components, a map user interface; while displaying the map user interface, detecting, via the one or more input devices, a user input; in response to detecting the user input and in accordance with a determination that the user input corresponds to a first type of request, replacing display, via the one or more display generation components, of the map user interface with a widgets user interface, wherein the widgets user interface includes a plurality of stacks of widgets, including a first stack of widgets that includes a first plurality of widgets and a second stack of widgets that includes a second plurality of widgets that are different from the first plurality of widgets; while displaying the widgets user interface that includes the plurality of stacks of widgets, detecting, via the one or more input devices, a user input directed to a respective stack of widgets of the plurality of stacks of widgets; and in response to detecting the user input directed to a respective stack of widgets of the plurality of stacks of widgets: in accordance with a determination that the user input directed to the respective stack of widgets is directed to the first stack of widgets, updating display, via the one or more display generation components, of the first stack of widgets from a first widget of the first stack of widgets to a second widget of the first stack of widgets without updating display of the second stack of widgets from a first widget of the second stack of widgets to a second widget of the second stack of widgets; and in accordance with a determination that the user input directed to the respective stack of widgets is directed to the second stack of widgets, updating display, via the one or more display generation components, of the second stack of widgets from the first widget of the second stack of widgets to the second widget of the second stack of widgets without updating display of the first stack of widgets from the first widget of the first stack of widgets to the second widget of the first stack of widgets.

In accordance with some embodiments, a computer system is described. The computer system is configured to communicate with one or more display generation components and one or more input devices. The computer system comprises: means for displaying, via the one or more display generation components, a map user interface; means, while displaying the map user interface, for detecting, via the one or more input devices, a user input; means, responsive to detecting the user input and in accordance with a determination that the user input corresponds to a first type of request, for replacing display, via the one or more display generation components, of the map user interface with a widgets user interface, wherein the widgets user interface includes a plurality of stacks of widgets, including a first stack of widgets that includes a first plurality of widgets and a second stack of widgets that includes a second plurality of widgets that are different from the first plurality of widgets; means, while displaying the widgets user interface that includes the plurality of stacks of widgets, for detecting, via the one or more input devices, a user input directed to a respective stack of widgets of the plurality of stacks of widgets; and means, responsive to detecting the user input directed to a respective stack of widgets of the plurality of stacks of widgets, for: in accordance with a determination that the user input directed to the respective stack of widgets is directed to the first stack of widgets, updating display, via the one or more display generation components, of the first stack of widgets from a first widget of the first stack of widgets to a second widget of the first stack of widgets without updating display of the second stack of widgets from a first widget of the second stack of widgets to a second widget of the second stack of widgets; and in accordance with a determination that the user input directed to the respective stack of widgets is directed to the second stack of widgets, updating display, via the one or more display generation components, of the second stack of widgets from the first widget of the second stack of widgets to the second widget of the second stack of widgets without updating display of the first stack of widgets from the first widget of the first stack of widgets to the second widget of the first stack of widgets.

In accordance with some embodiments, a computer program product is described. The computer program product comprises one or more programs configured to be executed by one or more processors of a computer system that is in communication with one or more display generation components and one or more input devices, the one or more programs including instructions for: displaying, via the one or more display generation components, a map user interface; while displaying the map user interface, detecting, via the one or more input devices, a user input; in response to detecting the user input and in accordance with a determination that the user input corresponds to a first type of request, replacing display, via the one or more display generation components, of the map user interface with a widgets user interface, wherein the widgets user interface includes a plurality of stacks of widgets, including a first stack of widgets that includes a first plurality of widgets and a second stack of widgets that includes a second plurality of widgets that are different from the first plurality of widgets; while displaying the widgets user interface that includes the plurality of stacks of widgets, detecting, via the one or more input devices, a user input directed to a respective stack of widgets of the plurality of stacks of widgets; and in response to detecting the user input directed to a respective stack of widgets of the plurality of stacks of widgets: in accordance with a determination that the user input directed to the respective stack of widgets is directed to the first stack of widgets, updating display, via the one or more display generation components, of the first stack of widgets from a first widget of the first stack of widgets to a second widget of the first stack of widgets without updating display of the second stack of widgets from a first widget of the second stack of widgets to a second widget of the second stack of widgets; and in accordance with a determination that the user input directed to the respective stack of widgets is directed to the second stack of widgets, updating display, via the one or more display generation components, of the second stack of widgets from the first widget of the second stack of widgets to the second widget of the second stack of widgets without updating display of the first stack of widgets from the first widget of the first stack of widgets to the second widget of the first stack of widgets.

In accordance with some embodiments, a method is described. The method is performed at a computer system that is in communication with a first set of one or more display generation components and one or more input devices. The method comprises: detecting, via the one or more input devices, a request to display a user interface of a respective application; in response to detecting the request to display the user interface of the respective application: displaying, via the first set of one or more display generation components, a user interface of the respective application; in accordance with a determination that a set of one or more criteria is met, including a display criterion that is met when the computer system is in communication with a second set of one or more display generation components that are different from the first set of one or more display generation components, displaying, via the first set of one or more display generation components, an eligibility indication that indicates that visual media of the respective application are eligible to be displayed via the second set of one or more display generation components; and in accordance with a determination that the set of one or more criteria is not met, forgoing display, via the first set of one or more display generation components, of the eligibility indication; while displaying, via the first set of one or more display generation components, the eligibility indication, detecting a request to initiate playback of a first visual media using the respective application; in response to detecting the request to initiate playback of the first visual media using the respective application: displaying, via the first set of one or more display generation components, playback of visual content of the first visual media using the respective application; and displaying, via the first set of one or more display generation components, a playback indication, different from the eligibility indication, that indicates that playback of the visual content the first visual media can be displayed via the second set of one or more display generation components; while displaying, via the first set of one or more display generation components, the playback indication, detecting, via the one or more input devices, an input directed to the playback indication; and in response to detecting the input directed to the playback indication: ceasing to display, via the first set of one or more display generation components, playback of the visual content of the first visual media; and displaying, via the second set of one or more display generation components, playback of the visual content of the first visual media.

In accordance with some embodiments, a non-transitory computer-readable storage medium is described. The non-transitory computer-readable storage medium stores one or more programs configured to be executed by one or more processors of a computer system that is in communication with a first set of one or more display generation components and one or more input devices, the one or more programs including instructions for: detecting, via the one or more input devices, a request to display a user interface of a respective application; in response to detecting the request to display the user interface of the respective application: displaying, via the first set of one or more display generation components, a user interface of the respective application; in accordance with a determination that a set of one or more criteria is met, including a display criterion that is met when the computer system is in communication with a second set of one or more display generation components that are different from the first set of one or more display generation components, displaying, via the first set of one or more display generation components, an eligibility indication that indicates that visual media of the respective application are eligible to be displayed via the second set of one or more display generation components; and in accordance with a determination that the set of one or more criteria is not met, forgoing display, via the first set of one or more display generation components, of the eligibility indication; while displaying, via the first set of one or more display generation components, the eligibility indication, detecting a request to initiate playback of a first visual media using the respective application; in response to detecting the request to initiate playback of the first visual media using the respective application: displaying, via the first set of one or more display generation components, playback of visual content of the first visual media using the respective application; and displaying, via the first set of one or more display generation components, a playback indication, different from the eligibility indication, that indicates that playback of the visual content the first visual media can be displayed via the second set of one or more display generation components; while displaying, via the first set of one or more display generation components, the playback indication, detecting, via the one or more input devices, an input directed to the playback indication; and in response to detecting the input directed to the playback indication: ceasing to display, via the first set of one or more display generation components, playback of the visual content of the first visual media; and displaying, via the second set of one or more display generation components, playback of the visual content of the first visual media.

In accordance with some embodiments, a transitory computer-readable storage medium is described. The transitory computer-readable storage medium stores one or more programs configured to be executed by one or more processors of a computer system that is in communication with a first set of one or more display generation components and one or more input devices, the one or more programs including instructions for: detecting, via the one or more input devices, a request to display a user interface of a respective application; in response to detecting the request to display the user interface of the respective application: displaying, via the first set of one or more display generation components, a user interface of the respective application; in accordance with a determination that a set of one or more criteria is met, including a display criterion that is met when the computer system is in communication with a second set of one or more display generation components that are different from the first set of one or more display generation components, displaying, via the first set of one or more display generation components, an eligibility indication that indicates that visual media of the respective application are eligible to be displayed via the second set of one or more display generation components; and in accordance with a determination that the set of one or more criteria is not met, forgoing display, via the first set of one or more display generation components, of the eligibility indication; while displaying, via the first set of one or more display generation components, the eligibility indication, detecting a request to initiate playback of a first visual media using the respective application; in response to detecting the request to initiate playback of the first visual media using the respective application: displaying, via the first set of one or more display generation components, playback of visual content of the first visual media using the respective application; and displaying, via the first set of one or more display generation components, a playback indication, different from the eligibility indication, that indicates that playback of the visual content the first visual media can be displayed via the second set of one or more display generation components; while displaying, via the first set of one or more display generation components, the playback indication, detecting, via the one or more input devices, an input directed to the playback indication; and in response to detecting the input directed to the playback indication: ceasing to display, via the first set of one or more display generation components, playback of the visual content of the first visual media; and displaying, via the second set of one or more display generation components, playback of the visual content of the first visual media.

In accordance with some embodiments, a computer system is described. The computer system is configured to communicate with a first set of one or more display generation components and one or more input devices. The computer system comprises: one or more processors; and memory storing one or more programs configured to be executed by the one or more processors, the one or more programs including instructions for: detecting, via the one or more input devices, a request to display a user interface of a respective application; in response to detecting the request to display the user interface of the respective application:
displaying, via the first set of one or more display generation components, a user interface of the respective application; in accordance with a determination that a set of one or more criteria is met, including a display criterion that is met when the computer system is in communication with a second set of one or more display generation components that are different from the first set of one or more display generation components, displaying, via the first set of one or more display generation components, an eligibility indication that indicates that visual media of the respective application are eligible to be displayed via the second set of one or more display generation components; and in accordance with a determination that the set of one or more criteria is not met, forgoing display, via the first set of one or more display generation components, of the eligibility indication; while displaying, via the first set of one or more display generation components, the eligibility indication, detecting a request to initiate playback of a first visual media using the respective application; in response to detecting the request to initiate playback of the first visual media using the respective application: displaying, via the first set of one or more display generation components, playback of visual content of the first visual media using the respective application; and displaying, via the first set of one or more display generation components, a playback indication, different from the eligibility indication, that indicates that playback of the visual content the first visual media can be displayed via the second set of one or more display generation components; while displaying, via the first set of one or more display generation components, the playback indication, detecting, via the one or more input devices, an input directed to the playback indication; and in response to detecting the input directed to the playback indication: ceasing to display, via the first set of one or more display generation components, playback of the visual content of the first visual media; and displaying, via the second set of one or more display generation components, playback of the visual content of the first visual media.

In accordance with some embodiments, a computer system is described. The computer system is configured to communicate with a first set of one or more display generation components and one or more input devices. The computer system comprises: means for detecting, via the one or more input devices, a request to display a user interface of a respective application; means, responsive to detecting the request to display the user interface of the respective application, for: displaying, via the first set of one or more display generation components, a user interface of the respective application; in accordance with a determination that a set of one or more criteria is met, including a display criterion that is met when the computer system is in communication with a second set of one or more display generation components that are different from the first set of one or more display generation components, displaying, via the first set of one or more display generation components, an eligibility indication that indicates that visual media of the respective application are eligible to be displayed via the second set of one or more display generation components; and in accordance with a determination that the set of one or more criteria is not met, forgoing display, via the first set of one or more display generation components, of the eligibility indication; means, while displaying, via the first set of one or more display generation components, the eligibility indication, for detecting a request to initiate playback of a first visual media using the respective application; means, responsive to detecting the request to initiate playback of the first visual media using the respective application, for: displaying, via the first set of one or more display generation components, playback of visual content of the first visual media using the respective application; and displaying, via the first set of one or more display generation components, a playback indication, different from the eligibility indication, that indicates that playback of the visual content the first visual media can be displayed via the second set of one or more display generation components; means, while displaying, via the first set of one or more display generation components, the playback indication, for detecting, via the one or more input devices, an input directed to the playback indication; and means, responsive to detecting the input directed to the playback indication, for: ceasing to display, via the first set of one or more display generation components, playback of the visual content of the first visual media; and displaying, via the second set of one or more display generation components, playback of the visual content of the first visual media.

In accordance with some embodiments, a computer program product is described. The computer program product comprises one or more programs configured to be executed by one or more processors of a computer system that is in communication with a first set of one or more display generation components and one or more input devices, the one or more programs including instructions for: detecting, via the one or more input devices, a request to display a user interface of a respective application; in response to detecting the request to display the user interface of the respective application: displaying, via the first set of one or more display generation components, a user interface of the respective application; in accordance with a determination that a set of one or more criteria is met, including a display criterion that is met when the computer system is in communication with a second set of one or more display generation components that are different from the first set of one or more display generation components, displaying, via the first set of one or more display generation components, an eligibility indication that indicates that visual media of the respective application are eligible to be displayed via the second set of one or more display generation components; and in accordance with a determination that the set of one or more criteria is not met, forgoing display, via the first set of one or more display generation components, of the eligibility indication; while displaying, via the first set of one or more display generation components, the eligibility indication, detecting a request to initiate playback of a first visual media using the respective application; in response to detecting the request to initiate playback of the first visual media using the respective application: displaying, via the first set of one or more display generation components, playback of visual content of the first visual media using the respective application; and displaying, via the first set of one or more display generation components, a playback indication, different from the eligibility indication, that indicates that playback of the visual content the first visual media can be displayed via the second set of one or more display generation components; while displaying, via the first set of one or more display generation components, the playback indication, detecting, via the one or more input devices, an input directed to the playback indication; and in response to detecting the input directed to the playback indication: ceasing to display, via the first set of one or more display generation components, playback of the visual content of the first visual media; and displaying, via the second set of one or more display generation components, playback of the visual content of the first visual media.

In accordance with some embodiments, a method is described. The method is performed at a computer system, wherein the computer system is in communication with a first display generation component. The method comprises: detecting information about the first display generation component, including a respective display resolution of the first display generation component and a respective display size of the first display generation component; subsequent to detecting the information about the first display generation component, generating, based on the respective display resolution of the first display generation component and the respective display size of the first display generation component, a respective user interface with a respective resolution, including: in accordance with a determination that the respective display resolution is a first display resolution and that the respective display size is a first display size, generating a first user interface with a first resolution that is different from the respective display resolution of the first display generation component, wherein the first user interface includes a plurality of user interface elements in a first arrangement; and in accordance with a determination that the respective display resolution is a second display resolution and that the respective display size is a second display size, generating a second user interface with a second resolution that is different from the first resolution and that is different from the respective display resolution of the first display generation component, and wherein the first display resolution is different from the second display resolution and/or the first display size is different from the second display size, and wherein the second user interface includes the plurality of user interface elements in a second arrangement that is different from the first arrangement; subsequent to generating the respective user interface with the respective resolution, resizing the respective user interface with the respective resolution to generate a resized user interface with a resized resolution; and displaying, via the first display generation component, the resized user interface with the resized resolution.

In accordance with some embodiments, a method is described. The method is performed at a computer system that is in communication with one or more display generation components, and comprises: displaying, via the one or more display generation components, first content; while displaying the first content via the one or more display generation components, detecting that a first set of criteria for displaying content via a first external display is satisfied, wherein the first external display is separate from the computer system and the one or more display generation components; and in response to detecting that the first set of criteria for displaying content via the first external display is satisfied, causing the first external display to display a first user interface from the computer system, including: in accordance with a determination that an activity of a first type is in progress on the computer system, causing the first external display to display the first user interface concurrently with a representation of the activity of the first type; and in accordance with a determination that an activity of the first type is not in progress on the computer system, causing the first external display to display the first user interface without displaying the representation of the activity of the first type.

In accordance with some embodiments, a non-transitory computer-readable storage medium is described. The non-transitory computer-readable storage medium stores one or more programs configured to be executed by one or more processors of a computer system that is in communication with one or more display generation components, and the one or more programs include instructions for: displaying, via the one or more display generation components, first content; while displaying the first content via the one or more display generation components, detecting that a first set of criteria for displaying content via a first external display is satisfied, wherein the first external display is separate from the computer system and the one or more display generation components; and in response to detecting that the first set of criteria for displaying content via the first external display is satisfied, causing the first external display to display a first user interface from the computer system, including: in accordance with a determination that an activity of a first type is in progress on the computer system, causing the first external display to display the first user interface concurrently with a representation of the activity of the first type; and in accordance with a determination that an activity of the first type is not in progress on the computer system, causing the first external display to display the first user interface without displaying the representation of the activity of the first type.

In accordance with some embodiments, a transitory computer-readable storage medium is described. The transitory computer-readable storage medium stores one or more programs configured to be executed by one or more processors of a computer system that is in communication with one or more display generation components, and the one or more programs include instructions for: displaying, via the one or more display generation components, first content; while displaying the first content via the one or more display generation components, detecting that a first set of criteria for displaying content via a first external display is satisfied, wherein the first external display is separate from the computer system and the one or more display generation components; and in response to detecting that the first set of criteria for displaying content via the first external display is satisfied, causing the first external display to display a first user interface from the computer system, including: in accordance with a determination that an activity of a first type is in progress on the computer system, causing the first external display to display the first user interface concurrently with a representation of the activity of the first type; and in accordance with a determination that an activity of the first type is not in progress on the computer system, causing the first external display to display the first user interface without displaying the representation of the activity of the first type.

In accordance with some embodiments, a computer system is described. The computer system is configured to communicate with one or more display generation components, and comprises: one or more processors; and memory storing one or more programs configured to be executed by the one or more processors, the one or more programs including instructions for: displaying, via the one or more display generation components, first content; while displaying the first content via the one or more display generation components, detecting that a first set of criteria for displaying content via a first external display is satisfied, wherein the first external display is separate from the computer system and the one or more display generation components; and in response to detecting that the first set of criteria for displaying content via the first external display is satisfied, causing the first external display to display a first user interface from the computer system, including: in accordance with a determination that an activity of a first type is in progress on the computer system, causing the first external display to display the first user interface concurrently with a representation of the activity of the first type; and in accordance with a determination that an activity of the first type is not in progress on the computer system, causing the first external display to display the first user interface without displaying the representation of the activity of the first type.

In accordance with some embodiments, a computer system is described. The computer system is configured to communicate with one or more display generation components, and comprises: means for displaying, via the one or more display generation components, first content; means for, while displaying the first content via the one or more display generation components, detecting that a first set of criteria for displaying content via a first external display is satisfied, wherein the first external display is separate from the computer system and the one or more display generation components; and means for, in response to detecting that the first set of criteria for displaying content via the first external display is satisfied, causing the first external display to display a first user interface from the computer system, including: in accordance with a determination that an activity of a first type is in progress on the computer system, causing the first external display to display the first user interface concurrently with a representation of the activity of the first type; and in accordance with a determination that an activity of the first type is not in progress on the computer system, causing the first external display to display the first user interface without displaying the representation of the activity of the first type.

In accordance with some embodiments, a computer program product is described. The computer program product comprises one or more programs configured to be executed by one or more processors of a computer system that is in communication with one or more display generation components, the one or more programs including instructions for: displaying, via the one or more display generation components, first content; while displaying the first content via the one or more display generation components, detecting that a first set of criteria for displaying content via a first external display is satisfied, wherein the first external display is separate from the computer system and the one or more display generation components; and in response to detecting that the first set of criteria for displaying content via the first external display is satisfied, causing the first external display to display a first user interface from the computer system, including: in accordance with a determination that an activity of a first type is in progress on the computer system, causing the first external display to display the first user interface concurrently with a representation of the activity of the first type; and in accordance with a determination that an activity of the first type is not in progress on the computer system, causing the first external display to display the first user interface without displaying the representation of the activity of the first type.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing processes related to secondary displays, thereby increasing the effectiveness, efficiency, and user satisfaction with such devices. Such methods and interfaces may complement or replace other methods for managing processes related to secondary displays.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6Y illustrate example user interfaces for interacting with stacks of widgets, in accordance with some embodiments.

FIGS. 6Z-6AF illustrate example user interfaces for managing media playback, in accordance with some embodiments.

FIGS. 6AG-6AH illustrate example techniques for displaying user interfaces on various displays, in accordance with some embodiments.

FIG. 7 is a flow diagram illustrating methods of managing stacks of widgets, in accordance with some embodiments.

FIG. 8 is a flow diagram illustrating methods of displaying stacks of widgets, in accordance with some embodiments.

FIGS. 9A-9B are a flow diagram illustrating methods of managing media playback, in accordance with some embodiments.

FIGS. 10A-10P illustrate example user interfaces and techniques for accessing event notifications, in accordance with some embodiments.

FIG. 11 is a flow diagram illustrating methods of accessing event notifications, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for managing processes related to secondary displays. Such techniques can reduce the cognitive burden on a user who use secondary displays, thereby enhancing productivity. Further, such techniques can reduce processor and battery power otherwise wasted on redundant user inputs.

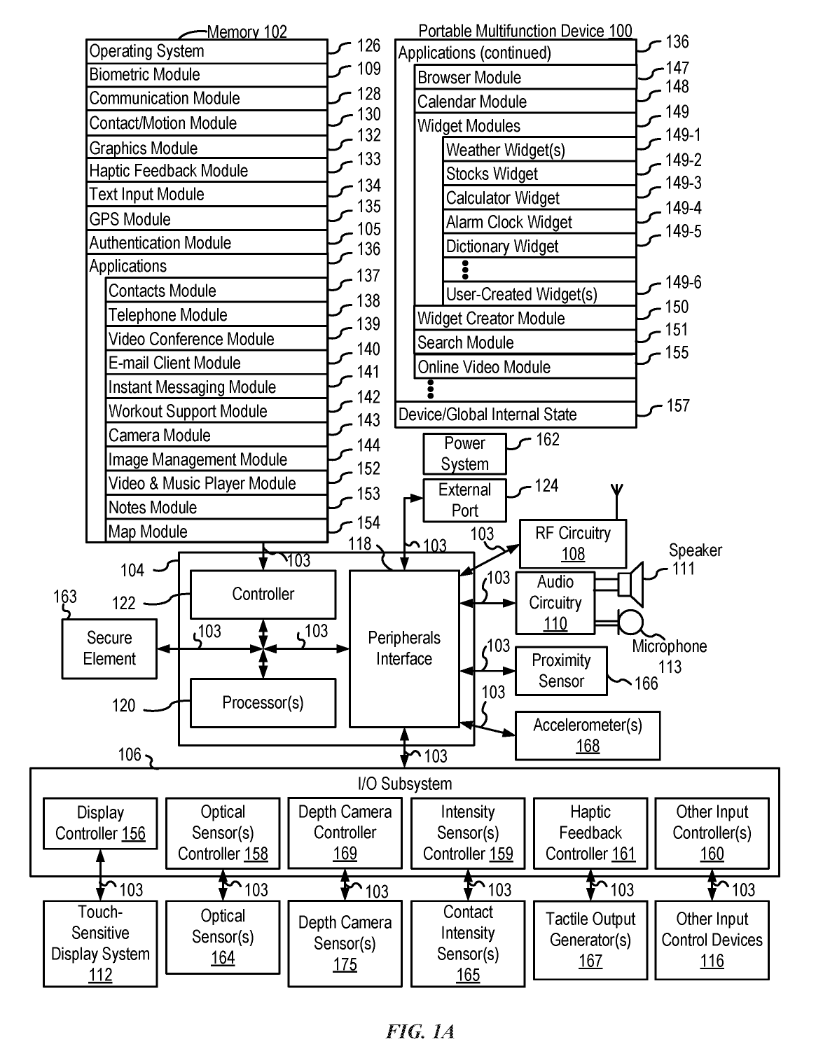

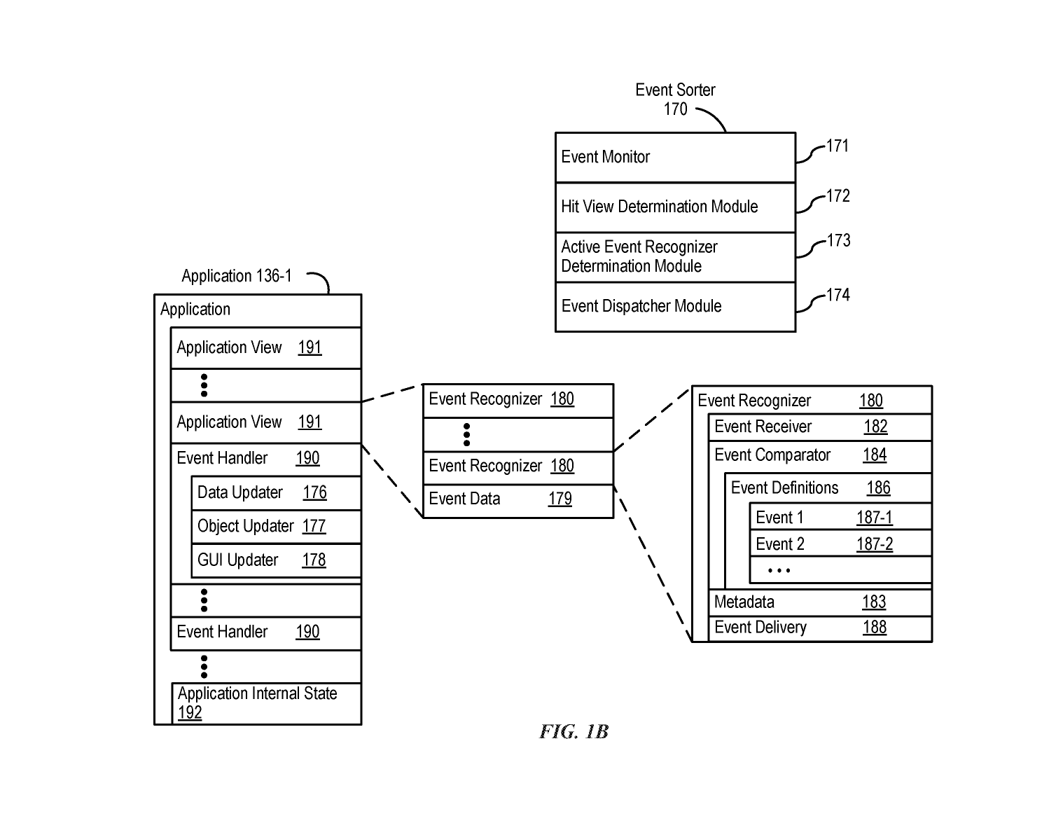

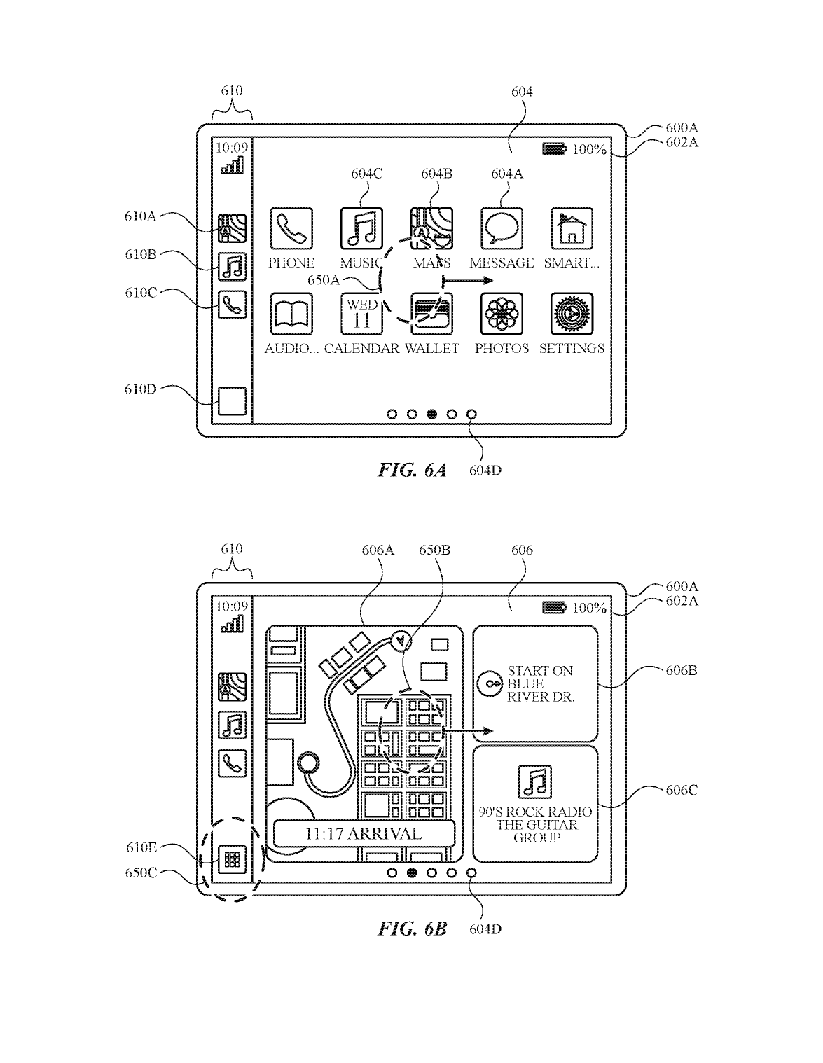

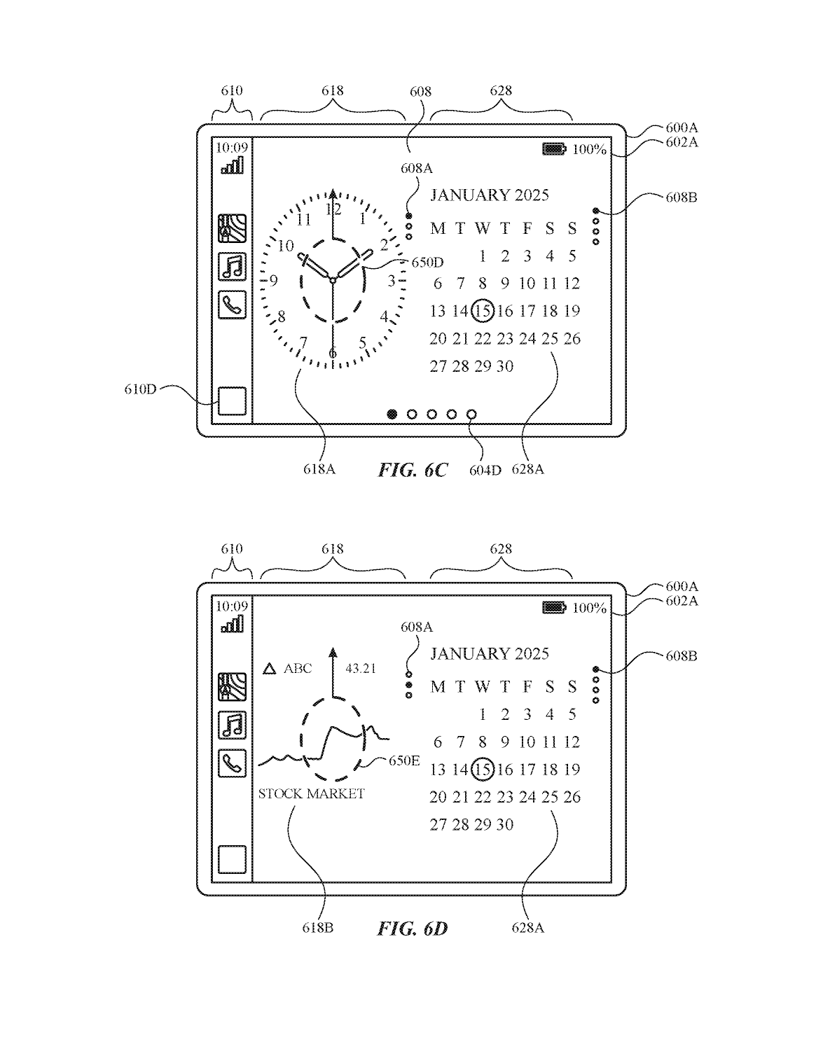

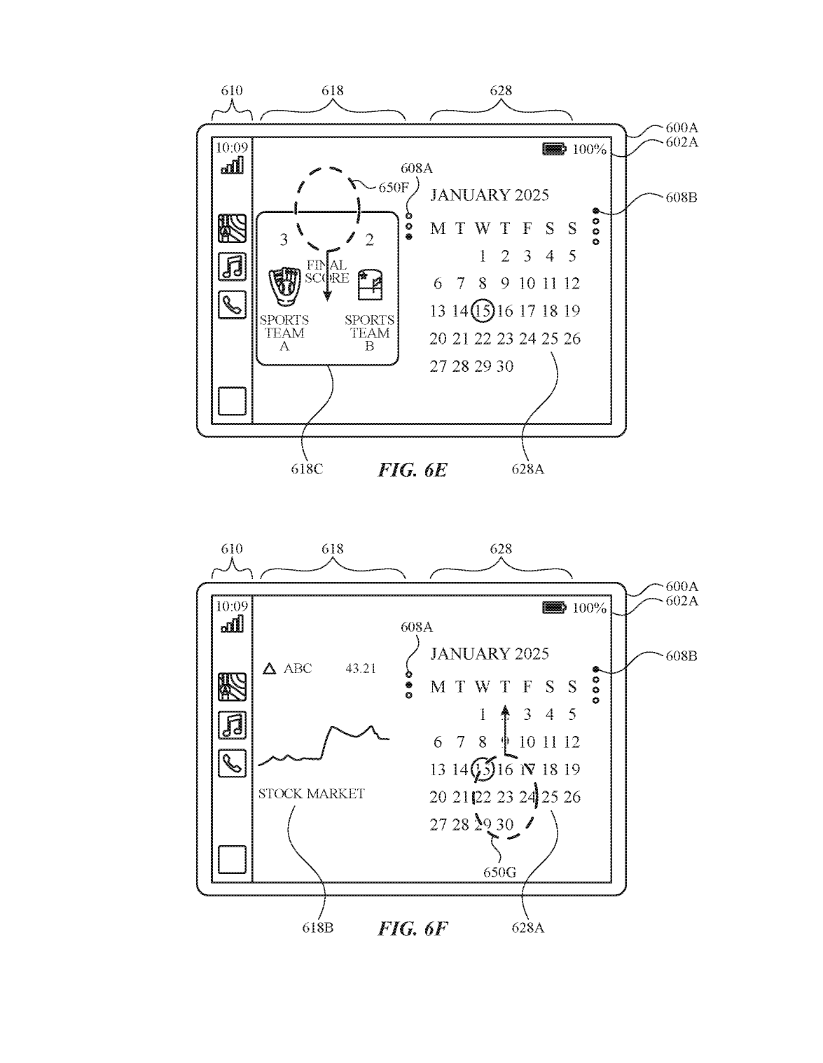

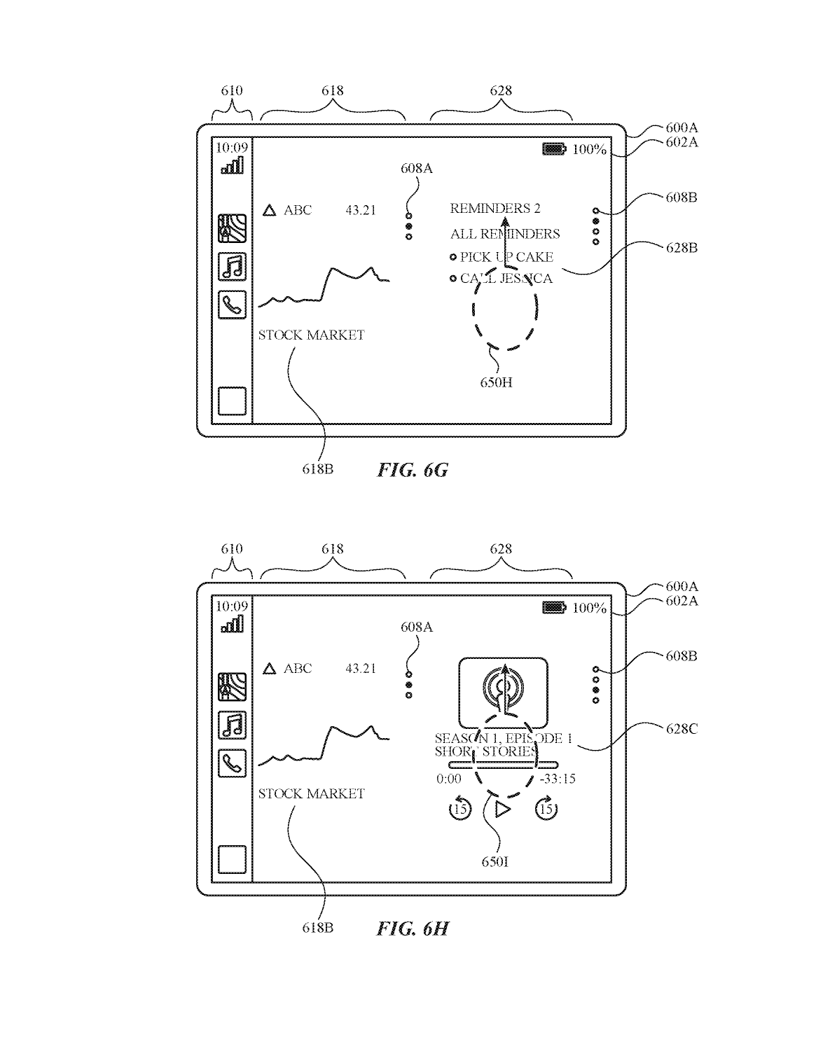

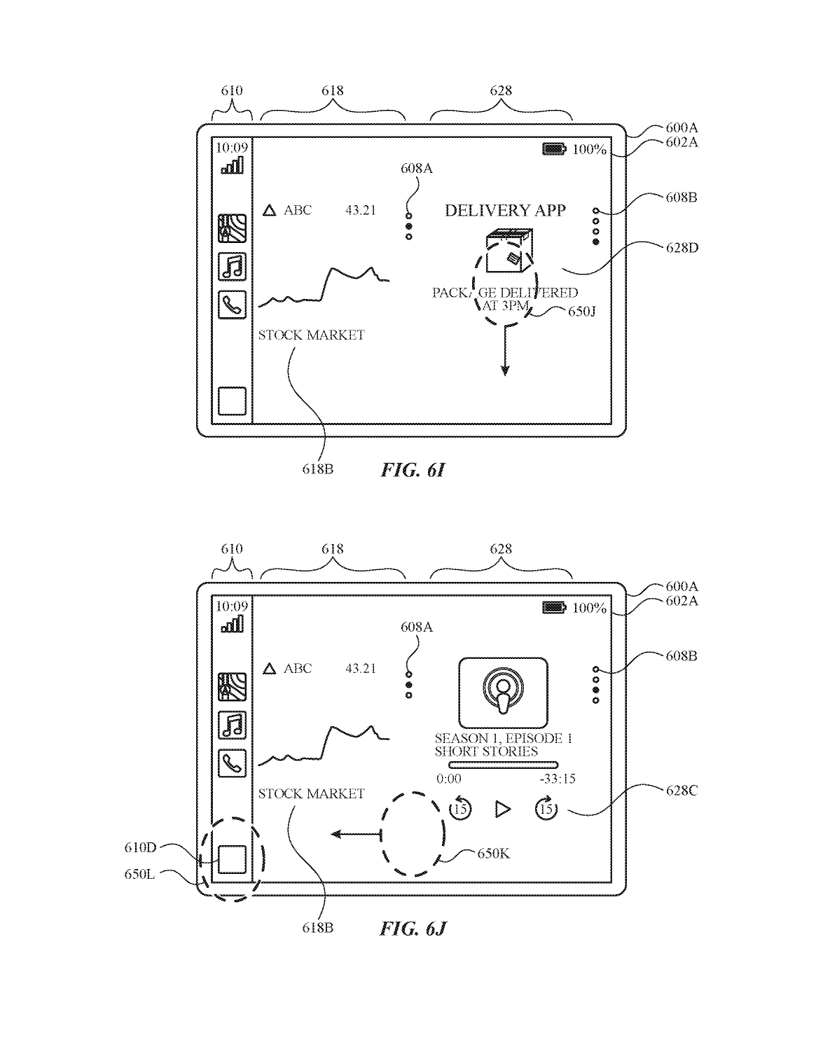

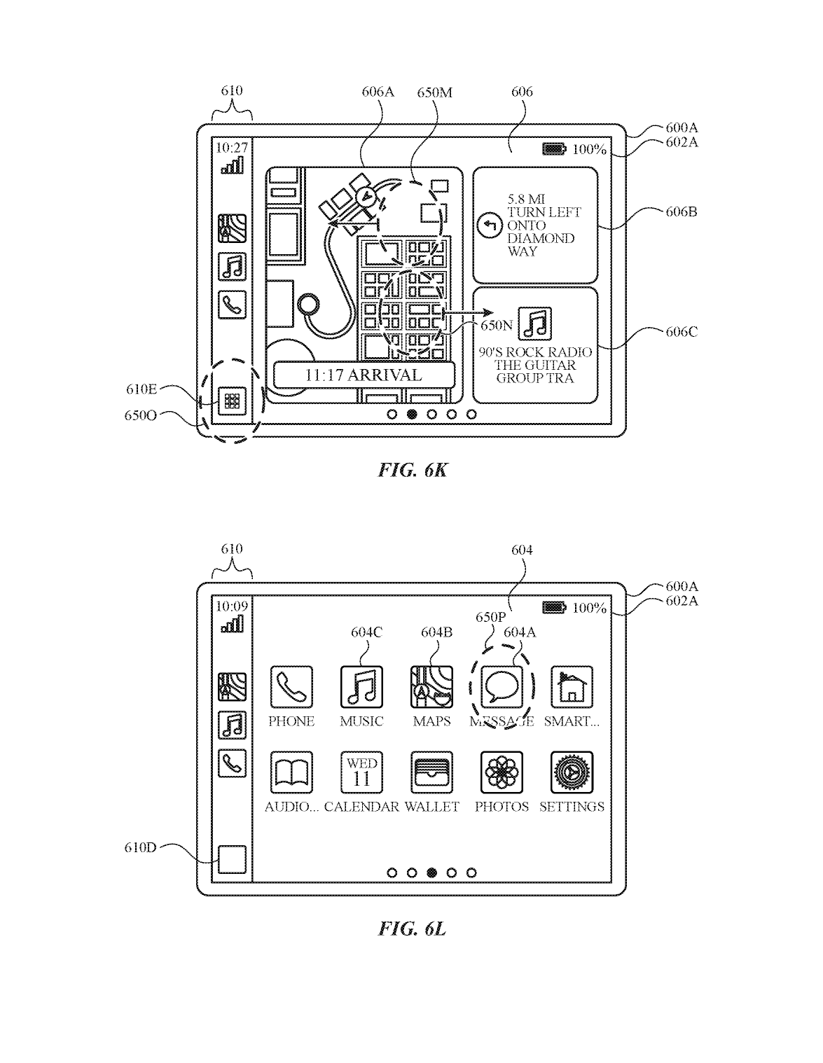

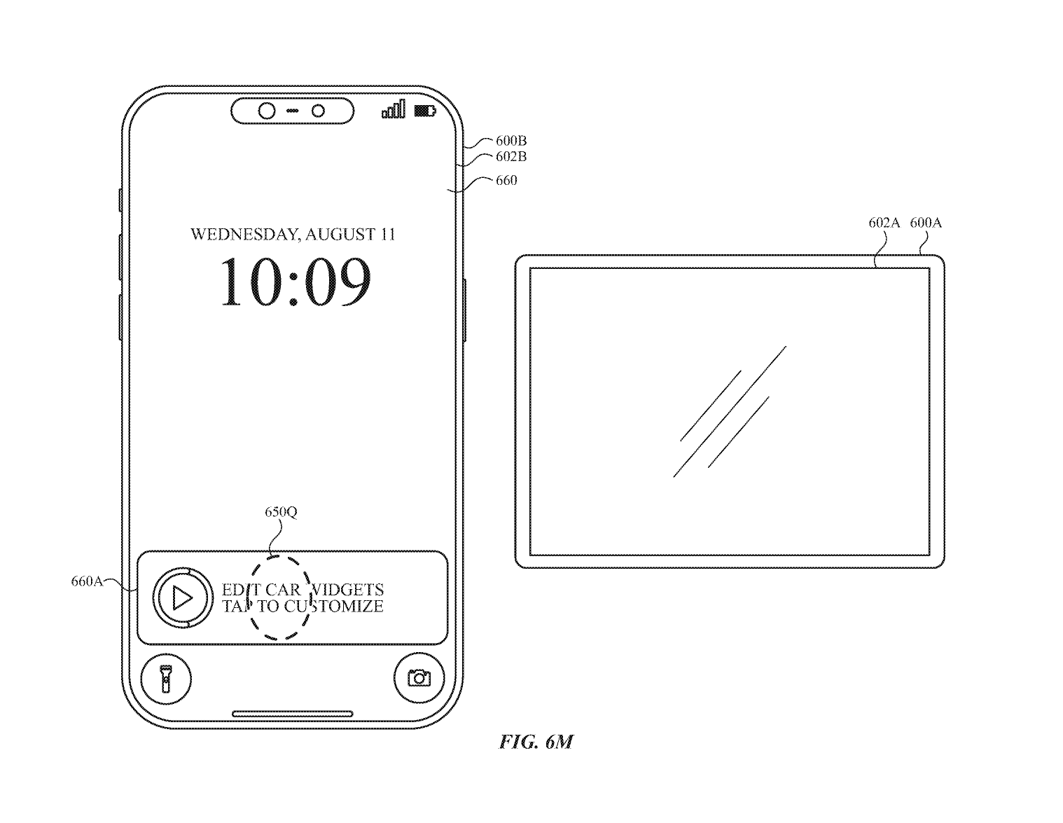

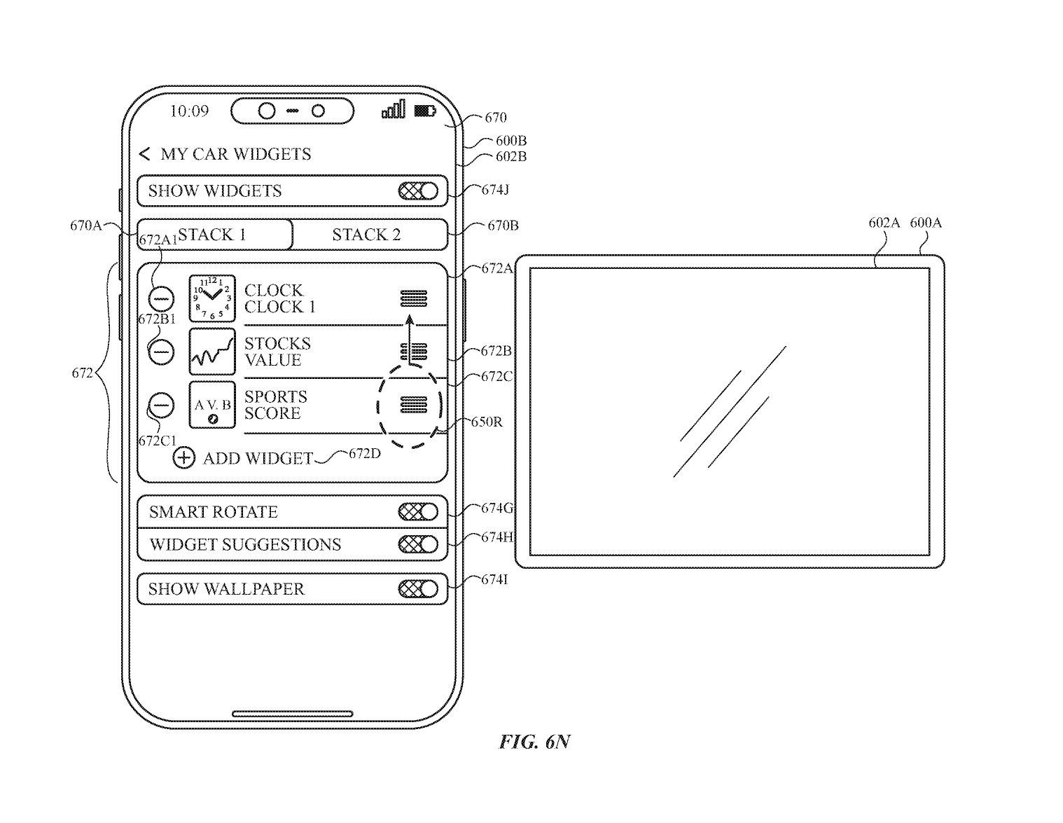

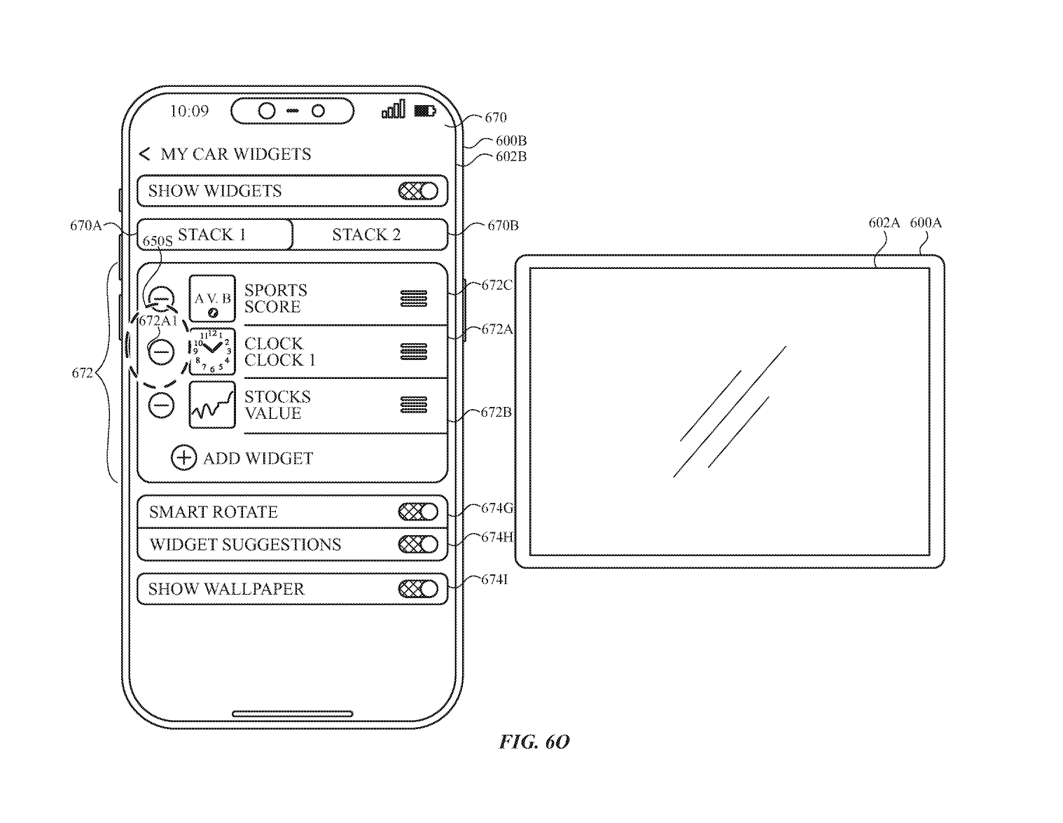

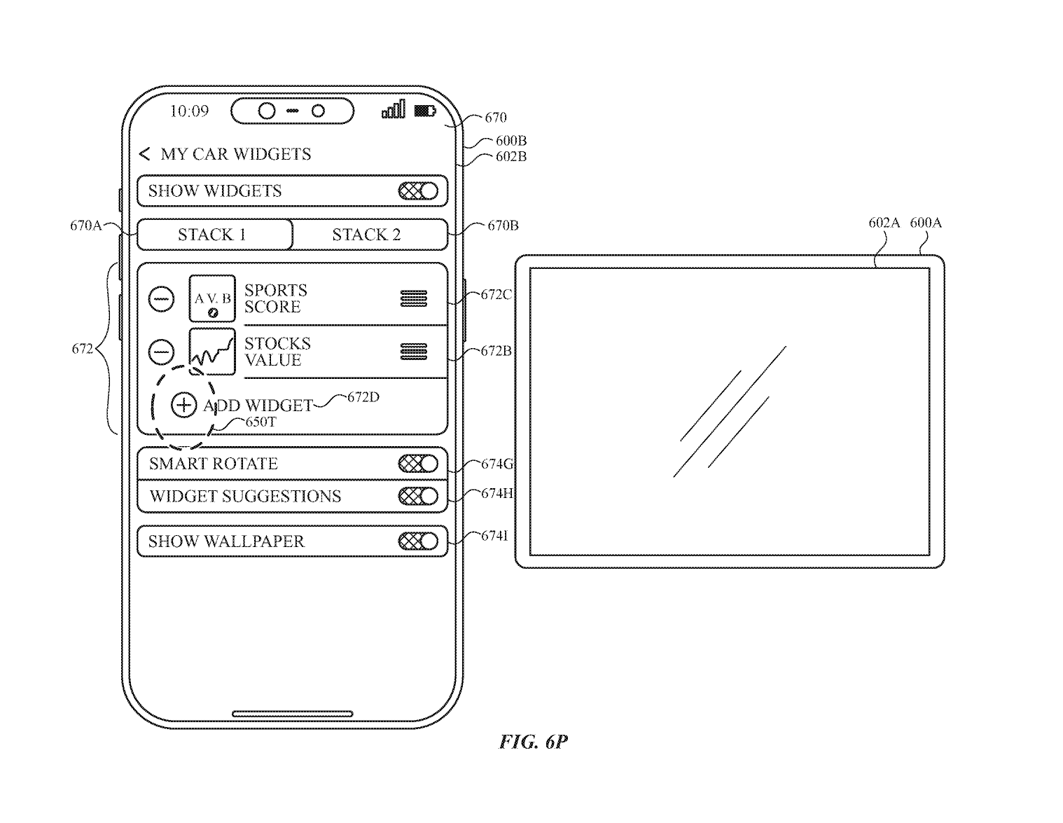

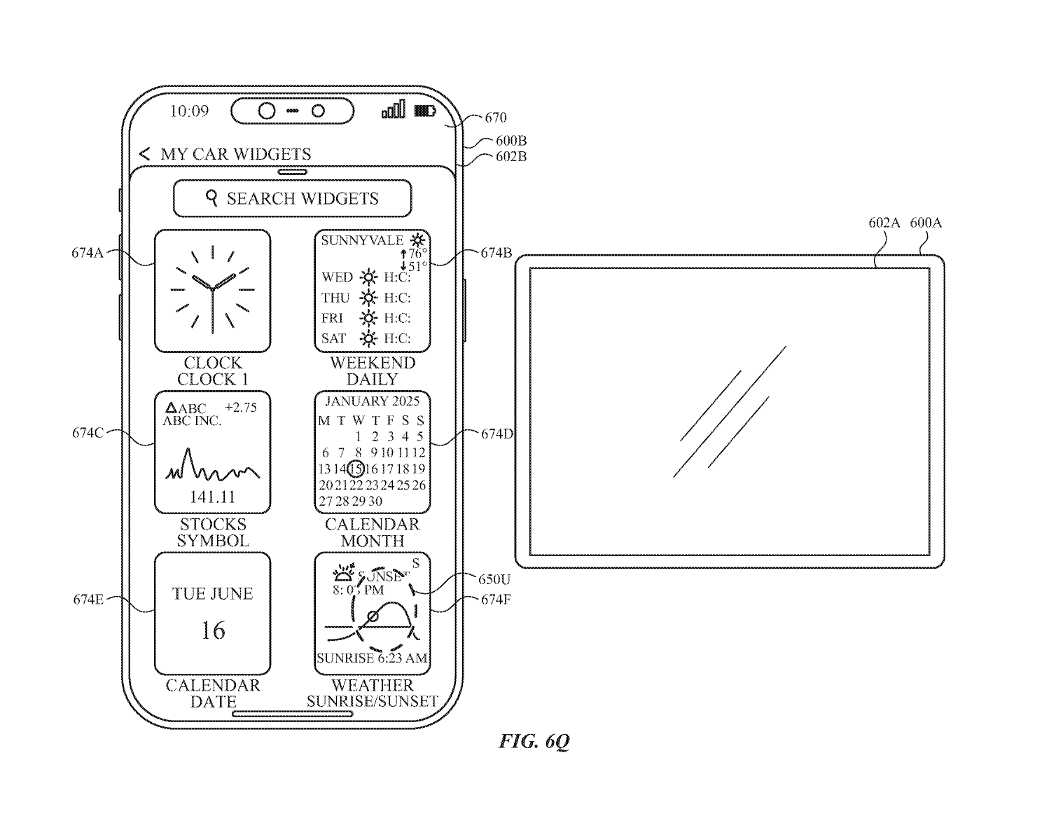

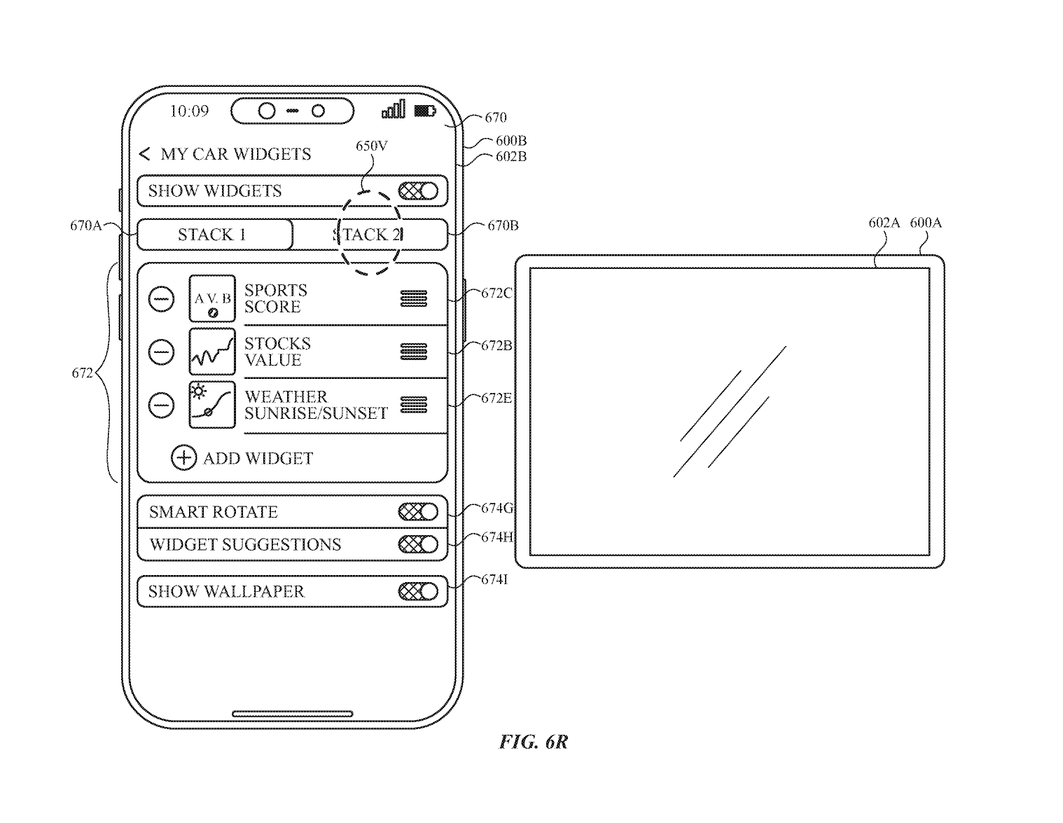

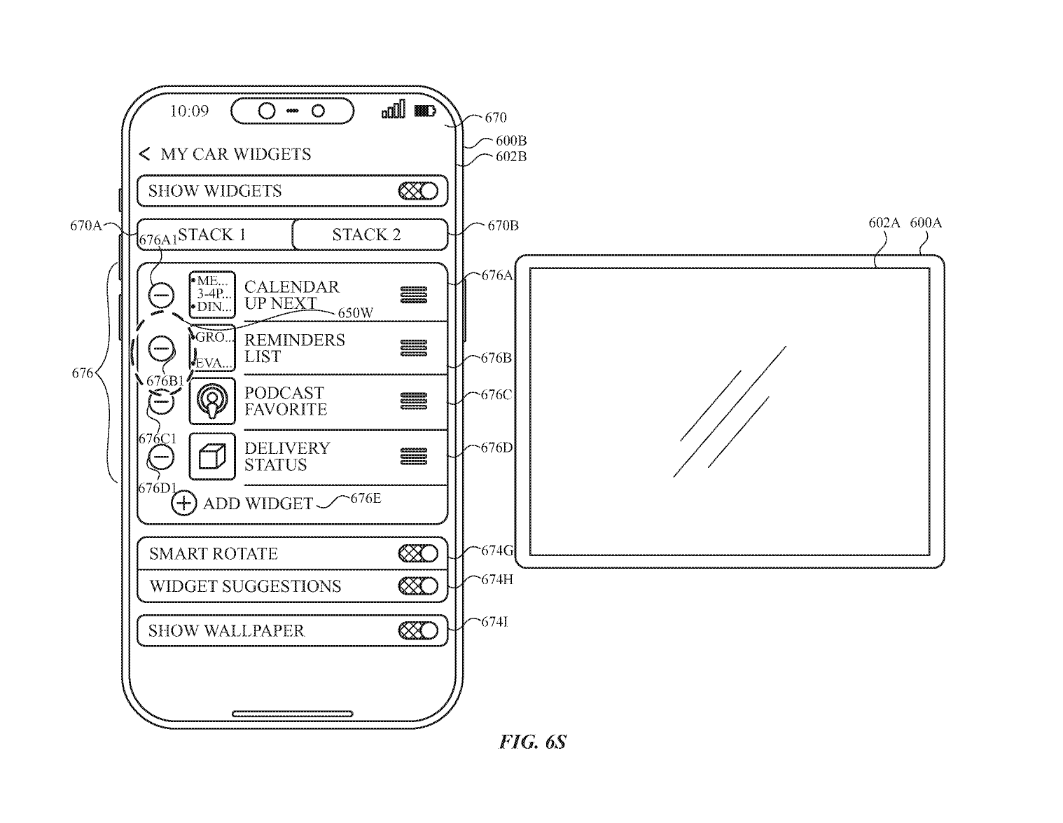

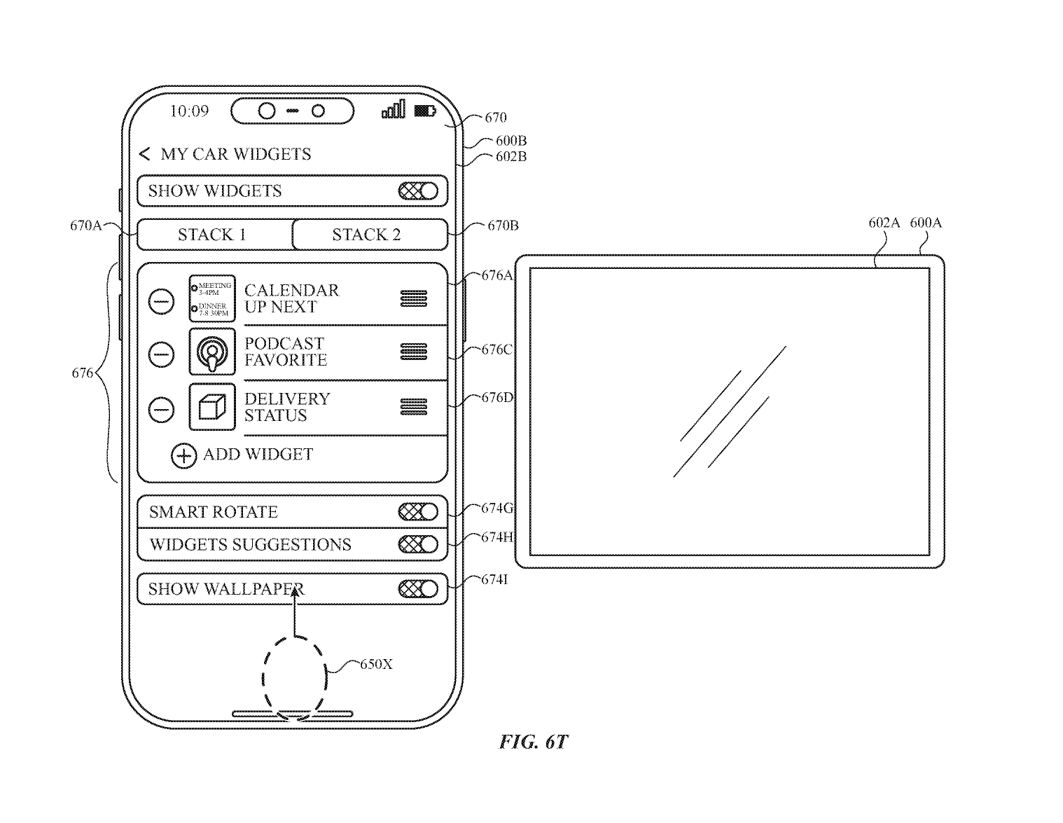

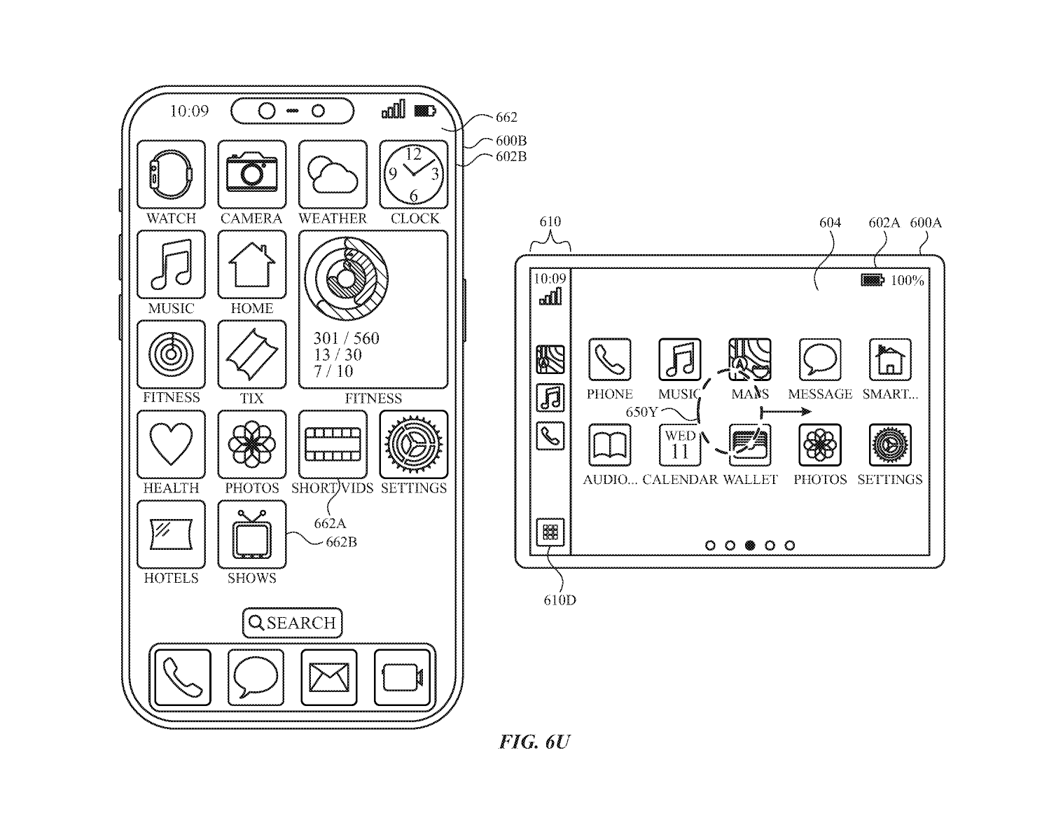

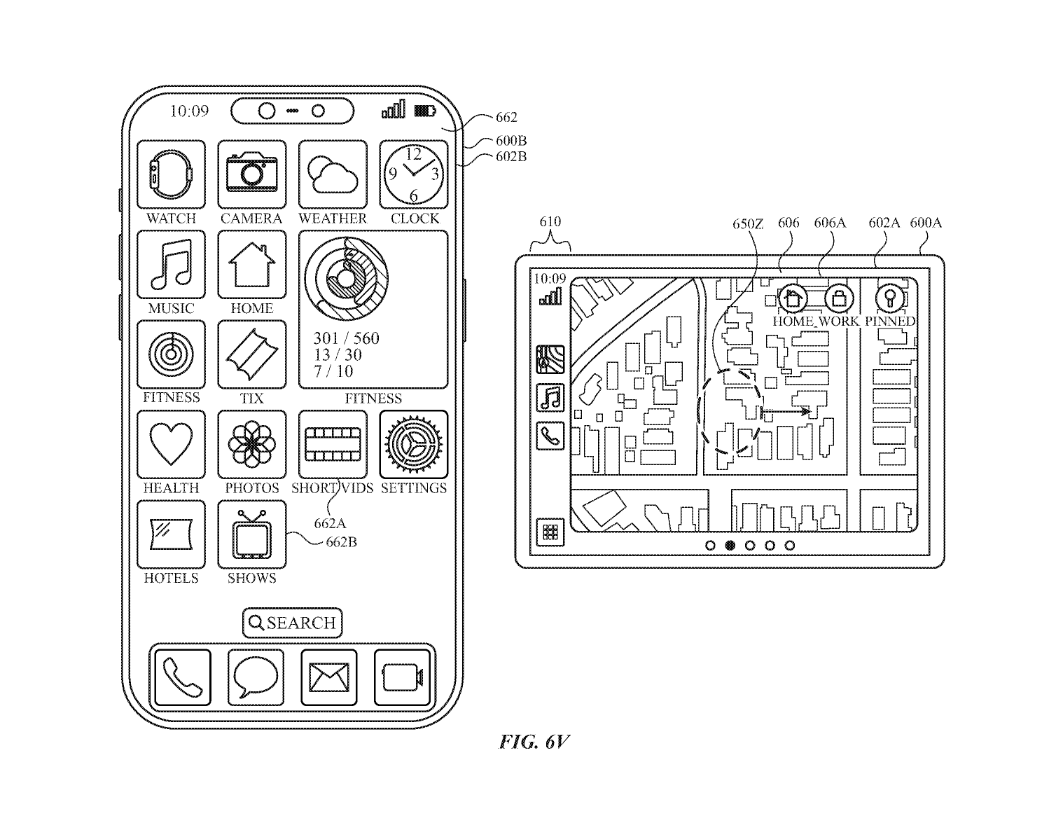

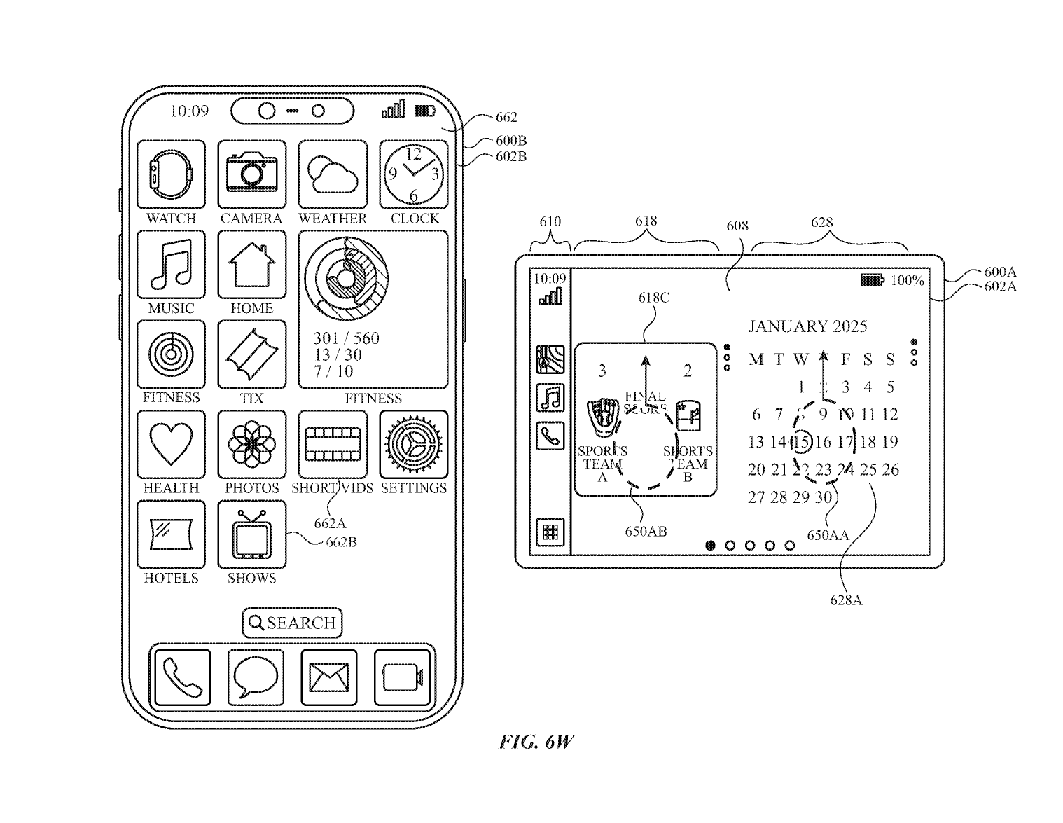

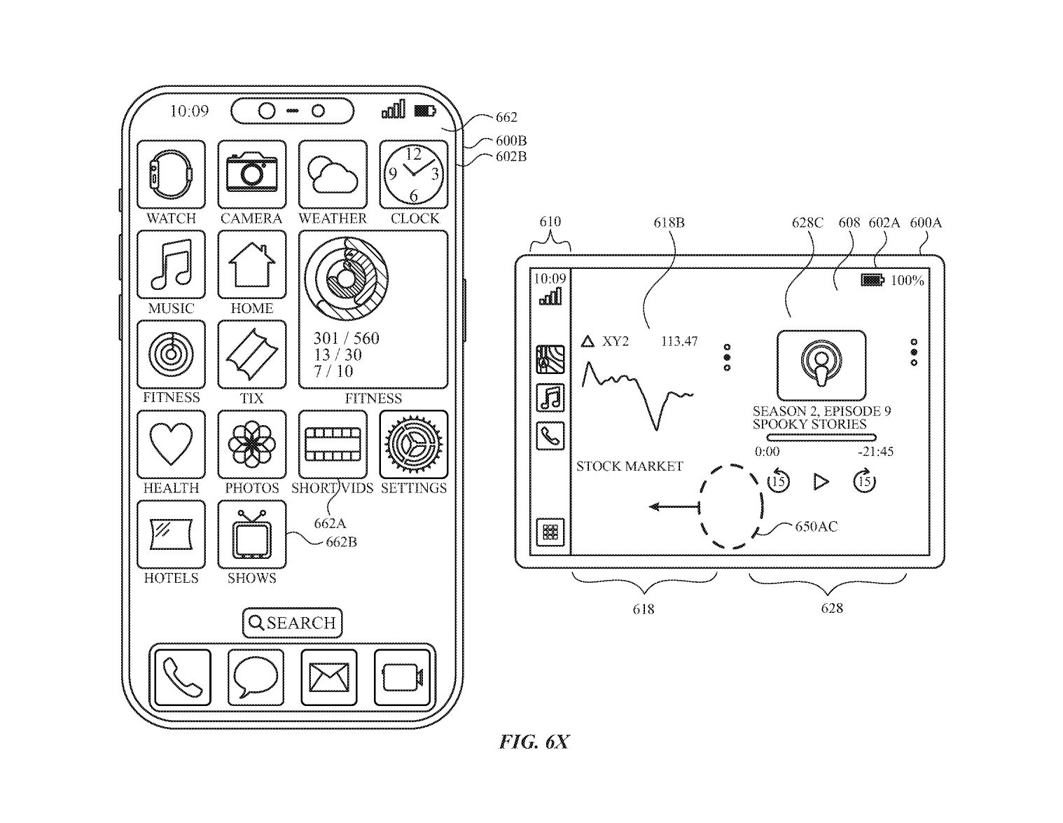

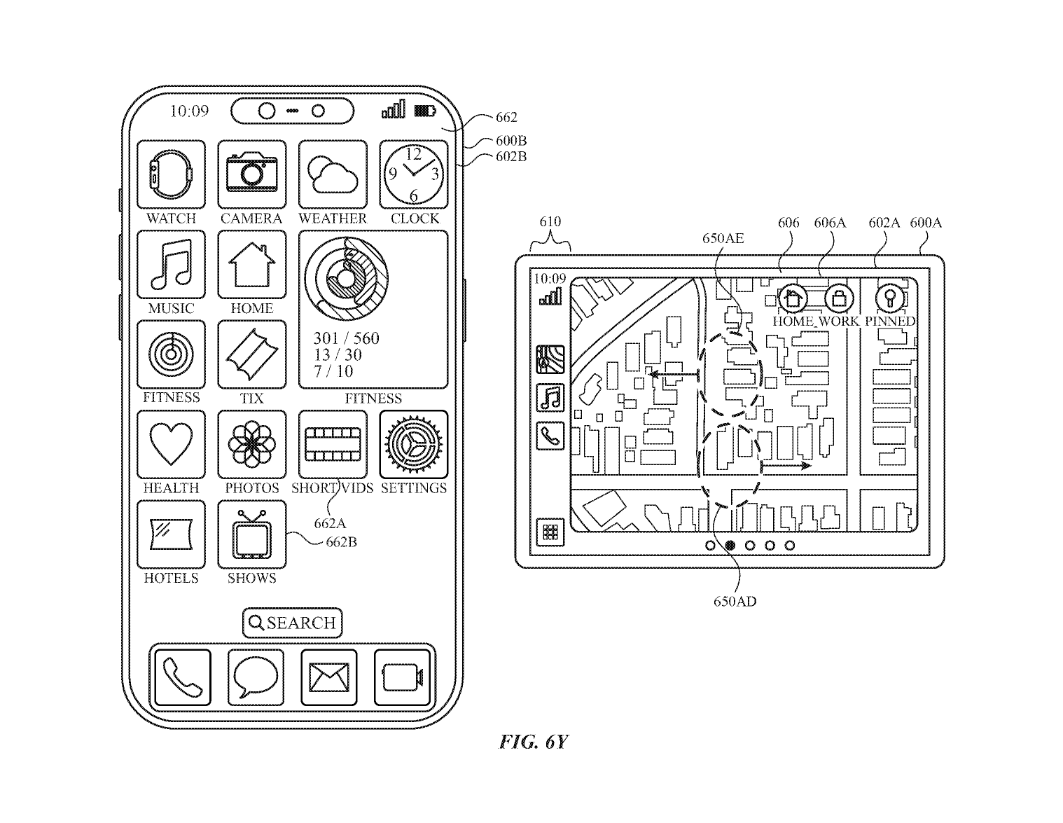

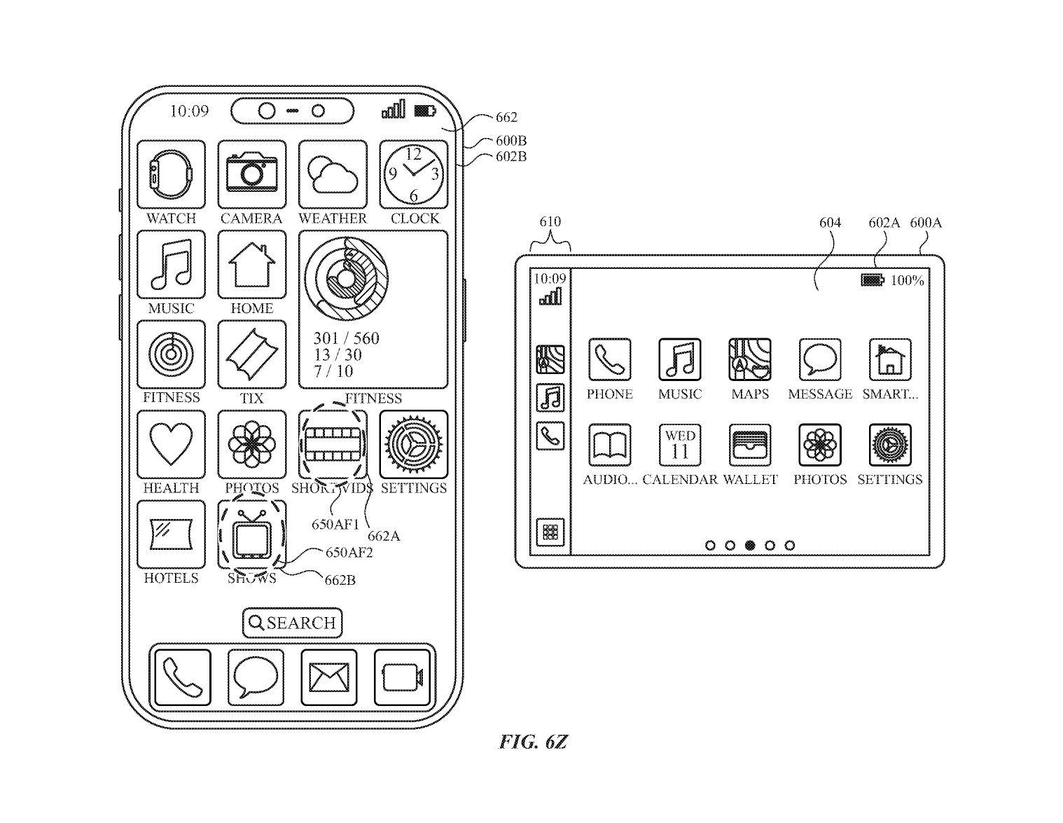

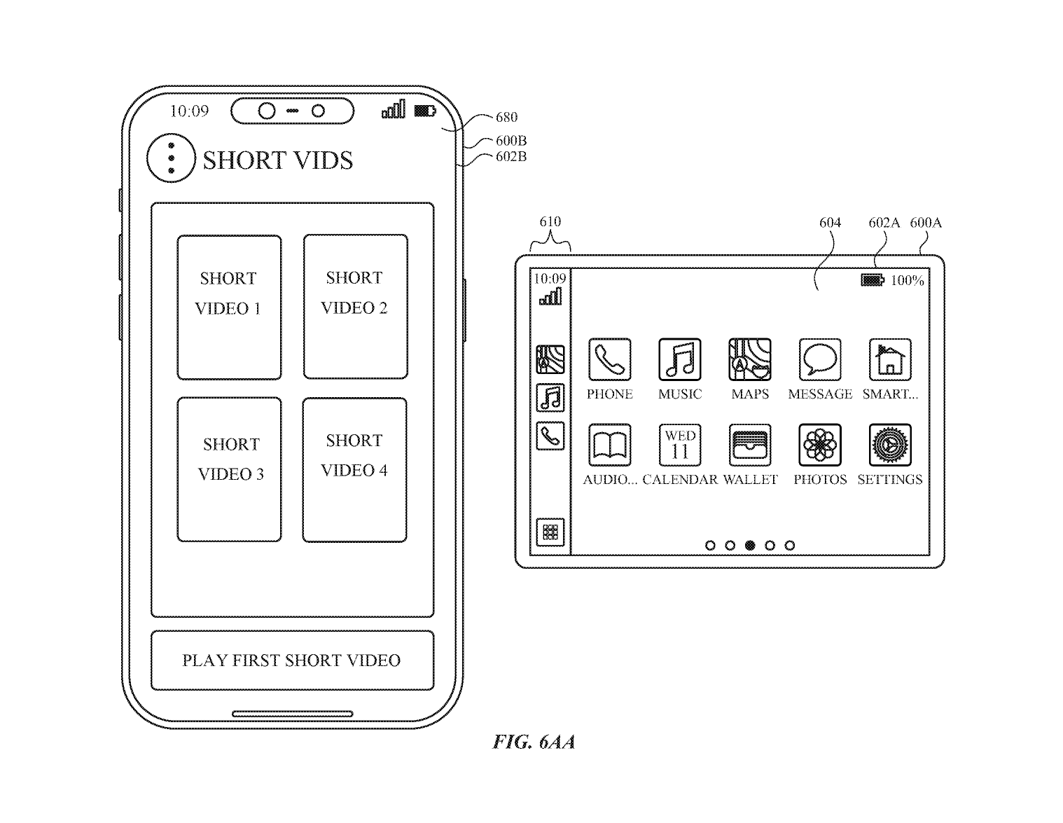

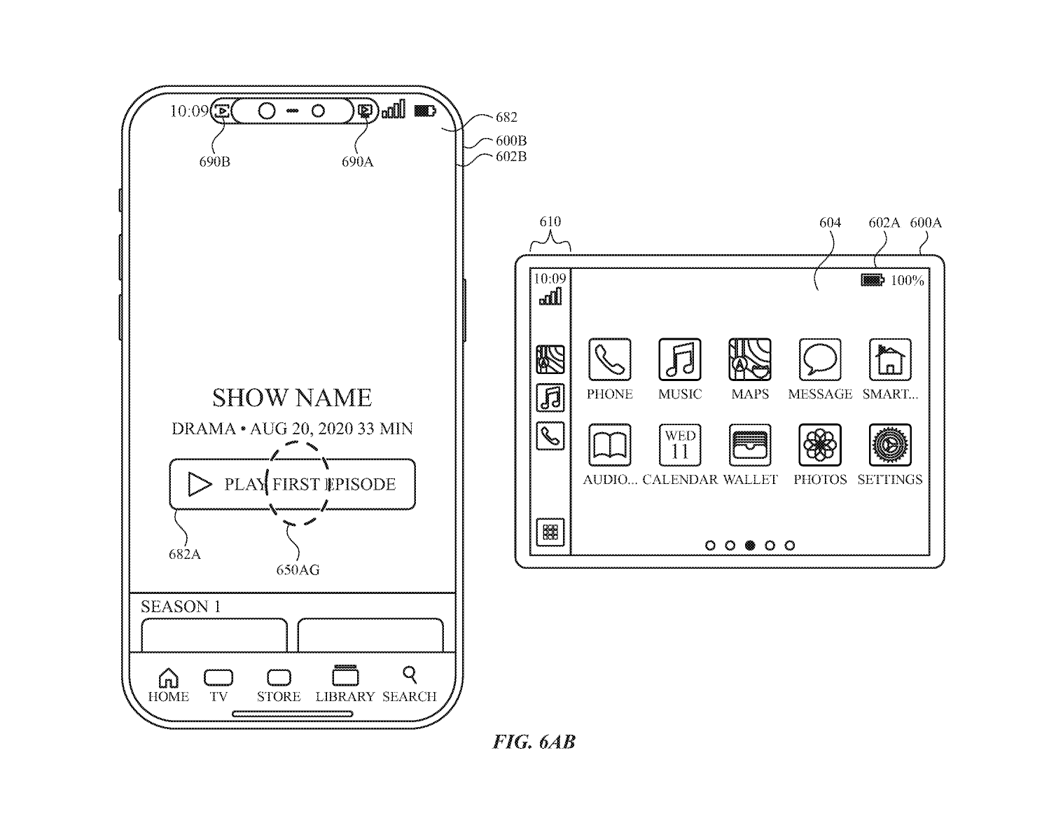

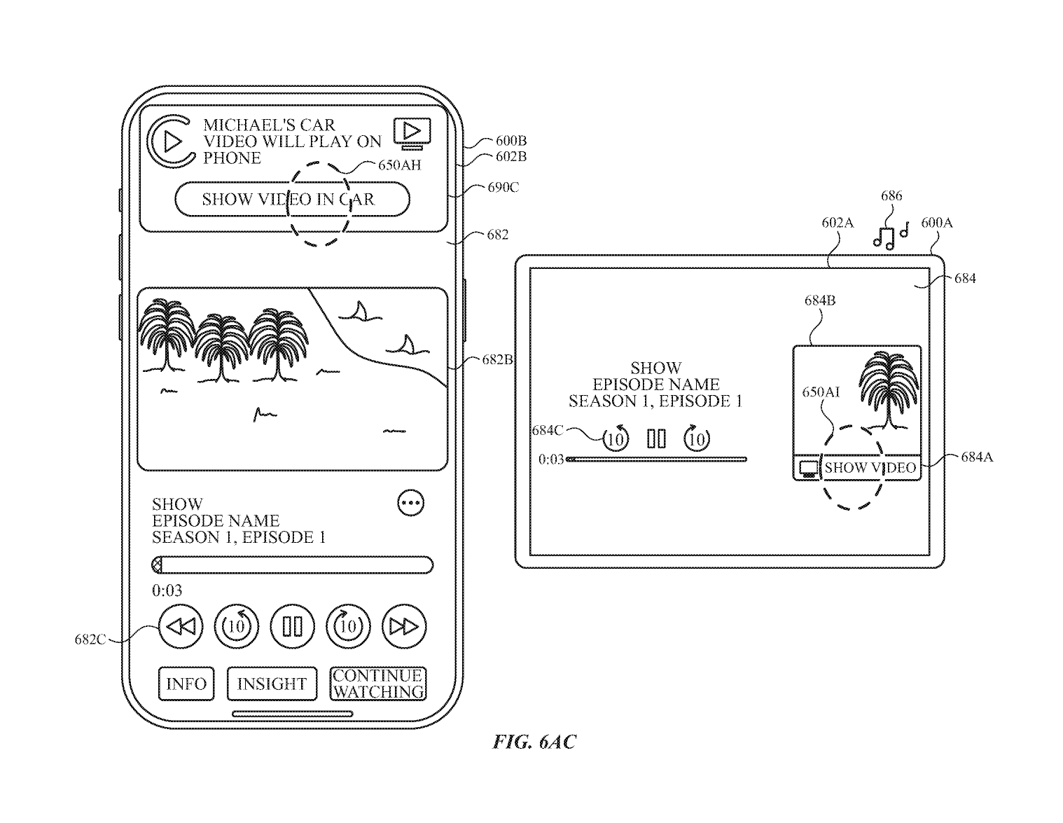

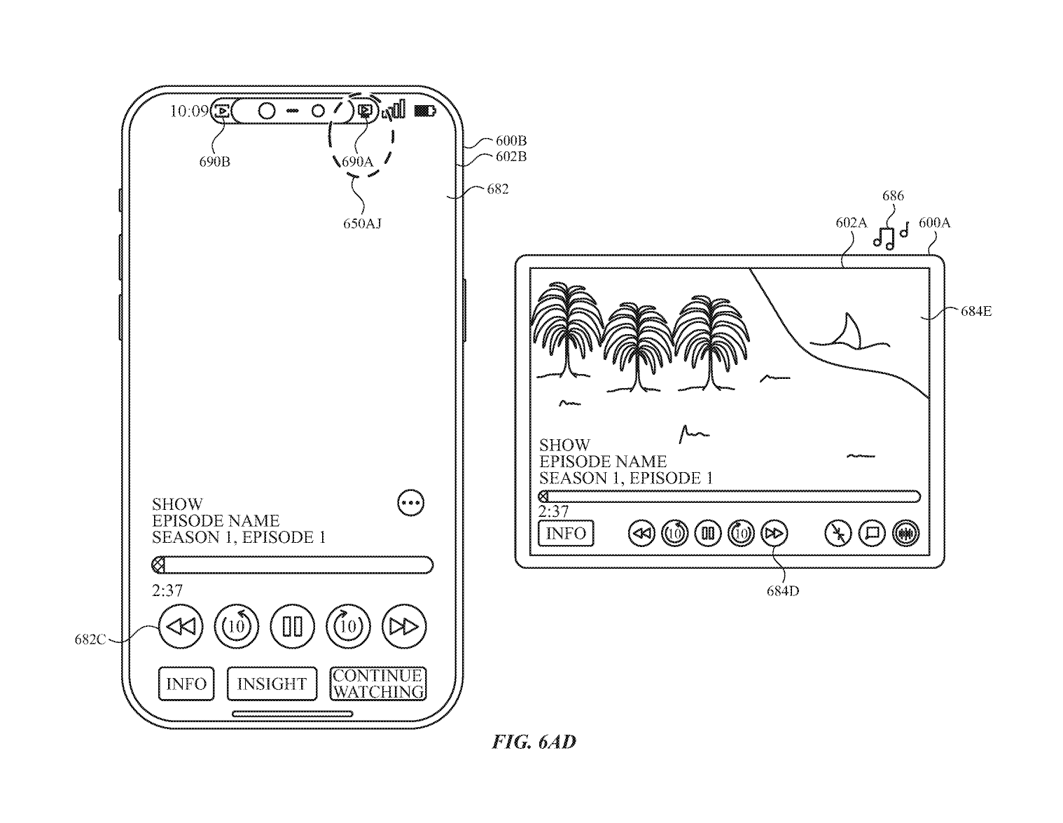

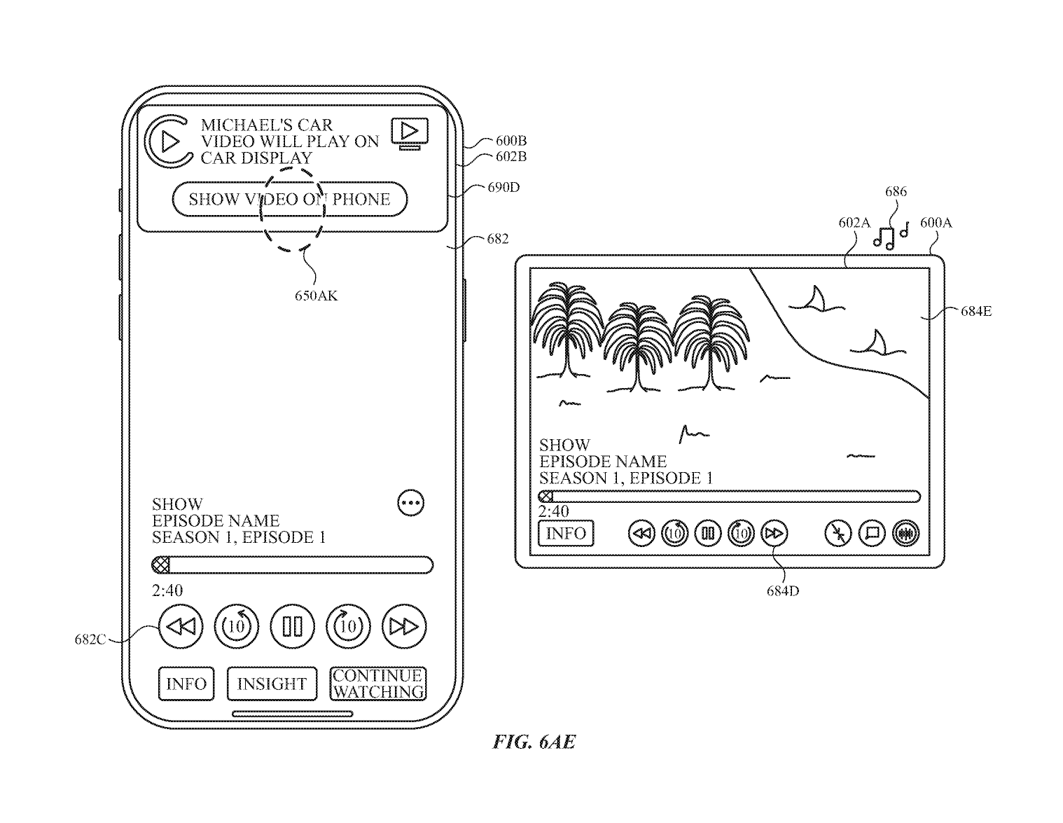

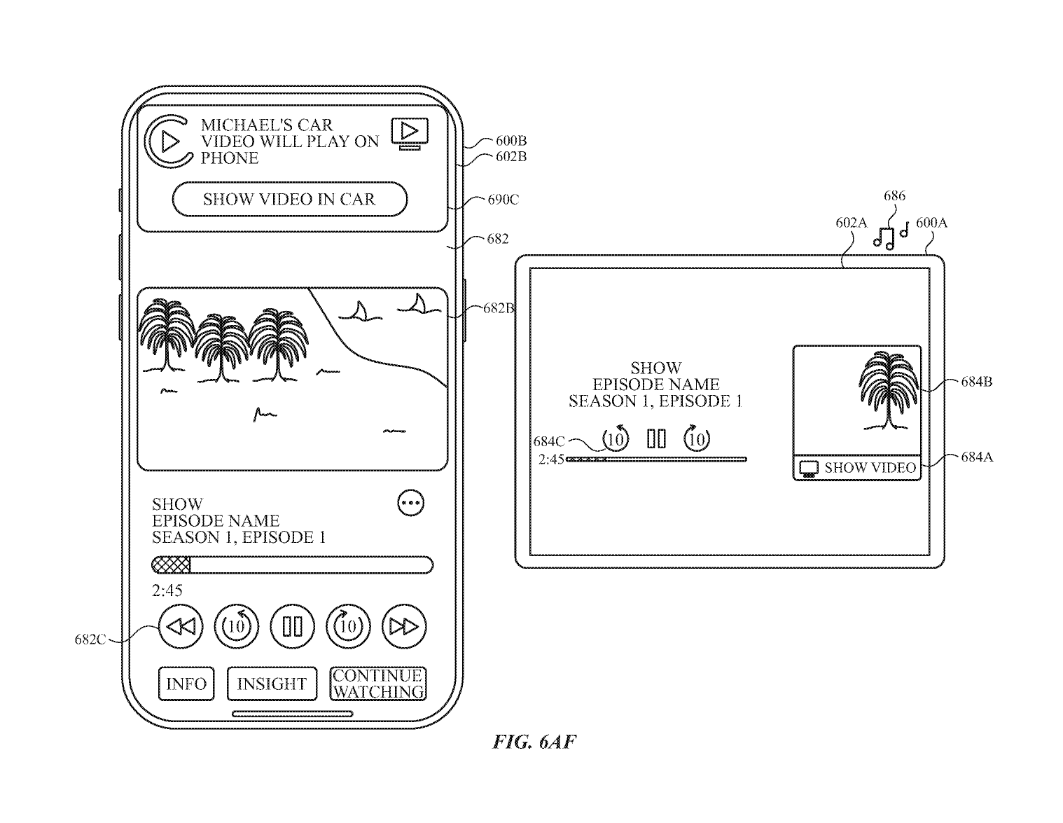

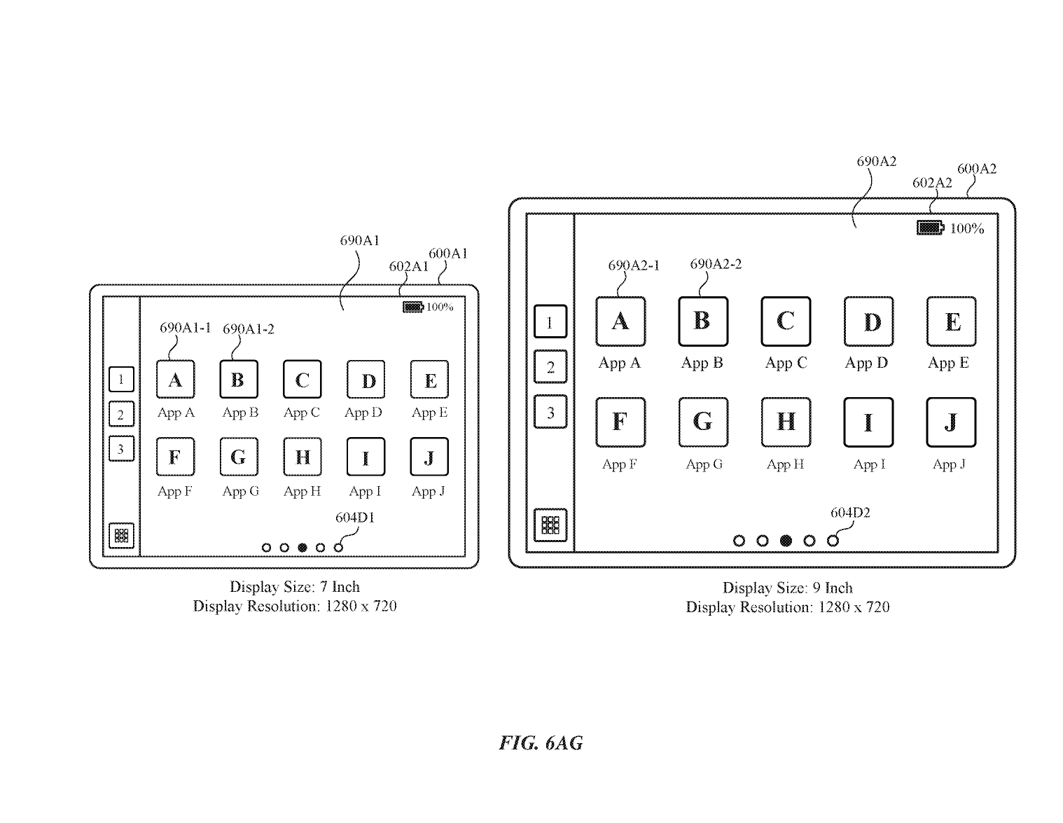

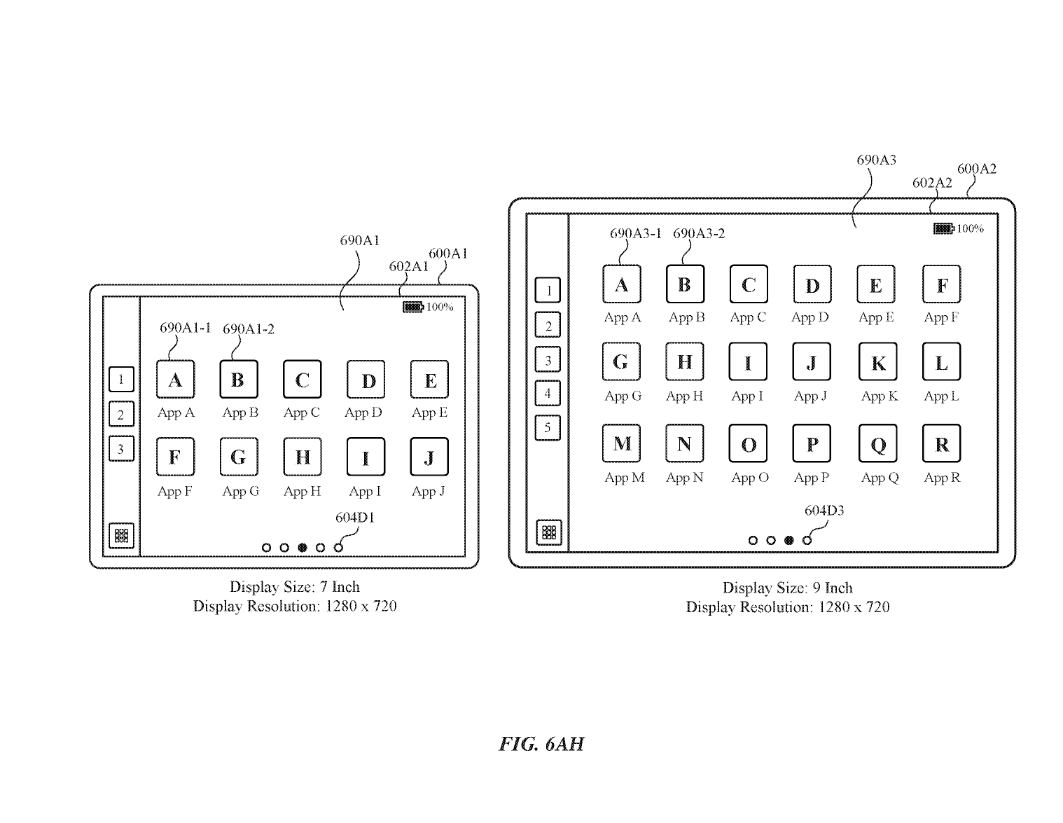

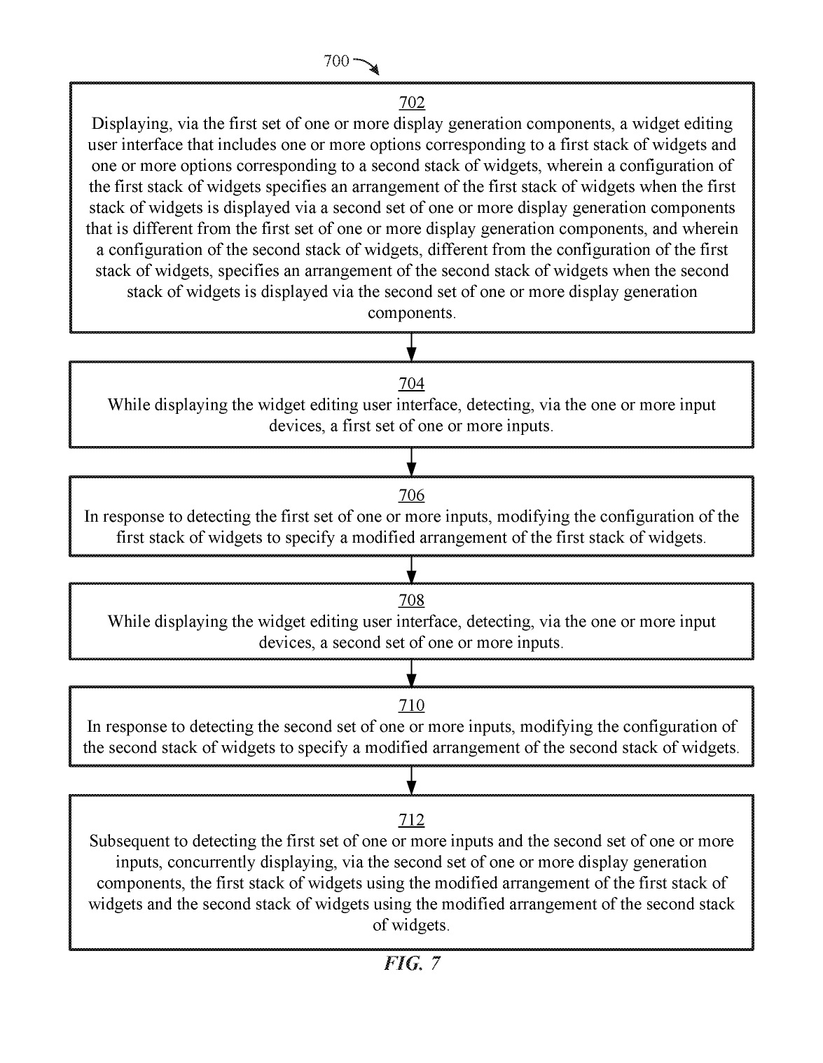

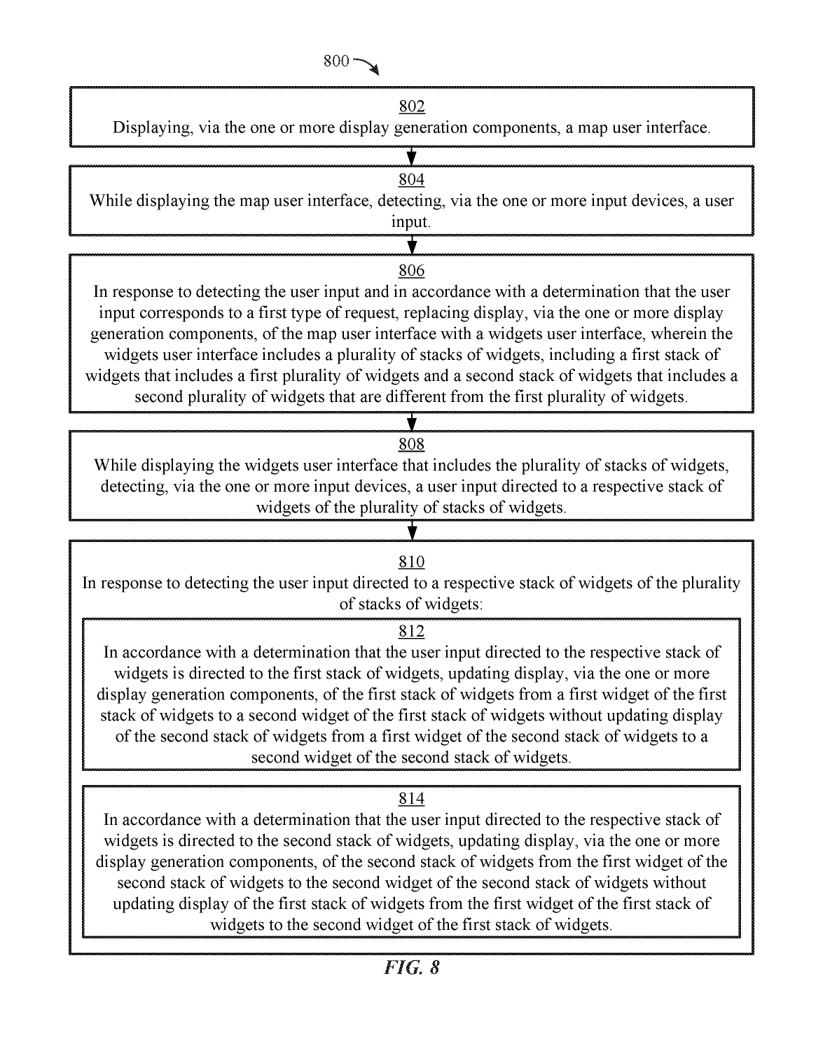

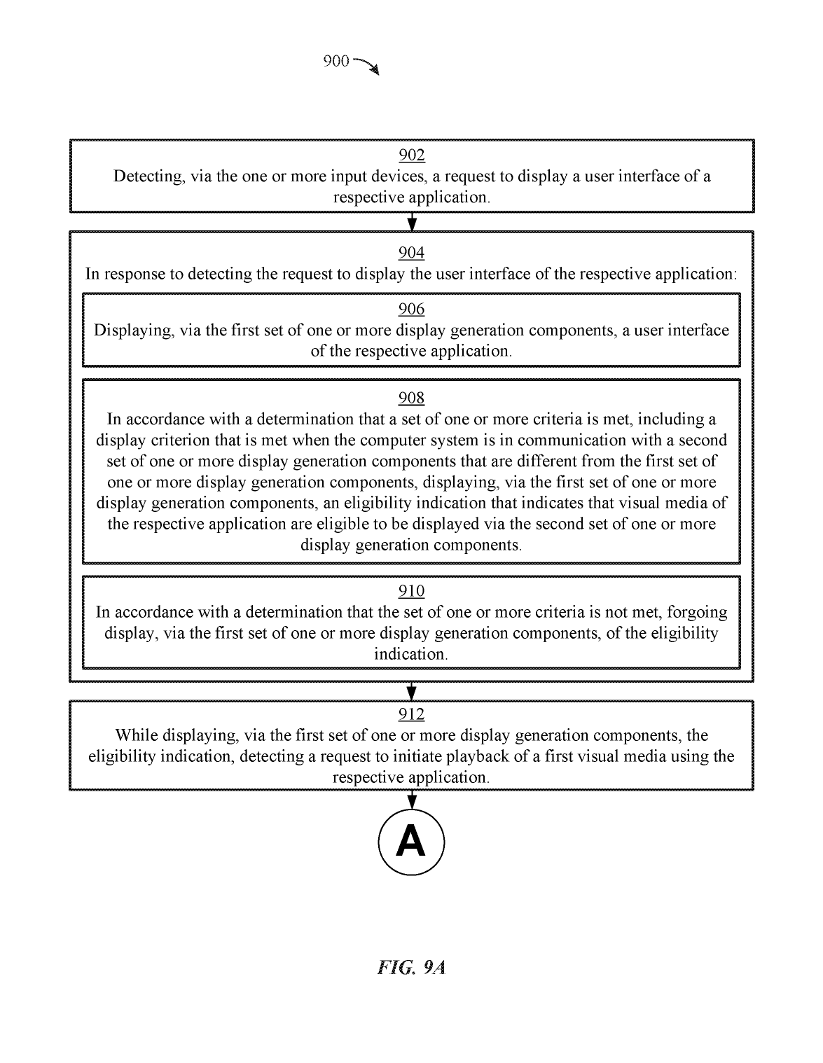

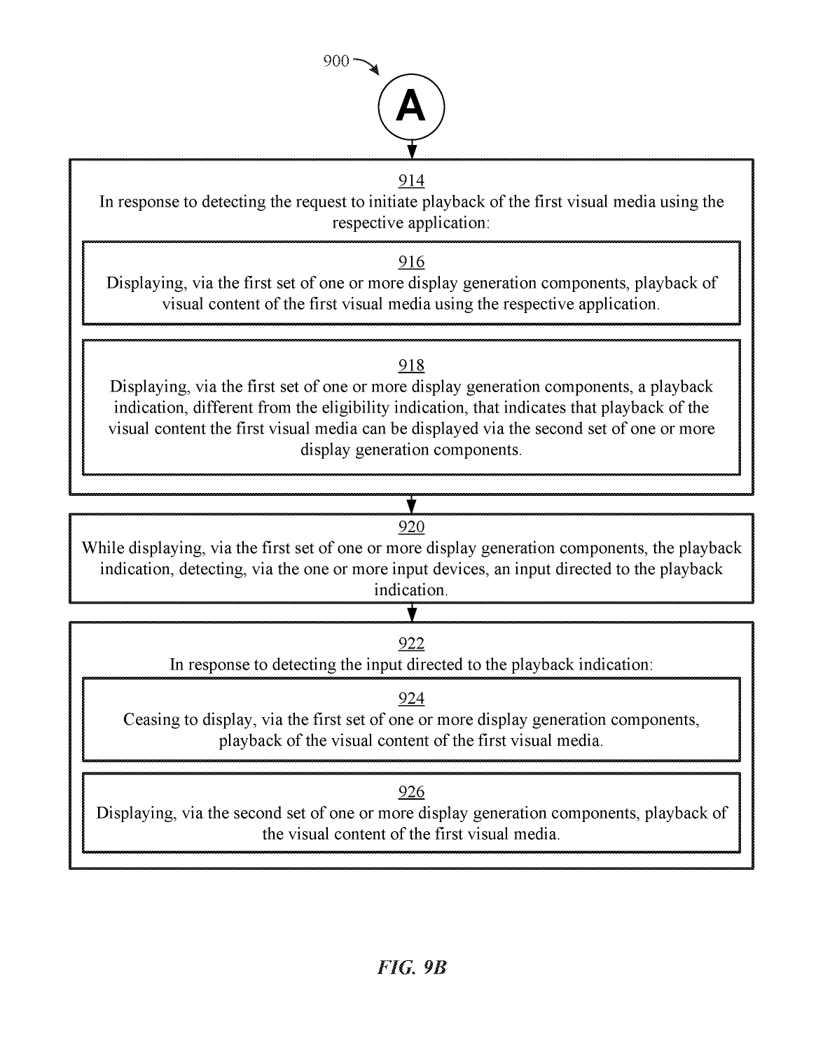

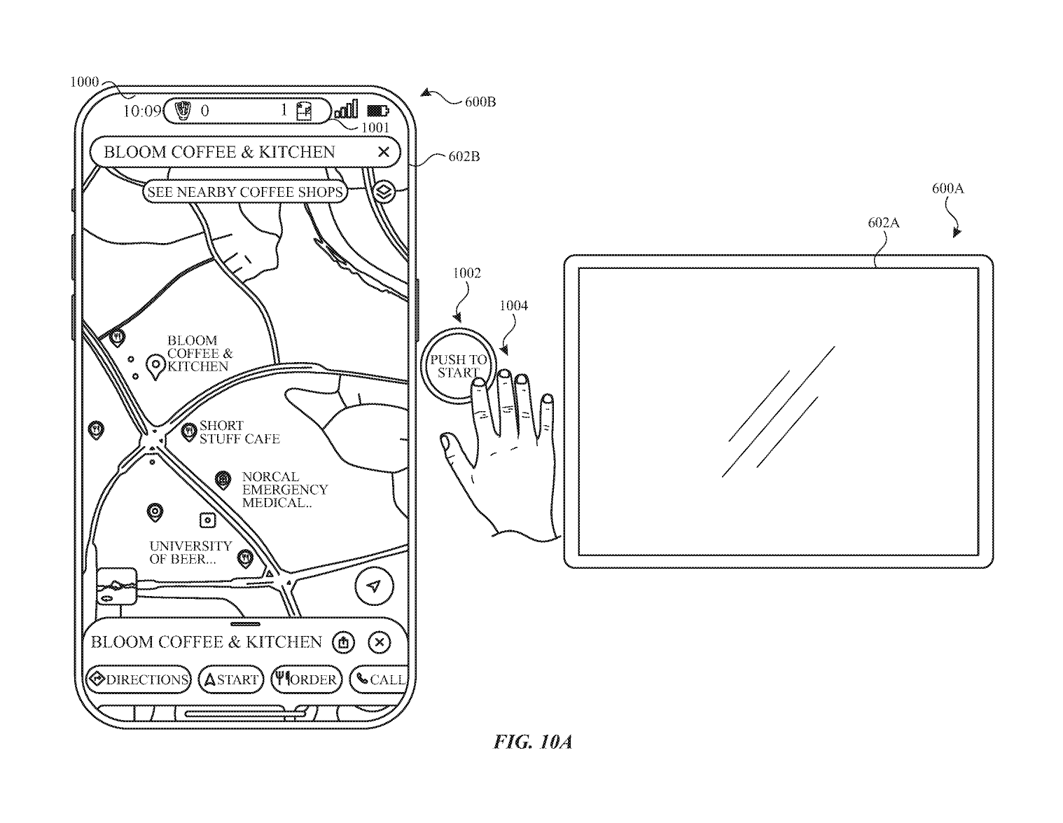

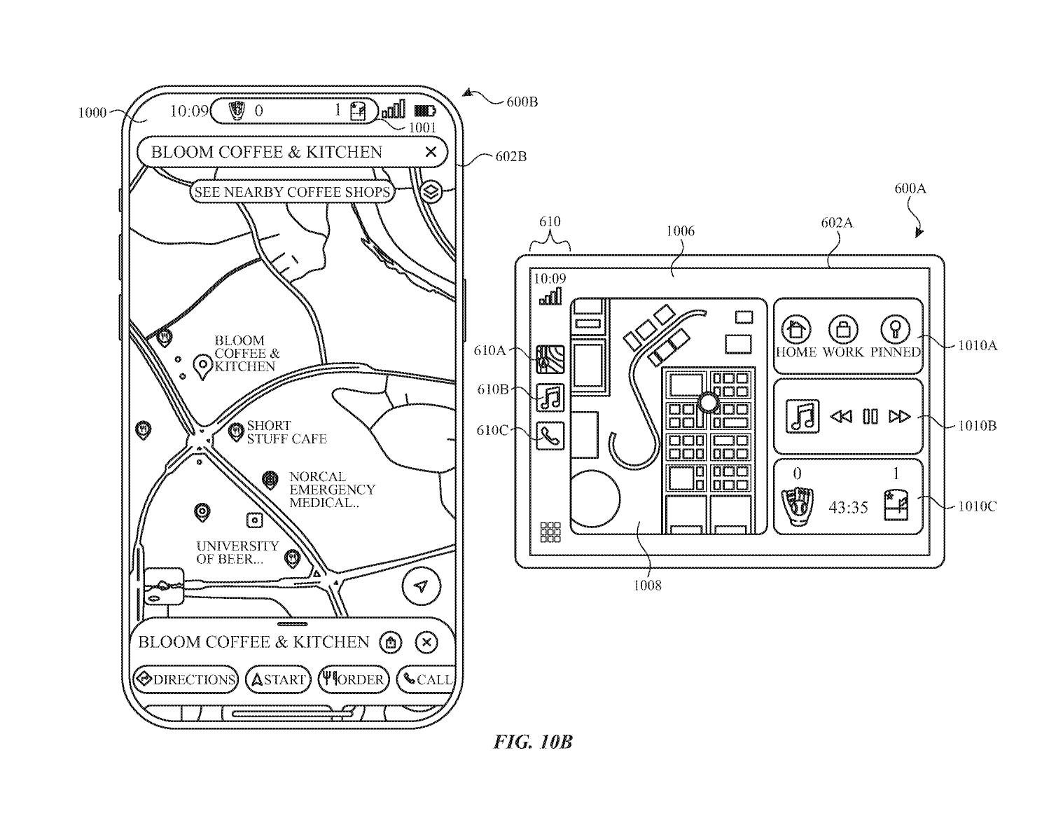

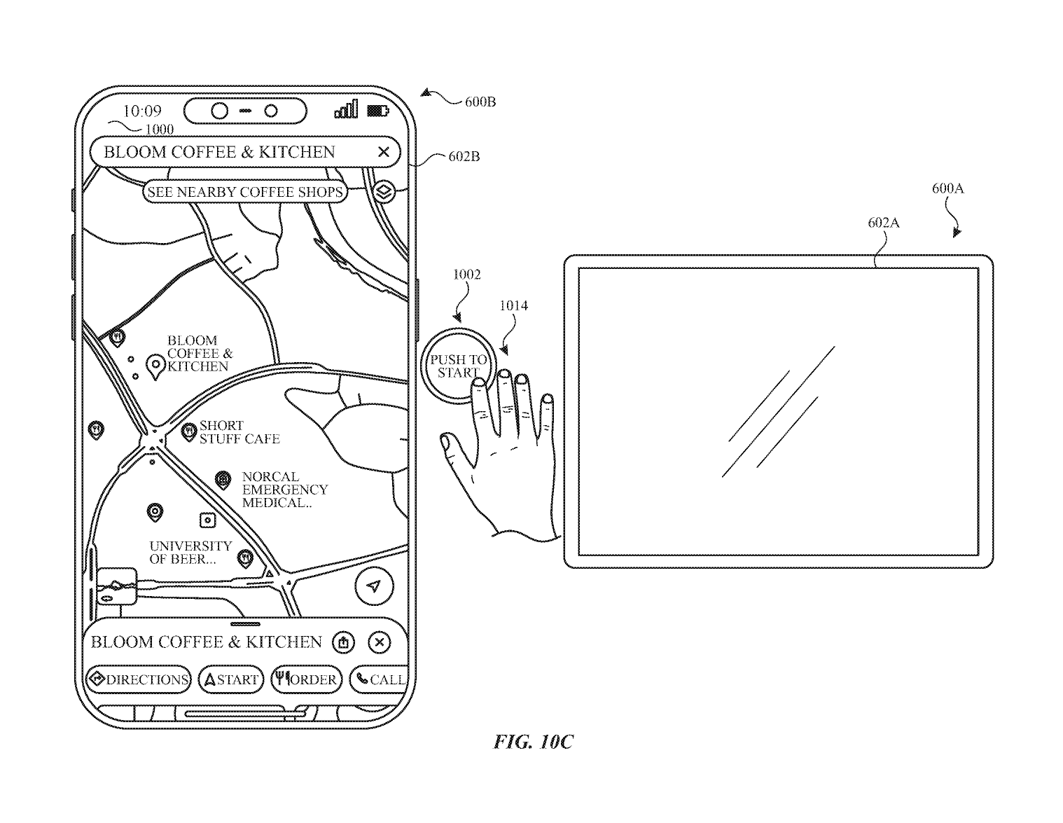

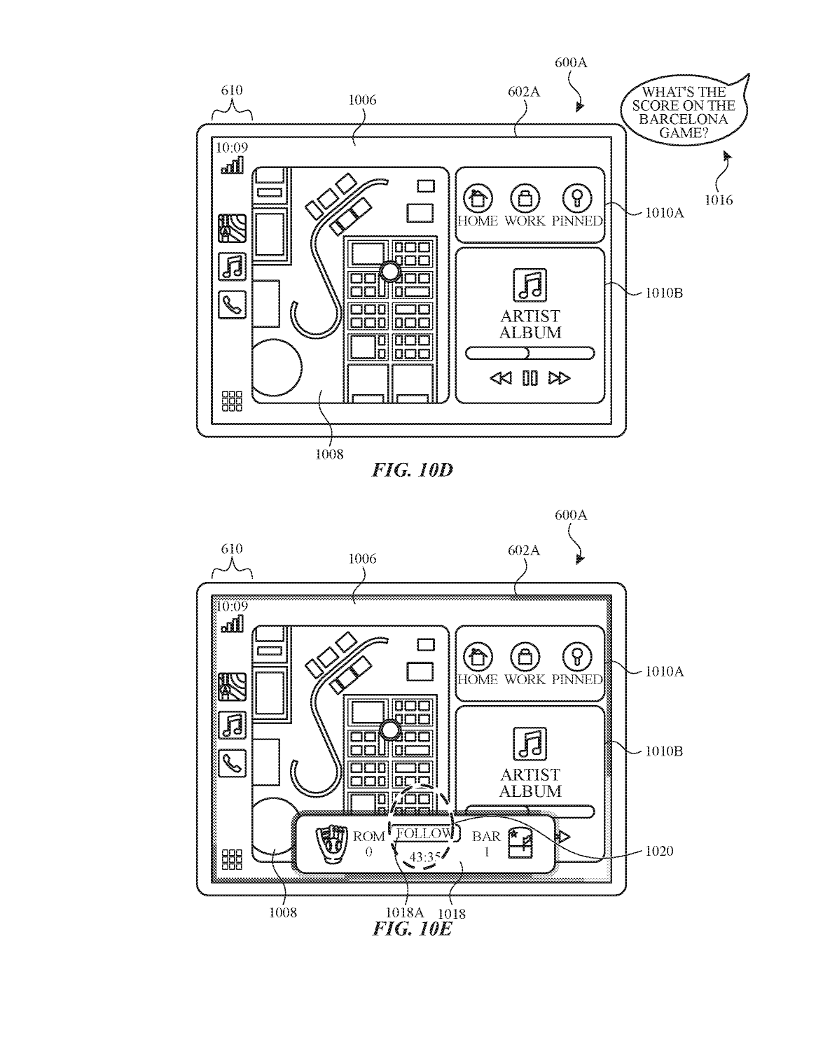

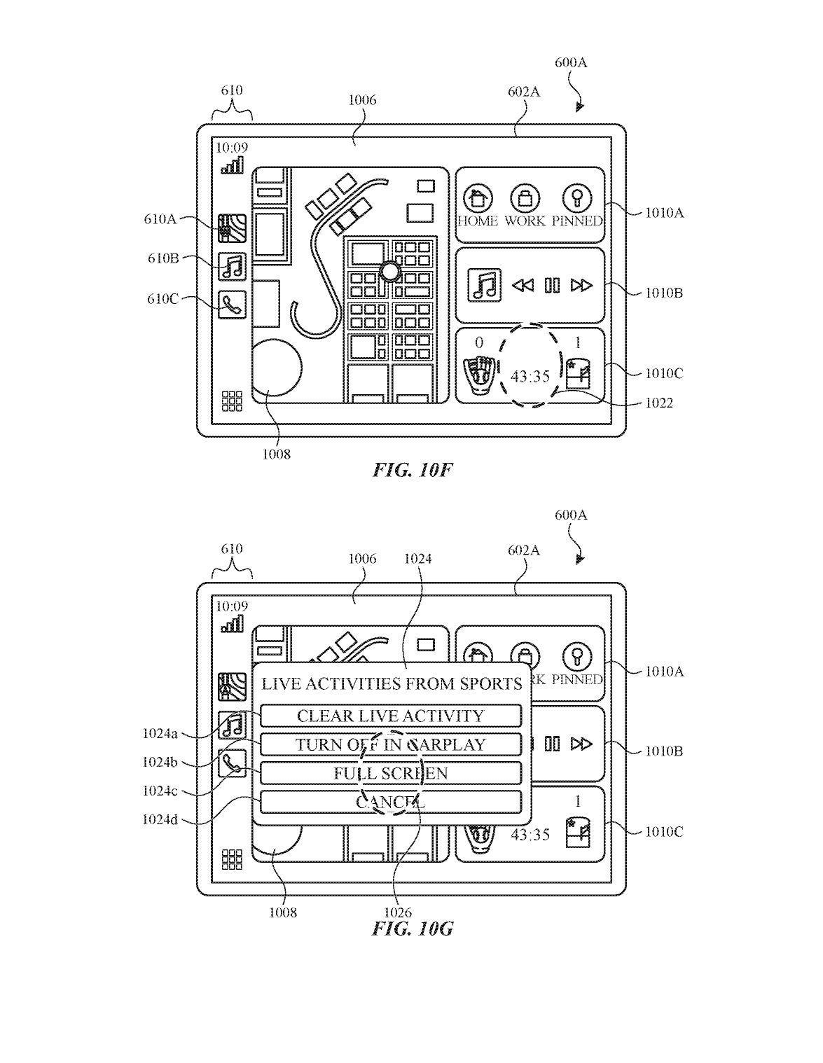

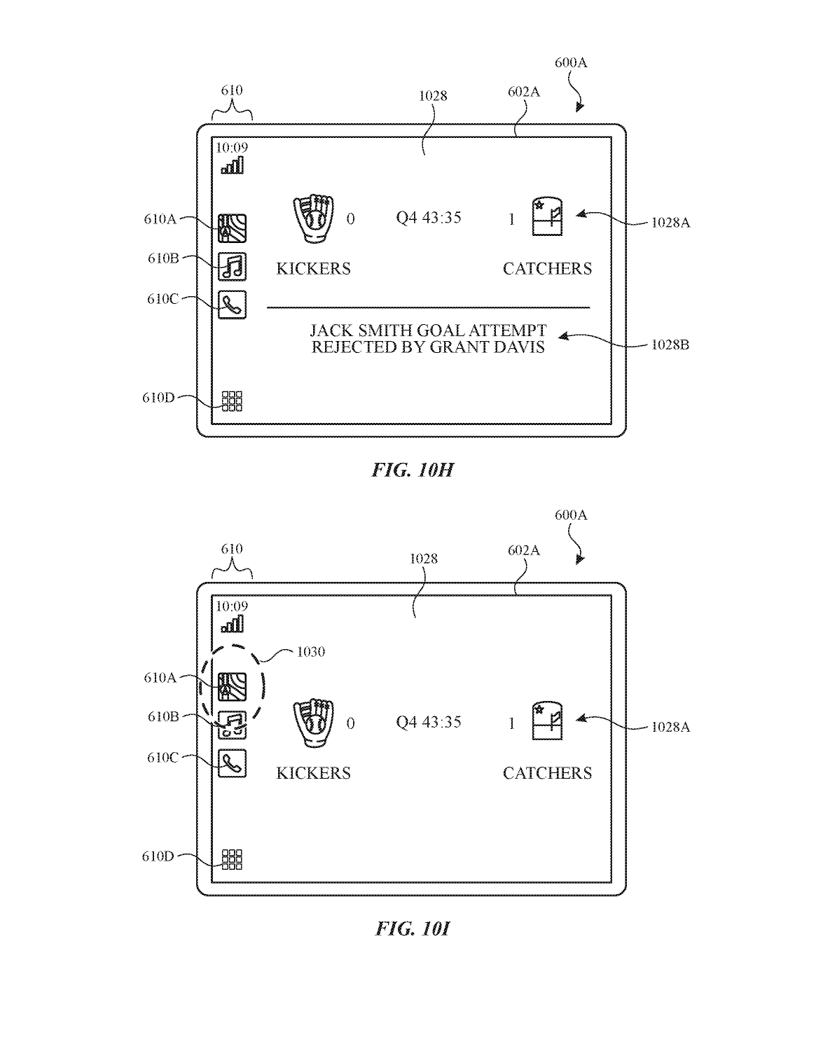

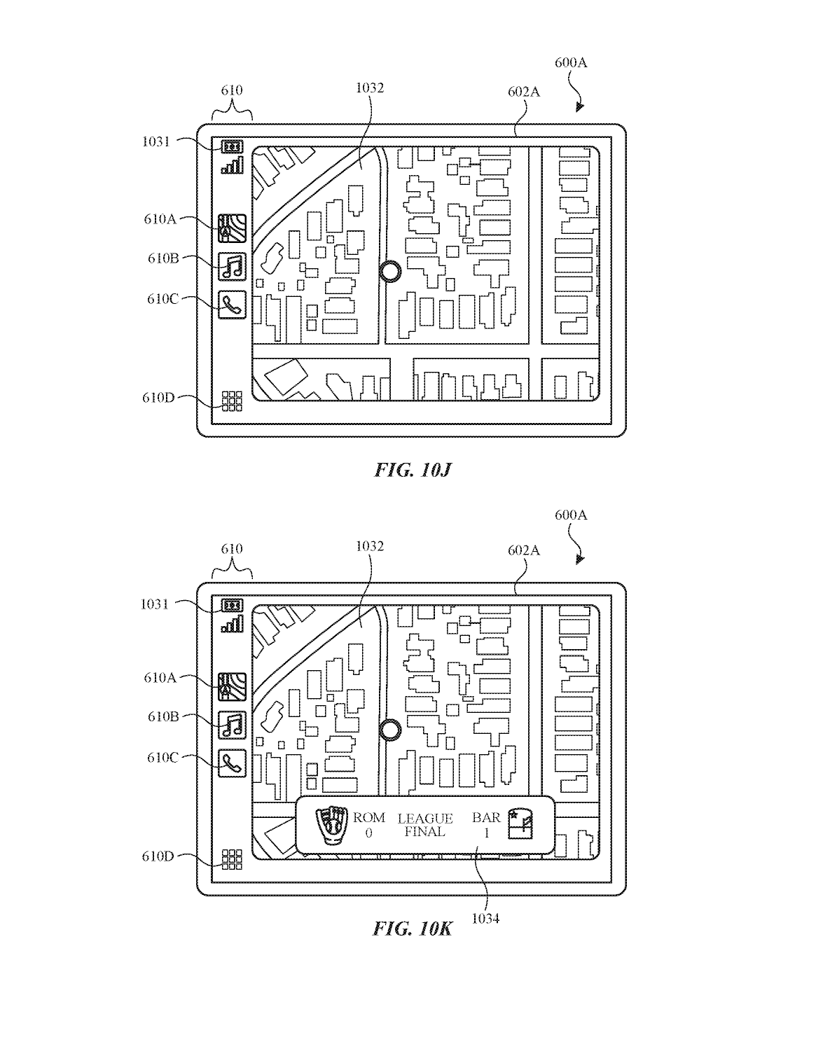

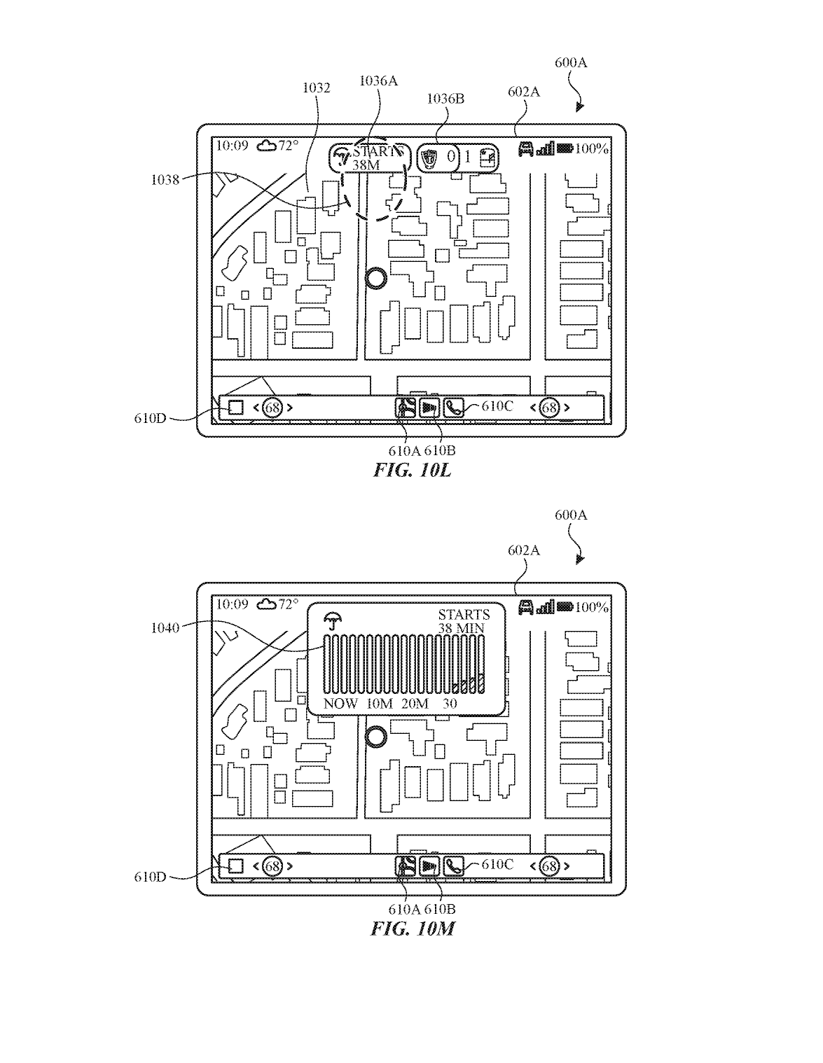

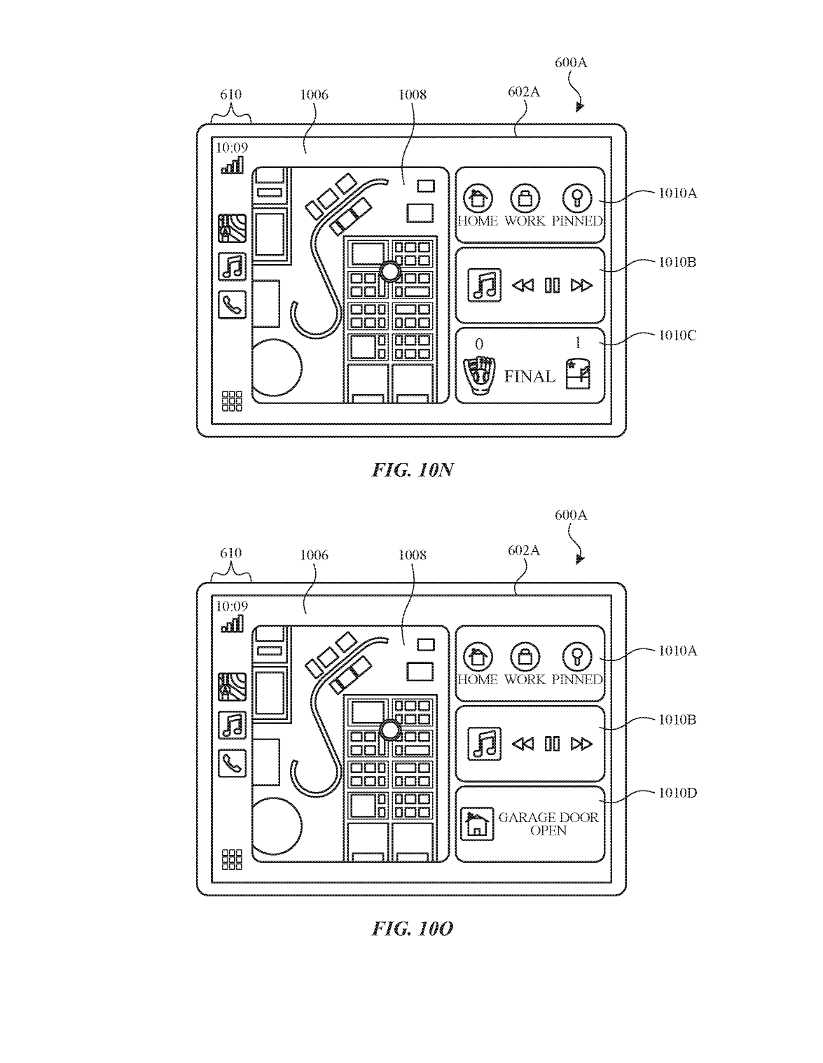

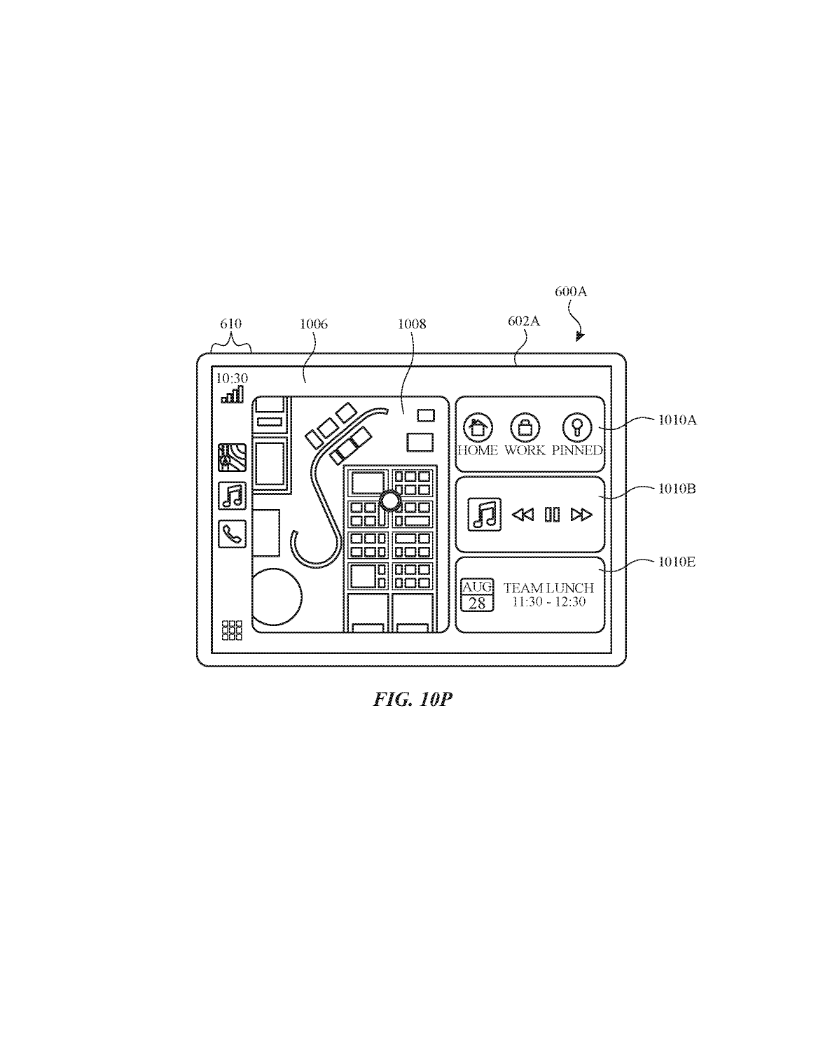

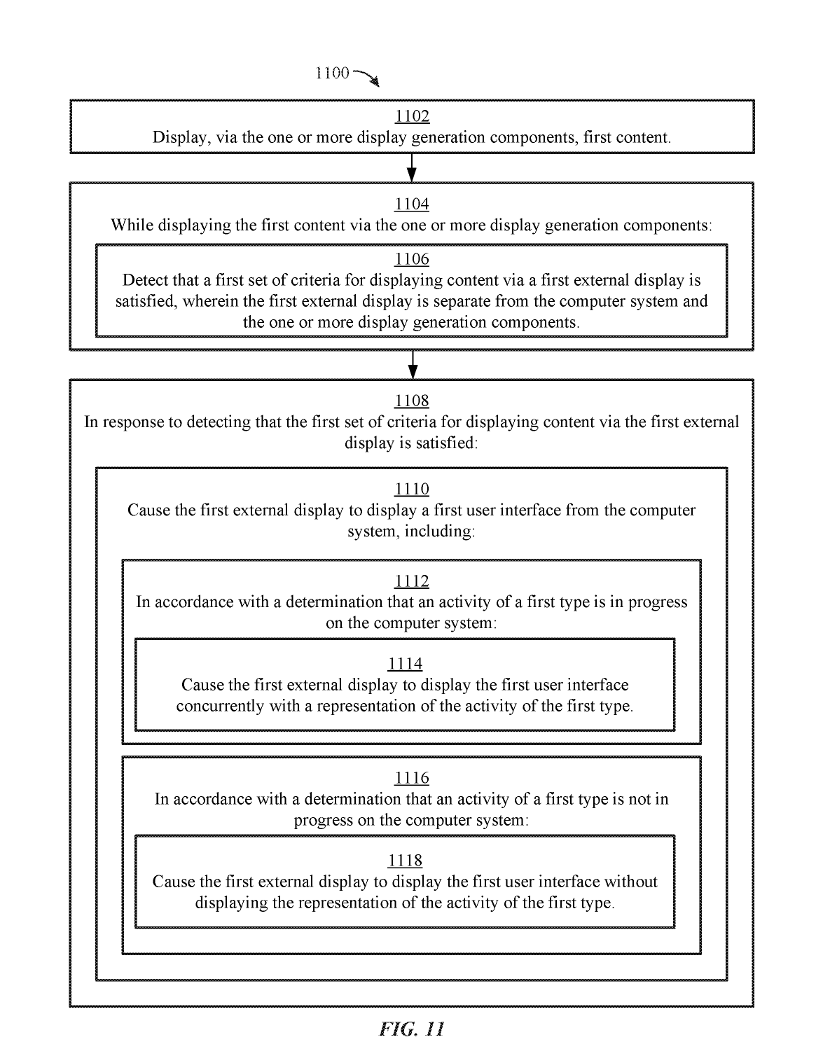

Below, FIGS. 1A-1B, 2, 3A-3G, 4A-4B, and 5A-5B provide a description of exemplary devices for performing the techniques for managing processes related to secondary displays. FIGS. 6A-6Y illustrate example user interfaces for interacting with stacks of widgets. FIGS. 6Z-6AF illustrate example user interfaces for managing media playback. FIGS. 6AG-6AH illustrate example techniques for displaying user interfaces on various displays. FIG. 7 is a flow diagram illustrating methods of managing stacks of widgets, in accordance with some embodiments. FIG. 8 is a flow diagram illustrating methods of displaying stacks of widgets, in accordance with some embodiments. FIGS. 9A-9B are a flow diagram illustrating methods of managing media playback, in accordance with some embodiments. The user interfaces in FIGS. 6A-6AH are used to illustrate the processes described below, including the processes in FIGS. 7, 8, and 9A-9B. FIGS. 10A-10P illustrate exemplary user interfaces for accessing event notifications. FIG. 11 is a flow diagram illustrating methods of accessing event notifications in accordance with some embodiments. The user interfaces in FIGS. 10A-10P are used to illustrate the processes described below, including the processes in FIG. 11.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

As used herein, the phrase “one or more of A and/or B” is construed to include all combinations of A and B, including, but not limited to: A individually without B; B individually without A; as well as a combination of A and B. The phrase “one or more of A, B, and/or C” is construed to include all combinations of A, B, and C, including, but not limited to: A individually without B and C; B individually without A and C; C individually without A and B; as well as any combinations of A, B, and/or C (e.g., A and B without C; A and C without B; B and C without A; and/or A, B, and C). Additionally, as used herein, the phrase “selected from the group consisting of A, B, C, and a combination thereof” and the phrase “at least one of A, B, and C” shall be construed to have the same meaning as the phrase “one or more of A, B, and/or C” as defined above. As used herein, the phrase “at least one of A, B, or C” and “one or more of A, B, or C” shall be construed to have the same meaning as the phrase “one or more of A, B, and/or C” as defined above. As used herein, the phrase “a combination including all of A, B, and C” is construed to include a combination of all the elements listed (e.g., a combination of A, B, and C).

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage media), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user’s sense of touch. For example, in situations where the device or the component of the device is in contact with a surface of a user that is sensitive to touch (e.g., a finger, palm, or other part of a user’s hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user’s movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

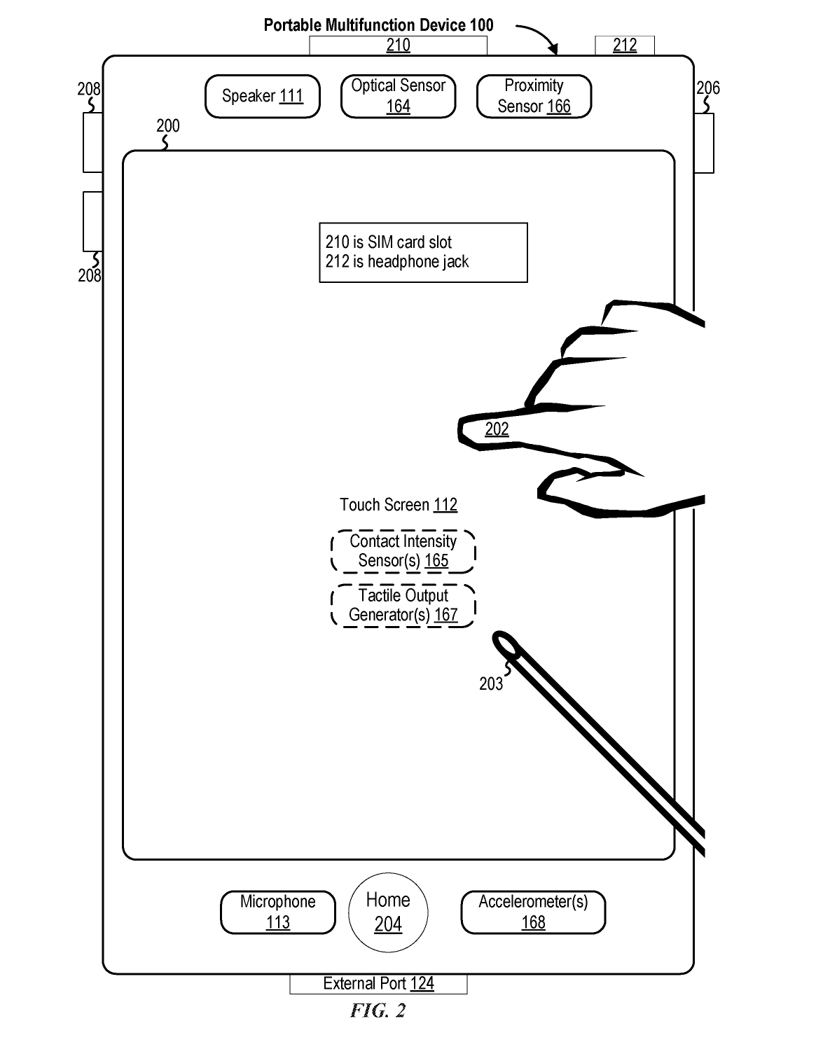

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user’s gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user’s body through the air including motion of the user’s body relative to an absolute reference (e.g., an angle of the user’s arm relative to the ground or a distance of the user’s hand relative to the ground), relative to another portion of the user’s body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user’s body (e.g., a tap gesture that includes movement of a hand in a predetermined pose by a predetermined amount and/or speed, or a shake gesture that includes a predetermined speed or amount of rotation of a portion of the user’s body).

A quick press of the push button optionally disengages a lock of touch screen 112 or optionally begins a process that uses gestures on the touch screen to unlock the device, as described in U.S. Patent Application 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Patents: 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. Patent Application No. 11/381,313, “Multipoint Touch Surface Controller,” filed May 2, 2006; (2) U.S. Patent Application No. 10/840,862, “Multipoint Touchscreen,” filed May 6, 2004; (3) U.S. Patent Application No. 10/903,964, “Gestures For Touch Sensitive Input Devices,” filed Jul. 30, 2004; (4) U.S. Patent Application No. 11/048,264, “Gestures For Touch Sensitive Input Devices,” filed Jan. 31, 2005; (5) U.S. Patent Application No. 11/038,590, “Mode-Based Graphical User Interfaces For Touch Sensitive Input Devices,” filed Jan. 18, 2005; (6) U.S. Patent Application No. 11/228,758, “Virtual Input Device Placement On A Touch Screen User Interface,” filed Sep. 16, 2005; (7) U.S. Patent Application No. 11/228,700, “Operation Of A Computer With A Touch Screen Interface,” filed Sep. 16, 2005; (8) U.S. Patent Application No. 11/228,737, “Activating Virtual Keys Of A Touch-Screen Virtual Keyboard,” filed Sep. 16, 2005; and (9) U.S. Patent Application No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user’s wrist since device 100 was unlocked by providing authentication credentials to device 100, where the continuous presence of device 100 on the user’s wrist is determined by periodically checking that the device is in contact with the user’s skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user’s image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user’s image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. Patent Application Nos. 11/241,839, “Proximity Detector In Handheld Device”; 11/240,788, “Proximity Detector In Handheld Device”; 11/620,702, “Using Ambient Light Sensor To Augment Proximity Sensor Output”; 11/586,862, “Automated Response To And Sensing Of User Activity In Portable Devices”; and 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user’s ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

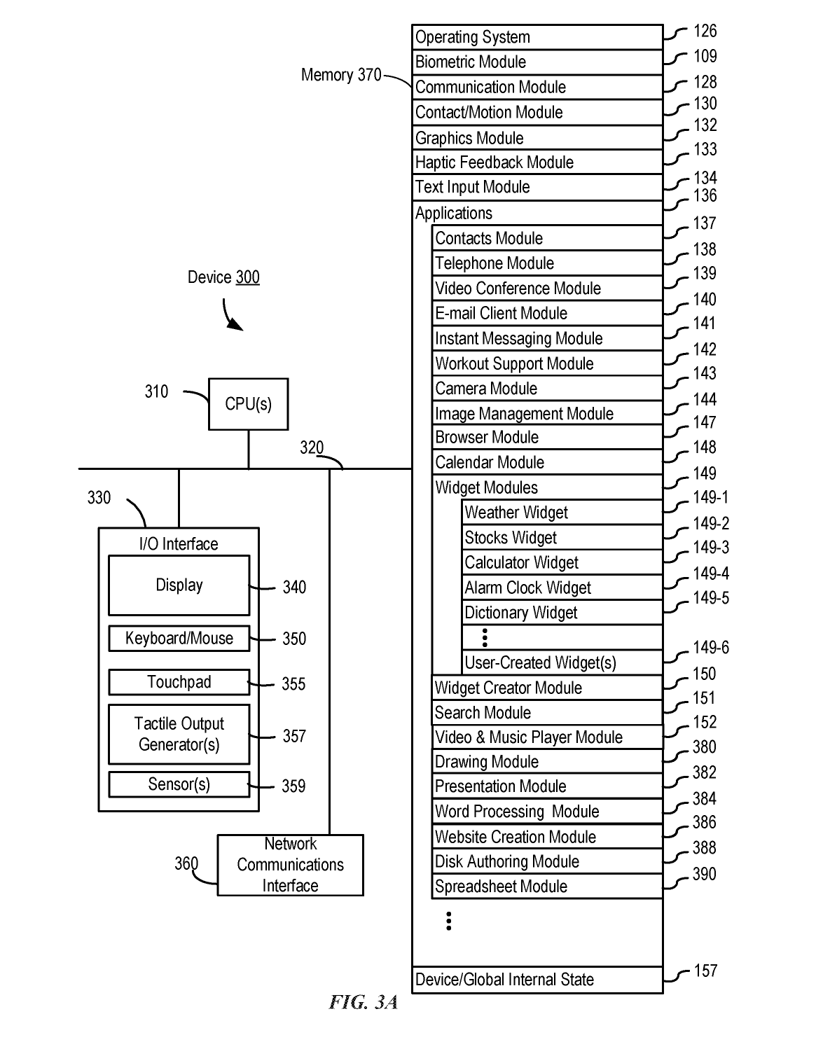

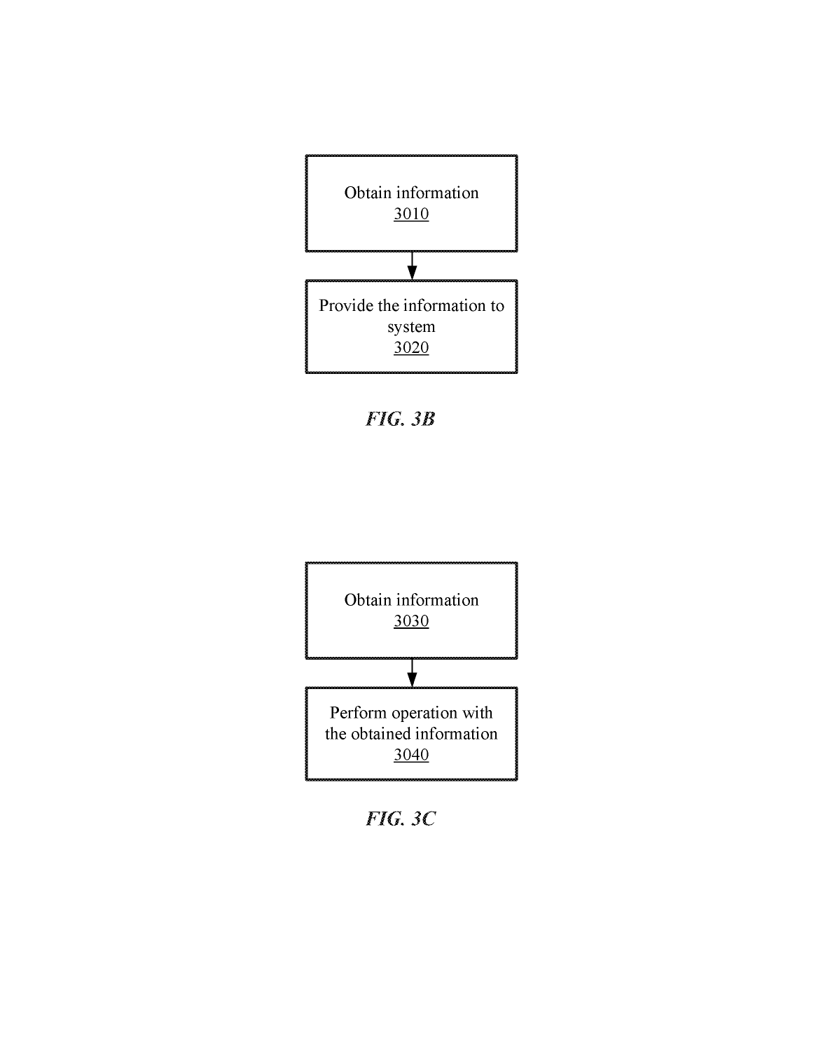

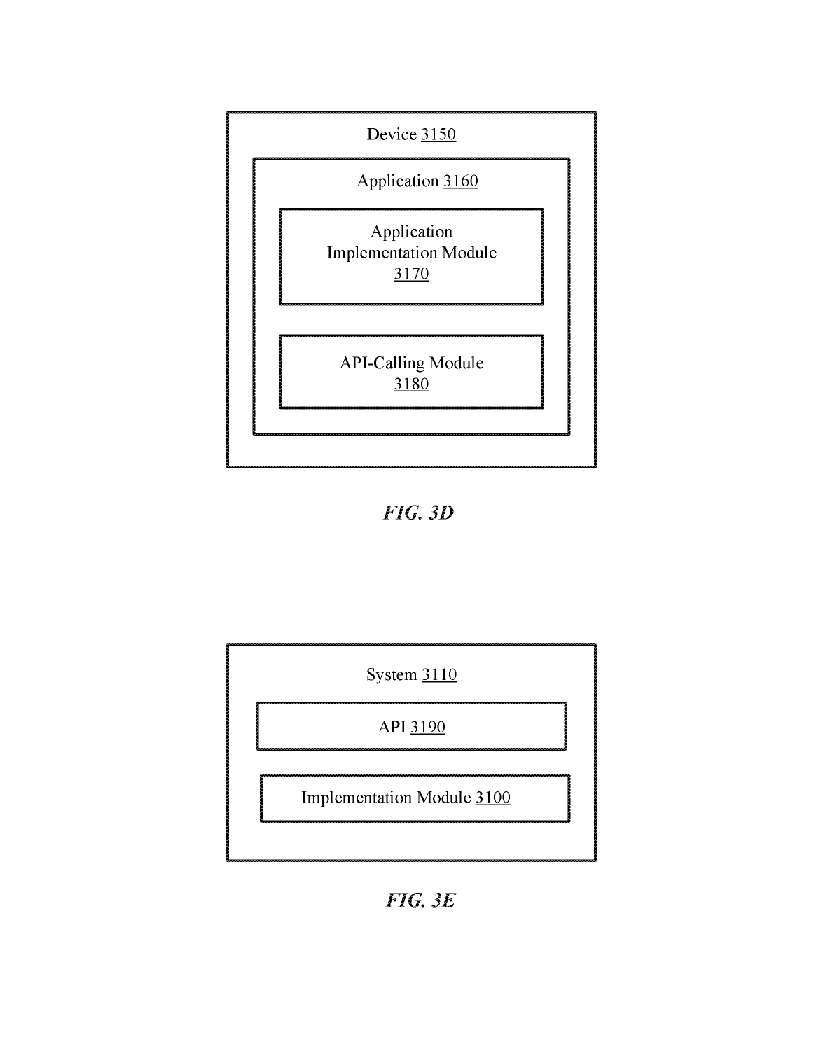

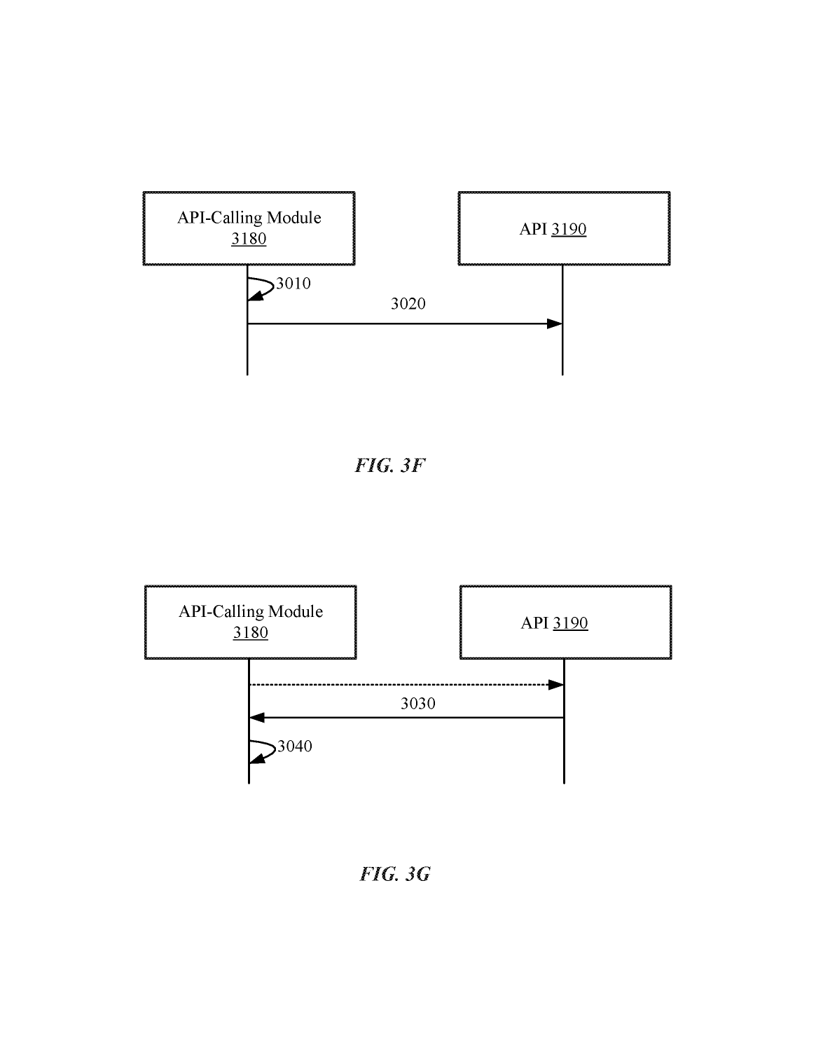

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device’s various sensors and input control devices 116; and location information concerning the device’s location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE®, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript® file (e.g., Yahoo!® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. Patent Application No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application’s user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer’s event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child’s learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIGS. 3B and 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIGS. 3C and 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700 (FIG. 7), 800 (e.g., FIG. 8), 900 (FIGS. 9A-9B), and/or 1100 (FIG. 11) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

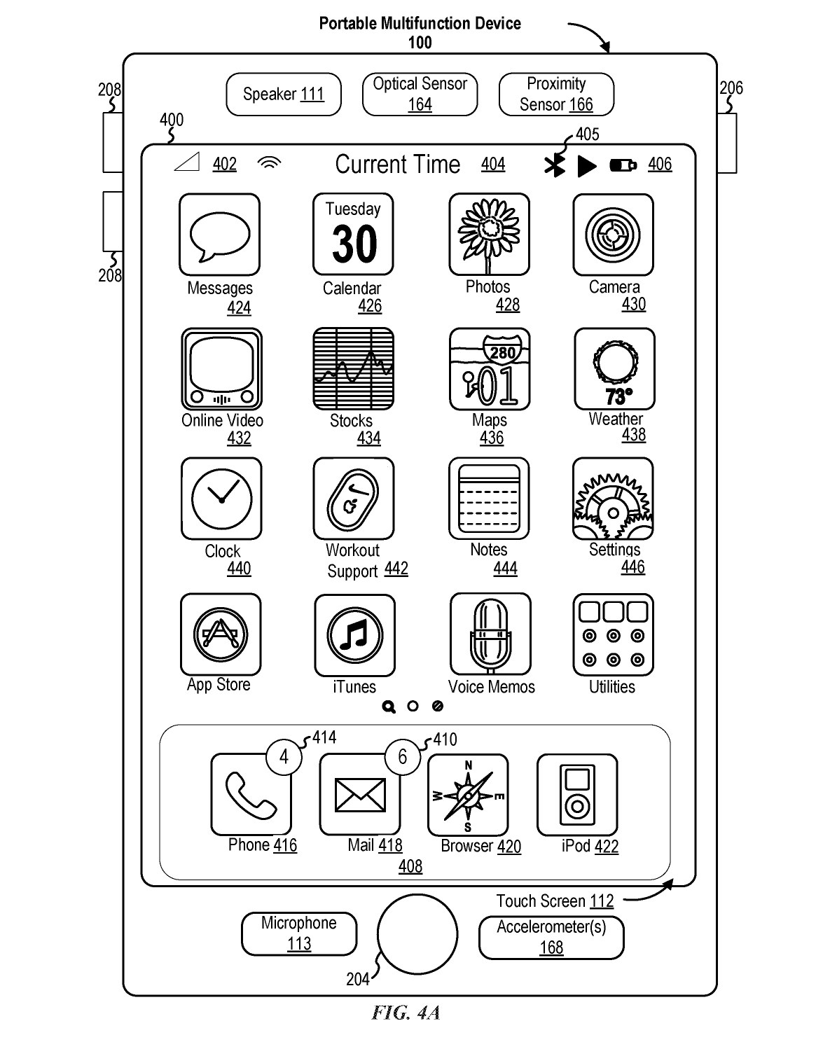

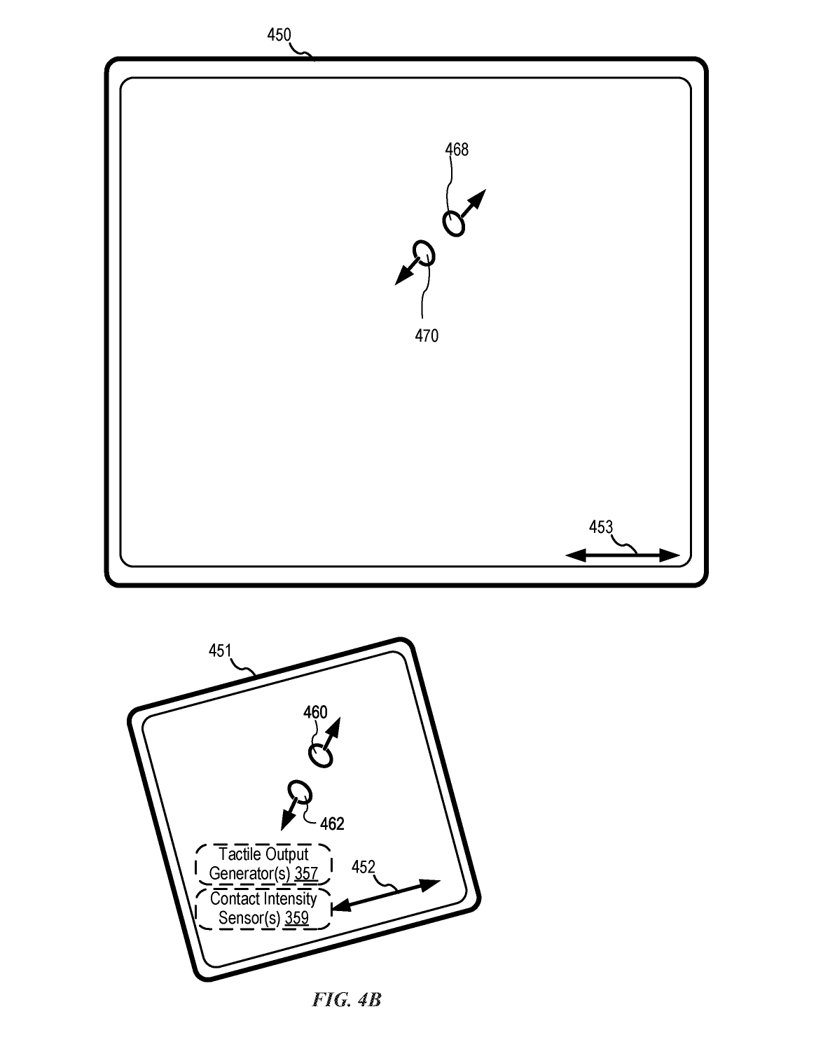

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled "Phone," which optionally includes an indicator 414 of the number of missed calls or voicemail messages;
   Icon 418 for e-mail client module 140, labeled "Mail," which optionally includes an indicator 410 of the number of unread e-mails;
   Icon 420 for browser module 147, labeled "Browser;" and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

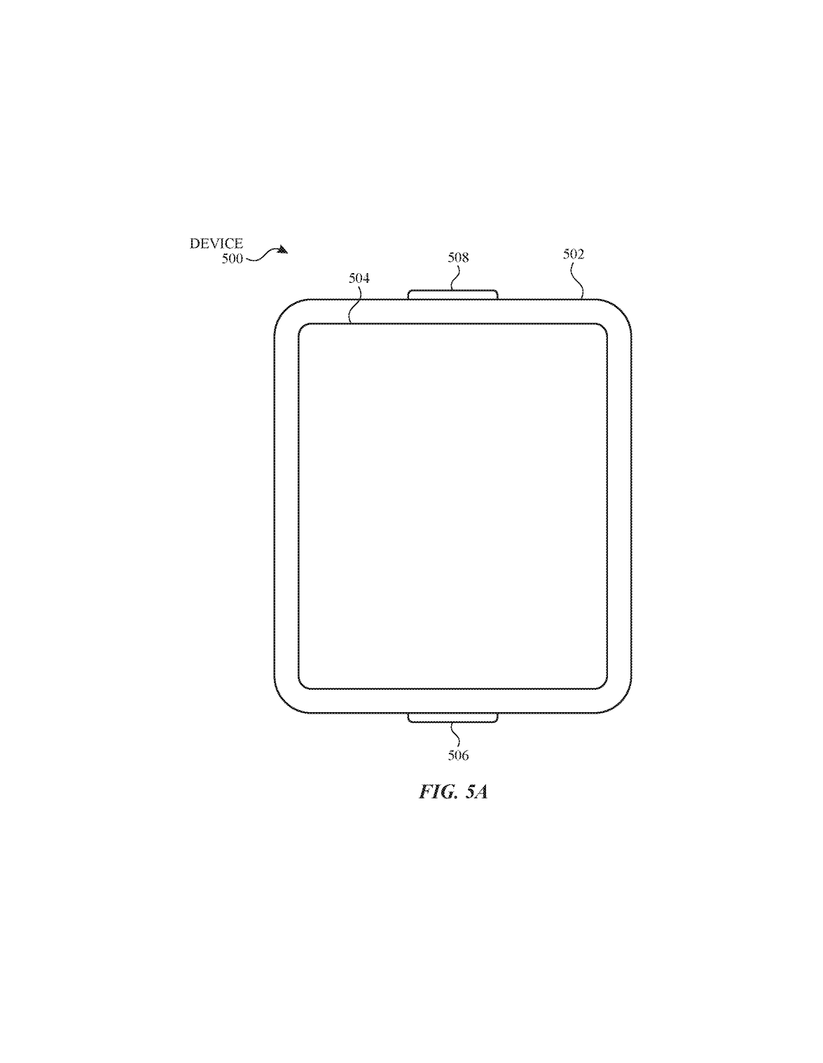

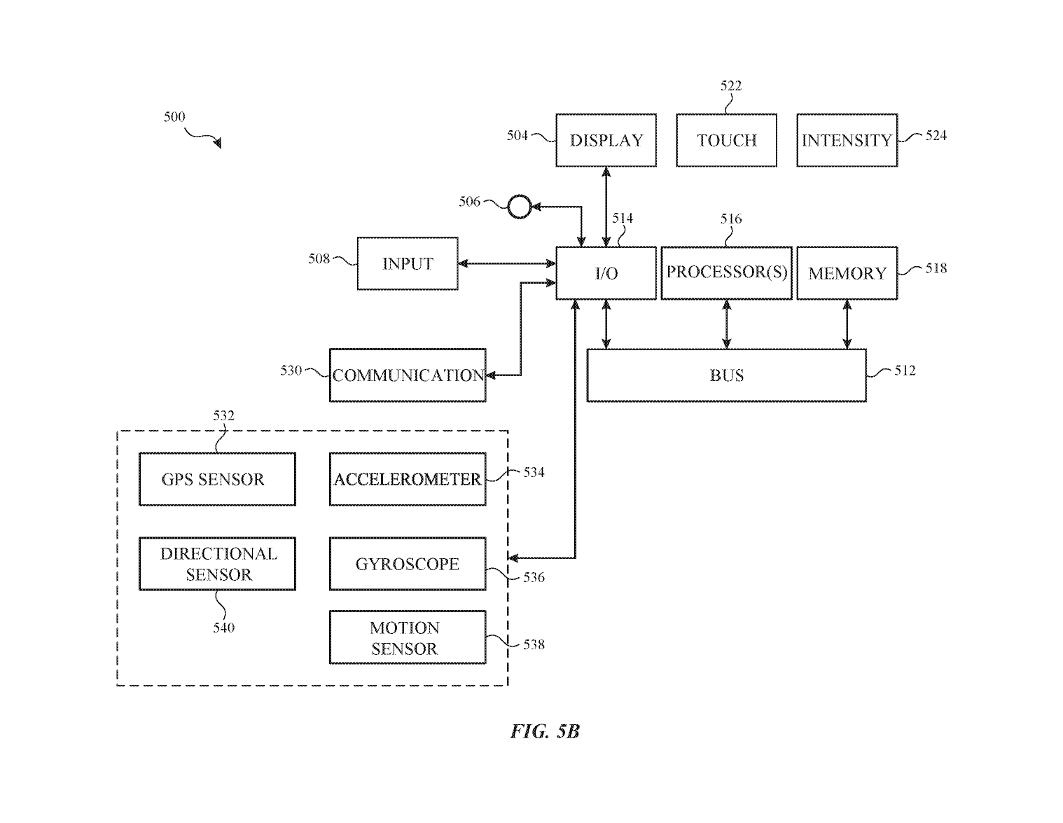

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage media, for storing computer-executable instructions, which, when executed by one or more computer processors 516, for example, can cause the computer processors to perform the techniques described below, including processes 700-900 and 1100 (FIGS. 7-9B and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray® technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user’s intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates exemplary devices connected via one or more communication channels to participate in a transaction in accordance with some embodiments. One or more exemplary electronic devices (e.g., devices 100, 300, and 500) are configured to optionally detect input (e.g., a particular user input, an NFC field) and optionally transmit payment information (e.g., using NFC). The one or more electronic devices optionally include NFC hardware and are configured to be NFC-enabled.

The electronic devices (e.g., devices 100, 300, and 500) are optionally configured to store payment account information associated with each of one or more payment accounts. Payment account information includes, for example, one or more of: a person’s or company’s name, a billing address, a login, a password, an account number, an expiration date, a security code, a telephone number, a bank associated with the payment account (e.g., an issuing bank), and a card network identifier. In some embodiments, payment account information includes include an image, such as a picture of a payment card (e.g., taken by the device and/or received at the device). In some embodiments, the electronic devices receive user input including at least some payment account information (e.g., receiving user-entered credit, debit, account, or gift card number and expiration date). In some embodiments, the electronic devices detect at least some payment account information from an image (e.g., of a payment card captured by a camera sensor of the device). In some embodiments, the electronic devices receive at least some payment account information from another device (e.g., another user device or a server). In some embodiments, the electronic device receives payment account information from a server associated with another service for which an account for a user or user device previously made a purchase or identified payment account data (e.g., an app for renting or selling audio and/or video files).

In some embodiments, a payment account is added to an electronic device (e.g., device 100, 300, and 500), such that payment account information is securely stored on the electronic device (e.g., on secure element 163). In some embodiments, after a user initiates such process, the electronic device transmits information for the payment account to a transaction-coordination server, which then communicates with a server operated by a payment network for the account (e.g., a payment server) to ensure a validity of the information. The electronic device is optionally configured to receive a script from the server that allows the electronic device to program payment information for the account onto a secure element (e.g., secure element 163).

In some embodiments, communication among electronic devices 100, 300, and 500 facilitates transactions (e.g., generally or specific transactions). For example, a first electronic device (e.g., 100) can serve as a provisioning or managing device, and can send notifications of new or updated payment account data (e.g., information for a new account, updated information for an existing account, and/or an alert pertaining to an existing account) to a second electronic device (e.g., 500). In another example, a first electronic device (e.g., 100) can send data to a second election device, wherein the data reflects information about payment transactions facilitated at the first electronic device. The information optionally includes one or more of: a payment amount, an account used, a time of purchase, and whether a default account was changed. The second device (e.g., 500) optionally uses such information to update a default payment account (e.g., based on a learning algorithm or explicit user input).

Electronic devices (e.g., 100, 300, 500) are configured to communicate with each other over any of a variety of networks. For example, the devices communicate using a Bluetooth connection 558 (e.g., which includes a traditional Bluetooth connection or a Bluetooth Low Energy connection) or using a WiFi network 556. Communications among user devices are, optionally, conditioned to reduce the possibility of inappropriately sharing information across devices. For example, communications relating to payment information requires that the communicating devices be paired (e.g., be associated with each other via an explicit user interaction) or be associated with a same user account.

In some embodiments, an electronic device (e.g., 100, 300, 500) is used to communicate with a point-of-sale (POS) payment terminal 550, which is optionally NFC-enabled. The communication optionally occurs using a variety of communication channels and/or technologies. In some embodiments, electronic device (e.g., 100, 300, 500) communicates with payment terminal 550 using an NFC channel 560. In some embodiments, payment terminal 550 communicates with an electronic device (e.g., 100, 300, 500) using a peer-to-peer NFC mode. Electronic device (e.g., 100, 300, 500) is optionally configured transmit a signal to payment terminal 550 that includes payment information for a payment account (e.g., a default account or an account selected for the particular transaction).

In some embodiments, proceeding with a transaction includes transmitting a signal that includes payment information for an account, such as a payment account. In some embodiments, proceeding with the transaction includes reconfiguring the electronic device (e.g., 100, 300, 500) to respond as a contactless payment card, such as an NFC-enabled contactless payment card, and then transmitting credentials of the account via NFC, such as to payment terminal 550. In some embodiments, subsequent to transmitting credentials of the account via NFC, the electronic device reconfigures to not respond as a contactless payment card (e.g., requiring authorization before again reconfigured to respond as a contactless payment card via NFC).

In some embodiments, generation of and/or transmission of the signal is controlled by a secure element (e.g., 163) in the electronic device (e.g., 100, 300, 500). The secure element (e.g., 163) optionally requires a particular user input prior to releasing payment information. For example, the secure element (e.g., 163) optionally requires detection that the electronic device is being worn, detection of a button press, detection of entry of a passcode, detection of a touch, detection of one or more option selections (e.g., received while interacting with an application), detection of a fingerprint signature, detection of a voice or voice command, and or detection of a gesture or movement (e.g., rotation or acceleration). In some embodiments, if a communication channel (e.g., an NFC communication channel) with another device (e.g., payment terminal 550) is established within a defined time period from detection of the input, the secure element (e.g., 163) releases payment information to be transmitted to the other device (e.g., payment terminal 550). In some embodiments, the secure element (e.g., 163) is a hardware component that controls release of secure information. In some embodiments, the secure element is a software component that controls release of secure information.

In some embodiments, protocols related to transaction participation depend on, for example, device types. For example, a condition for generating and/or transmitting payment information can be different for a wearable device (e.g., device 500) and a phone (e.g., device 100). For example, a generation and/or transmission condition for a wearable device includes detecting that a button has been pressed (e.g., after a security verification), while a corresponding condition for a phone does not require button-depression and instead requires detection of particular interaction with an application. In some embodiments, a condition for transmitting and/or releasing payment information includes receiving particular input on each of multiple devices. For example, release of payment information optionally requires detection of a fingerprint and/or passcode at the device (e.g., device 100) and detection of a mechanical input (e.g., button press) on another device (e.g., device 500).

Payment terminal 550 optionally uses the payment information to generate a signal to transmit to a payment server 554 to determine whether the payment is authorized. Payment server 554 optionally includes any device or system configured to receive payment information associated with a payment account and to determine whether a proposed purchase is authorized. In some embodiments, payment server 554 includes a server of an issuing bank. Payment terminal 550 communicates with payment server 554 directly or indirectly via one or more other devices or systems (e.g., a server of an acquiring bank and/or a server of a card network).

Payment server 554 optionally uses at least some of the payment information to identify a user account from among a database of user accounts (e.g., 552). For example, each user account includes payment information. An account is, optionally, located by locating an account with particular payment information matching that from the POS communication. In some embodiments, a payment is denied when provided payment information is not consistent (e.g., an expiration date does not correspond to a credit, debit, or gift card number) or when no account includes payment information matching that from the POS communication.

In some embodiments, data for the user account further identifies one or more restrictions (e.g., credit limits); current or previous balances; previous transaction dates, locations and/or amounts; account status (e.g., active or frozen), and/or authorization instructions. In some embodiments, the payment server (e.g., 554) uses such data to determine whether to authorize a payment. For example, a payment server denies a payment when a purchase amount added to a current balance would result in exceeding an account limit, when an account is frozen, when a previous transaction amount exceeds a threshold, or when a previous transaction count or frequency exceeds a threshold.

In some embodiments, payment server 554 responds to POS payment terminal 550 with an indication as to whether a proposed purchase is authorized or denied. In some embodiments, POS payment terminal 550 transmits a signal to the electronic device (e.g., 100, 300, 500) to identify the result. For example, POS payment terminal 550 sends a receipt to the electronic device (e.g., 100, 300, 500) when a purchase is authorized (e.g., via a transaction-coordination server that manages a transaction app on the user device). In some instances, POS payment terminal 550 presents an output (e.g., a visual or audio output) indicative of the result. Payment can be sent to a merchant as part of the authorization process or can be subsequently sent.

In some embodiments, the electronic device (e.g., 100, 300, 500) participates in a transaction that is completed without involvement of POS payment terminal 550. For example, upon detecting that a mechanical input has been received, a secure element (e.g., 163) in the electronic device (e.g., 100, 300, 500) releases payment information to allow an application on the electronic device to access the information (e.g., and to transmit the information to a server associated with the application).

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

Attention is now directed towards embodiments of user interfaces (“UI”) and associated processes that are implemented on an electronic device, such as portable multifunction device 100, device 300, or device 500.

FIGS. 6A-6Y illustrate example user interfaces for interacting with stacks of widgets. FIGS. 6Z-6AF illustrate example user interfaces for managing media playback. FIGS. 6AG-6AH illustrate example techniques for displaying user interfaces on various displays, in accordance with some embodiments. The user interfaces in these figures are used to illustrate the processes described below, including the processes in FIGS. 7, 8, and 9A-9B.

FIG. 6A illustrates computer system 600A, which includes display 602A. In some embodiments, computer system 600A is integrated into a vehicle, such as a car or truck. In some embodiments, display 602A is integrated into a dashboard or console of the vehicle, such as in the center console. In some embodiments, computer system 600A and computer system 600B (e.g., shown in FIG. 6M) are part of the same computer system.

At FIG. 6A, computer system 600A is displaying, via display 602A, home screen user interface 604. Home screen user interface 604 includes a plurality of icons (e.g., 604A-604C and/or 610A-610C) that, when activated, cause computer system 600A to display a user interface of an application that corresponds to the respective activated icon. For example, in response to detecting an input (e.g., a touch input, a tap input, and/or an air gesture) directed to music icon 604C, computer system 600A displays, via display 602A, a music user interface for playing music. Home screen user interface 604 also includes dock 610, which includes icons 610A-610C that, when activated, cause computer system 600A to display a user interface of an application that corresponds to the respective activated icon. In some embodiments, dock 610 continues to be displayed as computer system 600A navigates to different user interfaces. Pagination indicators 604D indicate which user interface from among a plurality of user interfaces is currently displayed. For example, a dark dot corresponds to a currently displayed user interface and white dots correspond to available user interfaces that are not currently displayed. At FIG. 6A, two user interfaces are available for display that are positioned to the left of the current user interface (home screen user interface 604) and two user interfaces are available for display that are positioned to the right of the current user interface (home screen user interface 604). In some embodiments, home screen user interface 604 also includes map button 610D that, when activated (e.g., via a touch input, a tap input, and/or an air gesture), causes computer system 600A to display map user interface 606.

At FIG. 6A, computer system 600A detects an input (e.g., a touch input, a swipe user input, swipe right input 650A, and/or an air gesture) directed to home screen user interface 604. In response to detecting the input, computer system 600A displays map user interface 606, as shown in FIG. 6B. In some embodiments, in response to detecting the input, home screen user interface 604 slides to the right to reveal map user interface 606 (e.g., map user interface 606 remains stationary or map user interface 606 slides into view from left-to-right). At FIG. 6B, map user interface 606 includes map 606A, navigation directions 606B (e.g., textual and/or graphical navigation directions), and audio playback information 606C. In some embodiment, the maps user interface includes a visual map and/or textual directions indicating a route to take to make progress towards a destination. In some embodiments, the maps user interface includes an indication of a current location of computer system 600A (e.g., a current location of a vehicle into which computer system 600A is integrated) and/or an indication of an estimated arrival time at a destination.

At FIG. 6B, computer system 600A detects an input (e.g., a touch input, tap input, a swipe user input, a swipe right user input, and/or an air gesture) directed to map user interface 606. In response to detecting the input and in accordance with a determination that the input is a first type of input (e.g., swipe right input 650B directed to map user interface 606), computer system 600A displays widget user interface 608, as shown in FIG. 6C. In some embodiments, map user interface 606 slides to the right and out of view to reveal widget user interface 608 (e.g., widget user interface 608 remains stationary or widget user interface 608 slides into view from left-to-right). In response to detecting the input and in accordance with a determination that the input is a second type of input (e.g., tap input 650C directed to home button 610E and/or a swipe left input directed to map user interface 606), computer system 600A displays home screen user interface 604 (e.g., map user interface 606 slides to the left to reveal home screen user interface 604), as shown in FIG. 6A.

At FIG. 6C, widget user interface 608 includes a plurality of (e.g., 2, 3, or more) stacks of widgets, such as first stack of widgets 618 and second stack of widgets 628. First stack of widgets 618 includes a plurality of widgets, as optionally indicated by first stack indicator 608A that indicates the current position and number of widgets in first stack of widgets. In this example, first stack of widgets 618 includes 3 widgets. Second stack of widgets 628 includes a plurality of widgets, as optionally indicated by second stack indicator 608B that indicates the current position and number of widgets in second stack of widgets. In this example, second stack of widgets 628 includes 4 widgets. At FIG. 6C, computer system 600A is concurrently displaying clock widget 618A as part of first stack of widgets 618 and calendar widget 628A as part of second stack of widgets 628. At FIG. 6C, computer system 600A detects an input (e.g., a touch input, a tap input, an air gesture, and/or swipe up input 650D) directed to first stack of widgets 618. In response to detecting the input directed to first stack of widgets 618, computer system 600A transitions first stack of widgets 618 from displaying clock widget 618A (which is the first widget in the stack) to displaying stock market widget 618B (which is the second widget in the stack), as shown in FIG. 6D. In some embodiments, a widget includes information corresponding to (e.g., received from, about, or relating to) a respective application (e.g., of computer system 600A and/or of computer system 600B). In some embodiments, the information displayed as part of a widget is updated over time to reflect changes in the information. In some embodiments, activation of a widget (e.g., a tap input on and/or a press-and-hold on the widget) causes computer system 600A to display a user interface of an application that corresponds to the activated widget.

At FIG. 6D, computer system 600A is concurrently displaying stock market widget 618B (which is the second widget in first stack of widgets 618) as part of first stack of widgets 618 and calendar widget 628A (which is the first widget in second stack of widgets 628) as part of second stack of widgets 628. For example, stock market widget 618B corresponds to a stock market application and/or the information displayed as part of stock market widget 618B is received from a stock market application. At FIG. 6D, computer system 600A detects an input (e.g., a touch input, a tap input, an air gesture, and/or swipe up input 650E) directed to first stack of widgets 618. In response to detecting the input directed to first stack of widgets 618, computer system 600A transitions first stack of widgets 618 from displaying stock market widget 618B (which is the second widget in the stack) to displaying sports widget 618C (which is the third widget in the stack), as shown in FIG. 6E.

At FIG. 6E, computer system 600A is concurrently displaying sports widget 618C (which is the third widget in first stack of widgets 618) as part of first stack of widgets 618 and calendar widget 628A (which is the first widget in second stack of widgets 628) as part of second stack of widgets 628. For example, sports widget 618C corresponds to a sports application and/or the information displayed as part of sports widget 618C is received from a sports application. At FIG. 6E, computer system 600A detects an input (e.g., a touch input, a tap input, an air gesture, and/or swipe down input 650F) directed to first stack of widgets 618. In response to detecting the input directed to first stack of widgets 618, computer system 600A transitions first stack of widgets 618 back to displaying stock market widget 618B (which is the second widget in the stack), as shown in FIG. 6F.

At FIG. 6F, computer system 600A is concurrently displaying stock market widget 618B (which is the second widget in first stack of widgets 618) as part of first stack of widgets 618 and calendar widget 628A (which is the first widget in second stack of widgets 628) as part of second stack of widgets 628. At FIG. 6F, computer system 600A detects an input (e.g., a touch input, a tap input, an air gesture, and/or swipe up input 650G) directed to second stack of widgets 628. In response to detecting the input directed to second stack of widgets 628, computer system 600A transitions second stack of widgets 628 from displaying calendar widget 628A (which is the first widget in the stack) to displaying reminders widget 628B (which is the second widget in the stack), as shown in FIG. 6G.

At FIG. 6F, computer system 600A is concurrently displaying stock market widget 618B (which is the second widget in first stack of widgets 618) as part of first stack of widgets 618 and calendar widget 628A (which is the first widget in second stack of widgets 628) as part of second stack of widgets 628. At FIG. 6F, computer system 600A detects an input (e.g., a touch input, a tap input, an air gesture, and/or swipe up input 650G) directed to second stack of widgets 628. In response to detecting the input directed to second stack of widgets 628, computer system 600A transitions second stack of widgets 628 from displaying calendar widget 628A (which is the first widget in the stack) to displaying reminders widget 628B (which is the second widget in the stack), as shown in FIG. 6G.

At FIG. 6G, computer system 600A is concurrently displaying stock market widget 618B (which is the second widget in first stack of widgets 618) as part of first stack of widgets 618 and reminders widget 628B (which is the second widget in second stack of widgets 628) as part of second stack of widgets 628. At FIG. 6G, computer system 600A detects an input (e.g., a touch input, a tap input, an air gesture, and/or swipe up input 650H) directed to second stack of widgets 628. In response to detecting the input directed to second stack of widgets 628, computer system 600A transitions second stack of widgets 628 from displaying reminders widget 628B (which is the second widget in the stack) to displaying podcasts widget 628C (which is the third widget in the stack), as shown in FIG. 6H.

At FIG. 6H, computer system 600A is concurrently displaying stock market widget 618B (which is the second widget in first stack of widgets 618) as part of first stack of widgets 618 and podcasts widget 628C (which is the third widget in second stack of widgets 628) as part of second stack of widgets 628. At FIG. 6H, computer system 600A detects an input (e.g., a touch input, a tap input, an air gesture, and/or swipe up input 650I) directed to second stack of widgets 628. In response to detecting the input directed to second stack of widgets 628, computer system 600A transitions second stack of widgets 628 from displaying podcasts widget 628C (which is the third widget in the stack) to displaying delivery widget 628D (which is the fourth widget in the stack), as shown in FIG. 6I.

At FIG. 6I, computer system 600A is concurrently displaying stock market widget 618B (which is the second widget in first stack of widgets 618) as part of first stack of widgets 618 and delivery widget 628D (which is the fourth widget in second stack of widgets 628) as part of second stack of widgets 628. At FIG. 6I, computer system 600A detects an input (e.g., a touch input, a tap input, an air gesture, and/or swipe down input 650J) directed to second stack of widgets 628. In response to detecting the input directed to second stack of widgets 628, computer system 600A transitions second stack of widgets 628 back to displaying podcasts widget 628C (which is the third widget in the stack), as shown in FIG. 6J.

At FIG. 6J, computer system 600A is concurrently displaying stock market widget 618B (which is the second widget in first stack of widgets 618) as part of first stack of widgets 618 and podcasts widget 628C (which is the third widget in second stack of widgets 628) as part of second stack of widgets 628. At FIG. 6J, computer system 600A detects an input (e.g., a touch input, tap input 650L directed to map button 610D, a swipe input, an air gesture, and/or swipe left input 650K) directed to widget user interface 608. In response to detecting the input directed to widget user interface 608, computer system 600A displays map user interface 606 (e.g., widget user interface 608 slides to the left to reveal map user interface 606), as shown in FIG. 6K.

At FIG. 6K, while displaying map user interface 606, computer system 600A detects an input. In response to detecting the input and in accordance with a determination that the input is the first type of input (e.g., swipe right input 650N directed to map user interface 606), computer system 600A displays widget user interface 608, as shown in FIG. 6J. In response to detecting the input and in accordance with a determination that the input is the second type of input (e.g., tap input 650O directed to home button 610E and/or swipe left input 650M directed to map user interface 606), computer system 600A displays home screen user interface 604 (e.g., map user interface 606 slides to the left to reveal home screen user interface 604), as shown in FIG. 6L.

At FIG. 6L, while displaying home screen user interface 604, computer system 600A detects an input (e.g., a touch input, tap input 650P, and/or an air gesture) directed to message icon 604A that corresponds to a messaging application and, in response, displays a messaging user interface of the messaging application.

FIG. 6M illustrates computer system 600A and computer system 600B. Computer system 600B includes display 602B that is displaying lock screen user interface 660. In some embodiments, computer system 600B detects that a drive has been completed of the vehicle into which computer system 600A is integrated (e.g., computer system 600B detects that the vehicle has stopped for a threshold duration of time, that the vehicle has been put into park, and/or that the vehicle has been turned off) and, in response, displays, via display 602B, notification 660A indicating that first stack of widgets 618 and second stack of widgets 628 can be modified/customized. In some embodiments, computer system 600B displays notification 660A based on different criteria being met (e.g., unrelated to the status of the vehicle). In some embodiments, computer system 600A and computer system 600B are in communication throughout FIGS. 6M-6T. In some embodiments, computer system 600A and computer system 600B are not in communication throughout FIGS. 6M-6T (e.g., computer system 600A is turned off and not communicating with computer system 600B). At FIG. 6M, computer system 600B detects an input (e.g., a touch input, a tap input 650Q, and/or an air gesture) directed to notification 660A. In response to detecting the input directed to notification 660A, computer system 600B displays, via display 602B, widget editing user interface 670, as shown in FIG. 6N. In some embodiments, computer system 600B receives one or more inputs to navigate a settings user interface and/or a settings application and, in response, displays widget editing user interface 670.

At FIG. 6N, computer system 600B is displaying, via display 602B, widget editing user interface 670 for modifying the plurality of stacks of widgets of widget user interface 608. Widget editing user interface 670 includes first stack option 670A for modifying the widgets of first stack of widgets 618 and second stack option 670B for modifying the widgets of second stack of widgets 628. At FIG. 6N, first stack option 670A is selected and, accordingly, widget objects 672A-672C are displayed as part of first widget stack modifier object 672. First widget stack modifier object 672 includes clock widget object 672A, stocks widget object 672B, and sports widget object 672C in an ordered arrangement. Clock widget object 672A corresponds to clock widget 618A, stocks widget object 672B corresponds to stock market widget 618B, and sports widget object 672C corresponds to sports widget 618C. The order of widget objects 672A-672C in first widget stack modifier object 672 dictates the order of the widgets of first stack of widgets 618. Widget objects 672A-672C include a respective delete option 672A1-672C1 that, when activated, initiates a process for deleting the respective widget object. In some embodiments, when computer system 600B detects activation of rotate option 674G, computer system (e.g., 600A and/or 600B) automatically reorders the stacks of widgets throughout the day to move the most relevant widget in a respective stack to the first (e.g., top) position based on the user’s usage patterns, location, and/or the current time, thereby helping to display the right information at the right time. In some embodiments, when computer system 600B detects activation of suggestion option 674H, computer system (e.g., 600A and/or 600B) automatically adds suggested relevant widgets to a respective stack based on a user’s past activity, thereby providing the user with additional widgets that the user may not have otherwise known about and provide the user with timely and relevant information as part of the widget stacks. In some embodiments, when computer system 600B detects activation of wallpaper option 674I, computer system (e.g., 600A and/or 600B) adds a wallpaper to widget user interface 608. In some embodiments, when computer system 600B detects activation of show widgets option 674J, computer system (e.g., 600A and/or 600B) forgoes displaying widget user interface 608 to the left of maps user interface 606 on display 602A.

At FIG. 6N, computer system 600B detects an input (e.g., a touch input, tap and drag input 650R, and/or an air gesture) directed to sports widget object 672C. In response to detecting the input, computer system 600B changes the order of widget objects 672A-672C, as shown in FIG. 6O.

At FIG. 6O, computer system 600B displays a new order for widget objects 672A-672C as part of first widget stack modifier object 672 (e.g., based on the location and/or direction of input 650R). As shown in FIG. 6O, sports widget object 672C (which corresponds to sports widget 618C) is now the first widget in the first stack of widgets. At FIG. 6O, computer system 600B detects an input (e.g., a touch input, tap input 650S, and/or an air gesture) directed to delete option 672A1 of clock widget object 672A. In response to detecting the input directed to delete option 672A1 of clock widget object 672A, computer system 600B initiates a process for deleting (e.g., requests confirmation to delete and/or deletes) clock widget object 672A.

At FIG. 6P, first widget stack modifier object 672 no longer includes clock widget object 672A based on the input directed to delete option 672A1 of clock widget object 672A. At FIG. 6P, computer system 600B detects an input (e.g., a touch input, tap input 650T, and/or an air gesture) directed to add object 672D for adding widgets to the first stack of widgets.

At FIG. 6Q, in response to detecting the input directed to add object 672D, computer system 600B displays plurality of objects 674A-674F corresponding to widgets that are available to be added to the first stack of widgets. For example, each object of the plurality of objects 674A-674F corresponds to a respective widget. At FIG. 6Q, computer system 600B detects an input (e.g., a touch input, tap input 650U, and/or an air gesture) directed to object 674F, which corresponds to a weather widget.

At FIG. 6R, in response to detecting the input directed to object 674F, computer system 600B has added weather widget object 672E to the arrangement of first widget stack modifier object 672. For example, weather widget object 672E is displayed below widget objects 672C and 672B to indicate that weather widget object 672E is in the third position for the first stack of widgets. At FIG. 6R, computer system 600B detects an input (e.g., a touch input, tap input 650V, and/or an air gesture) directed to second stack option 670B.

At FIG. 6S, in response to detecting the input directed to second stack option 670B, computer system 600B replaces display of first widget stack modifier object 672 with second widget stack modifier object 676, as shown in FIG. 6S. Second widget stack modifier object 676 includes calendar widget object 676A, reminders widget object 676B, podcasts widget object 676C, and delivery widget object 676D in an ordered arrangement. Calendar widget object 676A corresponds to calendar widget 628A, reminders widget object 676B corresponds to reminders widget 628B, podcasts widget object 676C corresponds to podcasts widget 628C, and delivery widget object 676D corresponds to delivery widget 628D. The order of widget objects 676A-676D in second widget stack modifier object 676 dictates the order of the widgets of second stack of widgets 628. Widget objects 676A-676D include a respective delete option 676A1-676D1 that, when activated, initiates a process for deleting the respective widget object. Similar to add object 672D for adding widgets to the first stack of widgets, add object 676E is for adding widgets to the second stack of widgets. At FIG. 6S, computer system 600B detects an input (e.g., a touch input, tap input 650W, and/or an air gesture) directed to delete option 676B1 of reminders widget object 676B. In response to detecting the input directed to delete option 676B1 of reminders widget object 676B, computer system 600B initiates a process for deleting (e.g., requests confirmation to delete and/or deletes) reminders widget object 676B.

At FIG. 6T, second widget stack modifier object 676 no longer includes reminders widget object 676B based on the input directed to delete option 676B1 of reminders widget object 676B. Similar to the description above, the order of second stack of widgets can be changed and additional widgets can also be added to the second stack of widgets. At FIG. 6T, computer system 600B detects an input (e.g., a touch input, swipe up input 650X, and/or an air gesture) to access home screen 662, as shown in FIG. 6U.

At FIG. 6U, after having modified the widgets of first stack of widgets 618 and second stack of widgets 628 using widget editing user interface 670, computer system 600B displays home screen 662. Home screen 662 includes a plurality of application icons that, when activated, cause computer system 600B to display a user interface of a respective application on display 602B of computer system 600B. At FIG. 6U, in some embodiments, computer system 600B is in communication with computer system 600A. In some embodiments, computer system 600B displays content using computer system 600A (e.g., computer system 600A is a secondary display and/or a secondary touch display for computer system 600B). At FIG. 6U, while computer system 600A is displaying home screen user interface 604, computer system 600A detects an input (e.g., a touch input, swipe right input 650Y, and/or an air gesture) directed to home screen user interface 604. In response to detecting the input directed to home screen user interface 604, computer system 600A displays map user interface 606, as shown in FIG. 6V.

At FIG. 6V, map user interface includes map 606A and optionally includes an indication on map 606A of a current location of computer system 600A and/or a vehicle in which computer system 600A is integrated. At FIG. 6V, while computer system 600A is displaying maps user interface 606, computer system 600A detects an input (e.g., a touch input, swipe right input 650Z, and/or an air gesture) directed to maps user interface 606. In response to detecting the input directed to maps user interface 606, computer system 600A displays widget user interface 608, as shown in FIG. 6W. As shown in FIGS. 6W and 6X, the widgets of first stack of widgets 618 and the widgets of second stack of widgets 628 have been modified based on the inputs directed to widget editing user interface 670.

At FIG. 6W, computer system 600A is concurrently displaying sports widget 618C as the first widget of first stack of widgets 618 and calendar widget 628A as the first widget of second stack of widgets 628. At FIG. 6Q, computer system 600A detects inputs (e.g., a touch inputs, tap inputs, air gestures, and/or swipe up inputs 650AA and 650AB) directed to first stack of widgets 618 and second stack of widgets 628. In response to detecting the input directed to first stack of widgets 618, computer system 600A transitions first stack of widgets 618 from displaying sports widget 618C (which is the first widget in the modified stack) to displaying stock market widget 618B (which is the second widget in the modified stack), as shown in FIG. 6X. In response to detecting the input directed to second stack of widgets 628, computer system 600A transitions second stack of widgets 628 from displaying calendar widget 628A (which is the first widget in the modified stack) to displaying podcasts widget 628C (which is the second widget in the modified stack), as shown in FIG. 6X.

At FIG. 6X, computer system 600A detects an input (e.g., a touch input, a tap input, a swipe input, an air gesture, and/or swipe left input 650AC) directed to widget user interface 608. In response to detecting the input directed to widget user interface 608, computer system 600A displays map user interface 606 (e.g., widget user interface 608 slides to the left to reveal map user interface 606), as shown in FIG. 6Y.

At FIG. 6Y, while displaying map user interface 606, computer system 600A detects an input. In response to detecting the input and in accordance with a determination that the input is the first type of input (e.g., swipe right input 650AD directed to map user interface 606), computer system 600A displays widget user interface 608, as shown in FIG. 6X. In response to detecting the input and in accordance with a determination that the input is the second type of input (e.g., a tap input directed to home button 610E and/or swipe left input 650AE directed to map user interface 606), computer system 600A displays home screen user interface 604 (e.g., map user interface 606 slides to the left to reveal home screen user interface 604), as shown in FIG. 6Z.

At FIG. 6Z, as described above, computer system 600B displays home screen 662, which includes a plurality of application icons (e.g., 662A-662B) that, when activated, cause computer system 600B to display a user interface of a respective application on display 602B of computer system 600B. For example, first icon 662A corresponds to a first video application for playing short videos (e.g., videos shorter than 15 seconds, shorter than 45 seconds, shorter than 3 minutes, and/or shorter than a threshold length of time) and second icon 662B corresponds to a second video application (different from the first video application) for playing long videos (e.g., videos longer than 45 seconds, longer than 3 minutes, longer than 30 minutes, and/or longer than the threshold length of time). At FIG. 6Z, computer system 600B detects an input (e.g., a touch input, a tap input, and/or an air gesture) directed to home screen 662.

At FIG. 6AA, in response to detecting the input directed to home screen 662 and in accordance with a determination that the input (e.g., input 650AF1) is directed to first icon 662A, computer system 600B displays, via display 602B, first video user interface 680 of the first video application without displaying an indication (e.g., an eligibility indication and/or an availability indication), via display 602B, that visual media of the first video application are eligible to be displayed via display 602A of computer system 600A, as shown in FIG. 6AA. In some embodiments, computer system 600B forgoes displaying the indication based on a determination that the first video application does not meet a set of one or more eligibility criteria. In some embodiments, the set of one or more eligibility criteria includes a length criterion that is based on a length of visual media content (e.g., videos, movies, and/or shows) of the first video application. In some embodiments, the set of one or more eligibility criteria includes a length criterion that is met when a length of visual media content (e.g., videos, movies, and/or shows) of the first video application exceeds a threshold playback length of time (e.g., the criterion is met when the length of various media files available for playback using the application are longer than the threshold playback length of time). In some embodiments, the set of one or more eligibility criteria includes a criterion that is met when the application is identified as an application for displaying long-form videos and is not met when the application is not identified as an application for displaying long-form videos (and/or is not met when the application is identified as an application for displaying short-form videos). Thus, in some embodiments, because the set of one or more eligibility criteria is not met, computer system 600B does not automatically display, via display 602B, the indication that visual media of the first video application are eligible to be displayed via display 602A of computer system 600A and/or does not display an option to initiate a process to play visual media of the first video application via display 602A.

At FIG. 6AB, in response to detecting the input directed to home screen 662 and in accordance with a determination that the input (e.g., input 650AF2) is directed to second icon 662B, computer system 600B displays, via display 602B, second video user interface 682 of the second video application and (e.g., concurrently) displays, via display 602B, indications 690A-

690B (e.g., an eligibility indication and/or an availability indication) that visual media of the second video application are eligible to be displayed via display 602A of computer system 600A, as shown in FIG. 6AB. In some embodiments, computer system 600B displays indication 690A-690B based on a determination that the second video application meets the set of one or more eligibility criteria. In some embodiments, the set of one or more eligibility criteria includes a length criterion that is based on a length of visual media content (e.g., videos, movies, and/or shows) of the second video application. In some embodiments, the set of one or more eligibility criteria includes a length criterion that is met when a length of visual media content (e.g., videos, movies, and/or shows) of the second video application exceeds a threshold playback length of time (e.g., the criterion is met when the length of various media files available for playback using the application are longer than the threshold playback length of time). In some embodiments, the set of one or more eligibility criteria includes a criterion that is met when computer system 600B is in communication with computer system 600A (e.g., computer system 600B is connected (wirelessly or wired) to computer system 600A). In some embodiments, the set of one or more eligibility criteria includes a criterion that is met when the application is identified as an application for displaying long-form videos and is not met when the application is not identified as an application for displaying long-form videos (and/or is not met when the application is identified as an application for displaying short-form videos). Thus, in some embodiments, because the set of one or more eligibility criteria is met, computer system 600B automatically displays, via display 602B, an indication (e.g., 690A and/or 690B) that visual media of the second video application are eligible to be displayed via display 602A of computer system 600A and/or displays an option (e.g., 690A and/or 690B) to initiate a process to play visual media of the second video application via display 602A. In some embodiments, in accordance with a determination that the set of one or more eligibility criteria is met, computer system 600B provides (e.g., transmits) a corresponding indication to computer system 600A and/or computer system 600A displays, via display 602A, an indication that visual media of the second video application is eligible to be displayed via display 602A. In some embodiments, in accordance with a determination that the set of one or more eligibility criteria is met, computer system 600B does not provide a corresponding indication to computer system 600A and/or computer system 600A does not display, via display 602A, an indication that visual media of the second video application is eligible to be displayed via display 602A. In some embodiments, when computer

system 600B is not in communication with computer system 600A when input 650AF2 directed to second icon 662B is detected and/or when second video user interface 682 is displayed, computer system 600B forgoes displaying, via display 602B, indications that visual media of the second video application are eligible to be displayed via display 602A of computer system 600A (e.g., does not display 690A-690B).

At FIG. 6AB, second video user interface 682 of the second video application includes options for selecting media for playback and/or starting playback of media. For example, second video user interface 682 includes play button 682A that, when activated, starts playback of a first media that includes visual content (e.g., a video, a movie, and/or a show). At FIG. 6AB, computer system 600B detects an input (e.g., a touch input, tap input 650AG, and/or an air gesture) directed to play button 682A.

At FIG. 6AC, in response to detecting the input directed to play button 682A, computer system 600B starts playback of the first media, including displaying, via display 602B, visual content (e.g., 682B) of the first media (e.g., displaying video progressing over time, displaying consecutive frames of the video, and/or displaying animation/motion of the first media) and outputting audio 686 of the first media via one or more speakers. In some embodiments, the one or more speakers are speakers that are integrated into the vehicle and not speakers that are integrated into computer system 600B, as indicated by audio 686. At FIG. 6AC, in response to detecting the input directed to play button 682A (and, optionally, in accordance with a determination that the set of one or more eligibility criteria is met), computer system 600B displays, via display 602B, indication 690C that the visual media of the currently playing media is eligible to be displayed via display 602A of computer system 600A. In some embodiments, indication 690C has a different appearance from indications 690A and/or 690B. In some embodiments, indication 690C is larger than indications 690A and/or 690B. In some embodiments, indication 690C replaces indications 690A and/or 690B. In some embodiments, indication 690C persists while playback continues on display 602B. In some embodiments, indication 690C is displayed for a defined period of time (e.g., 5 seconds, 10 seconds, or 15 seconds) and then ceases to be displayed on display 602B while playback continues on display 602B (e.g., indications 690A and/or 690B are displayed when indication 690C ceases to be displayed). In some embodiments, second video user interface 682 includes controls 682C for controlling playback of the currently playing media and/or includes a progress bar indicating progress of the playback of the currently playing media.

At FIG. 6AC, in some embodiments, in response to detecting the input directed to play button 682A (and, optionally, in accordance with a determination that the set of one or more eligibility criteria is met), computer system 600A displays information 684 corresponding to (e.g., about) the currently playing media (e.g., the first media) on display 602A, as shown in FIG. 6AC. In some embodiments, information 684 is provided by computer system 600B. At FIG. 6AC, information 684 optionally includes playback option 684A corresponding to the currently playing media, image 684B (e.g., a static image and/or not the visual content of the first media) corresponding to the currently playing media, name/title of the currently playing media, and/or controls 684C for controlling playback of the currently playing media (e.g., that is playing on display 602B). Accordingly, others in the vehicle can see information on display 602A about the media that is playing on display 602B and/or others can control playback of the media playing on display 602B using computer system 600A (e.g., using controls 684C).

At FIG. 6AC, in some embodiments, while visual content 682B of the first media plays on computer system 600B and/or is displayed on display 602B, computer system 600B detects an input (e.g., a touch input, tap input 650AH, and/or an air gesture) directed to indication 690C. In response to detecting the input directed to indication 690C, computer system 600B initiates a process to move playback (e.g., moves playback) of the visual content of the first media from display 602B to display 602A, as shown in FIG. 6AD. At FIG. 6AC, in some embodiments, while visual content 682B of the first media plays on computer system 600B and/or is displayed on display 602B, computer system 600A detects an input (e.g., a touch input, tap input 650AI, and/or an air gesture) directed to playback option 684A. In response to detecting the input directed to playback option 684A, computer system 600A initiates a process to move playback (e.g., moves playback) of the visual content of the first media from display 602B to display 602A, as shown in FIG. 6AD.

At FIG. 6AD, in response to detecting the input (e.g., 650AH and/or 650AI), playback of the visual content of the first media has moved from display 602B to display 602A. For example, playback of the visual content continues (e.g., does not restart from the beginning of the first media). As shown in FIG. 6AD, playback of visual content 684E of the first media plays on display 602A. In some embodiments, controls 684D for controlling playback of the first media are concurrently displayed with visual content 684E. In response to detecting the input (e.g., 650AH and/or 650AI), the visual content of the first media is no longer playing on display 602B, as shown in FIG. 6AD. In response to detecting the input (e.g., 650AH and/or 650AI), indication 690C ceases to be displayed on display 602B and, optionally, indications 690A and/or 690B are displayed instead. As shown in FIG. 6AD, second video user interface 682 optionally continues to display controls 682C for controlling playback of the currently playing media (e.g., pausing and/or rewinding playback on display 602A) and/or continues to display a progress bar indicating progress of the playback of the currently playing media.

At FIG. 6AD, computer system 600B detects an input (e.g., a touch input, tap input 650AJ, and/or an air gesture) directed to indications 690A and/or 690B. In response to detecting the input directed to indications 690A and/or 690B, computer system 600B displays, via display 602B, indication 690D indicating that the visual media of the currently playing media on display 602A is eligible to be displayed via display 602B of computer system 600B. In some embodiments, indication 690D has a different appearance from indications 690A and/or 690B. In some embodiments, indication 690D is larger than indications 690A and/or 690B. In some embodiments, indication 690D replaces indications 690A and/or 690B. In some embodiments, indication 690D is the same size and/or has the same information layout as indication 690C.

At FIG. 6AE, computer system 600B detects an input (e.g., a touch input, tap input 650AK, and/or an air gesture) directed to indication 690D. In response to detecting the input directed to indication 690D, computer system 600B initiates a process to move playback (e.g., moves playback) of the visual content of the first media from display 602A back to display 602B, as shown in FIG. 6AF. For example, playback of the visual content continues (e.g., does not restart from the beginning of the first media) after being moved back to display 602B. In some embodiments, playback of the first media can continue to be controlled via both controls 682C and controls 684C. In some embodiments, in response to detecting the input directed to indication 690D and/or playback of the visual content being moved back to display 602B, computer system 600B displays, via display 602B, indication 690C. In some embodiments, computer system 600B does not display, via display 602B, the indication 690C and, optionally, instead displays, via display 602B, indications 690A and/or 690B. In some embodiments, throughout FIGS. 6AC-6AF, audio of the first media is output by speakers of the vehicle into which computer system 600A is integrated, independent of where the visual content of the first media is displayed.

FIGS. 6AG-6AH illustrate example techniques for displaying user interfaces on various displays. Often times, a system is designed for a specific display size and/or resolution and the actual display size and/or resolution of the display being used is not taken into account. For example, at FIG. 6AG, computer system 600A1 includes display 602A1 that has a first resolution (e.g., the number of horizontal and vertical pixels a screen can display) and a first size (e.g., physical dimension of the display, measured diagonally across the screen, and/or measured horizontally across the screen) and computer system 600A2 includes display 602A2 that has a second resolution and a second size. The resolution and/or size of display 602A1 and display 602A2 are different. For example, at FIG. 6AG, the resolutions of the two displays are the same (e.g., 1280x720), but the sizes of the two displays are different (e.g., 7” vs 9”). A computer system (e.g., 600A1, 600A2, and/or 600B) renders and displays the same user interface 690A1 and 690A2 on both displays, resulting in the same user interface being displayed on both displays, but with the physical size of user interface objects displayed on display 602A2 being larger than the physical size of corresponding user interface objects displayed on display 602A1. For example, at FIG. 6AG, icon 690A1-1 is smaller than corresponding icon 690A2-1 (each of which, when activated, cause a user interface for the same application to be displayed) and icon 690A1-2 is smaller than corresponding icon 690A2-2. For another example, at FIG. 6AG, pagination indicators 604D1 are smaller than pagination indicators 604D2. As a result, when a user moves from using one system to using another system, the user is accessing the same user interface with the same layout and the same arrangement of user interface objects, but with user interface objects of different sizes, which can result in a less-than-ideal user experience.

One technique to address this is to take into account the size and/or resolution of the display being used to display the user interface so as to provide the display with content that results in user interface objects having a defined size, as shown in FIG. 6AF. The technique selects a display resolution for a user interface based on the resolution of the display, the pixel density of the display, and/or the physical size of the display on which the user interface will be displayed. In some embodiments, the technique enables user interface objects to be displayed with the same or similar physical size on displays with different physical sizes (e.g., 7-inch display vs. 9-inch display) and/or with different resolutions (e.g., 1280x720 vs. 1920x1080).

As shown in FIG. 6AF, display 602A1 has a resolution of 1280x720 and a size of 7 inches and display 602A2 has a resolution of 1280x720 and a size of 9 inches. To accommodate different size displays and to have user interface objects (e.g., all user interface objects or a subset (less than all) of user interface object, such as icons 690A1-1, 690A2-2, 690A3-1, and/or 690A3-2) displayed at the same or similar physical size regardless of the size/resolution of the currently connected display, the technique generates a user interface using a selected resolution and then resizes the user interface to a resized resolution that matches the resolution of the currently connected display. In some embodiments, the selected resolution is selected from among a plurality of selectable resolutions (e.g., discrete resolutions). In some embodiments, the selected resolution is selected to be higher than the resolution of the currently connected display. In some embodiments, the selected resolution is selected based on the display size and/or the display resolution of the currently connected display. Once the user interface is generated for the selected resolution, the computer system resizes (e.g., resamples, downsamples, and/or upsamples) the generated user interface to produce a resized user interface with a resolution that matches the resolution of the currently connected display. In some embodiments, the selected resolution is selected based on the display size and display resolution of the currently connected display such that resizing the user interface and displaying the resized user interface on the connected display results in a user interface object being displayed with a same physical size. For example, as shown in FIG. 6AH, when a computer system (e.g., 600B) is connected to display 602A1, the computer system renders a first user interface with a resolution of 1280x720 (resulting in a first layout for the first user interface) for display on the 7-inch display, resulting in icon 690A1-1 having dimensions of 1 inch by 1 inch. When the computer system (e.g., 600B) is instead connected to display 602A2, the computer system generates (e.g., renders, without displaying) a second user interface with a resolution that is higher than 1280x720 (resulting in a second layout for the user interface that is different from the first layout), then resizes the second user interface down to a resized user interface that has a resolution of 1280x720 for display on the 9-inch display, resulting in icon 690A3-1 having the same dimensions of 1 inch by 1 inch. As described above, in some embodiments, the user interface rendering process results in different layouts and/or arrangements of user interface objects based on the resolution at which the user interface is generated (e.g., prior to resizing).

FIG. 6AH illustrates the different layouts and/or arrangements based on the resolution at which that the user interface is generated. User interface 690A1 was generated at a first resolution, resulting in a 5-wide by 2-high grid of icons and 5 pagination indicators 604D1. User interface 690A3 was generated at a second resolution (higher than the first resolution), resulting in a 6-wide by 3-high grid of icons and 4 pagination indicators 604D3. The second resolution user interface was then resized to the first resolution and displayed as user interface 690A3.

In some embodiments, a reference display has a resolution of 1280x720 and a size of 7 inches (e.g., diagonal measurement of 16x9 aspect ratio display) and a second display has a resolution of 1280x720 and a size of 9 inches (e.g., diagonal measurement of 16x9 aspect ratio display). To accommodate the difference in display size of the two displays and have the user interface objects display at the same or similar physical size, the technique determines the proportional difference in the physical size of the second display with respect to the reference display: (9 inches – 7 inches)/7 inches = 28.57%. The proportional difference is then used to determine the resolution at which the user interface should be generated: (1280pixels by 720 pixels) x (100% + 28.57%) = 1646 pixels by 926 pixels. The generated user interface is then resized to 1280x720 and displayed on the 9-inch display, resulting in user interface objects having a uniform display size as compared to the reference display. Similarly, when the computer system is connected to a 10-inch third display with a 1280x720 resolution display, the technique determines the proportional difference in the physical size of the third display with respect to the reference display: (10 inches – 7 inches)/7 inches = 42.86%. The proportional difference is then used to determine the resolution at which the user interface should be generated: (1280pixels by 720 pixels) x (100% + 42.7%) = 1829 pixels by 1029 pixels. The generated user interface is then resized to 1280x720 and displayed on the 10-inch display, resulting in user interface objects having a uniform display size as compared to the reference display and the 9-inch display.

In some embodiments, a method is performed at a computer system, wherein the computer system is in communication with a first display generation component (e.g., one or

more displays, one or more touch-screen displays, one or more monitors, a holographic display system, one or more transparent displays, a head-mounted display system, and/or one or more displays integrated into a vehicle, such as a car). In some embodiments, the method includes detecting information about the first display generation component, including a respective display resolution (e.g., a native display resolution and/or a preferred display resolution) of the first display generation component and a respective display size of the first display generation component. In some embodiments, the information about the first display generation component of the first set of one or more display generation components. In some embodiments, the information about the first display generation component includes a resolution (e.g., a native resolution, a preferred resolution, 1280x720, 1920x1080, or 2560x1440), a display size (e.g., 7” diagonal, 9” diagonal, 8” width, and/or 9” width), and/or a pixel density (e.g., in pixels per inch or pixels per cm) of the first display generation component. In some embodiments, the native resolution of the first display generation component is the number of pixels that the first display generation component can physically display. In some embodiments, the computer system detects the information about the first display generation component by receiving the information about the first display generation component from the first display generation component (e.g., during a boot-up sequence of the computer system and/or the first display generation component and/or during an initial setup time when the computer system and the first display generation component initially communicate). In some embodiments, the method includes: subsequent to detecting the information about the first display generation component, generating (e.g., preparing and/or rendering), based on the respective display resolution of the first display generation component and the respective display size of the first display generation component, a respective user interface with a respective resolution, including: in accordance with a determination that the respective display resolution is a first display resolution and that the respective display size is a first display size, generating a first user interface with a first resolution that is different from (e.g., higher than or lower than) the respective display resolution of the first display generation component, wherein the first user interface includes a plurality of user interface elements in a first arrangement; and in accordance with a determination that the respective display resolution is a second display resolution and that the respective display size is a second display size, generating a second user interface with a second resolution that is different from (e.g., higher than or lower than) the first resolution and that is different from the respective

display resolution of the first display generation component, and wherein the first display resolution is different from the second display resolution and/or the first display size is different from the second display size, and wherein the second user interface includes the plurality of user interface elements in a second arrangement that is different from the first arrangement. In some embodiments, the computer system selects the resolution (e.g., the first resolution) at which to generate the user interface based on both the display resolution of the first display generation component and a display size of the first display generation component. In some embodiments, the computer system selects a resolution for generating the user interface that is larger/higher than the display resolution of the first display generation component. In some embodiments, the computer system selects the resolution at which to generate the user interface based on two or more of the display resolution, the display size, and/or the pixel density of the first display generation component. In some embodiments, the computer system does not display the respective user interface at the generated resolution (e.g., the first resolution and/or the second resolution) on any display. In some embodiments, the method includes: subsequent to generating the respective user interface with the respective resolution, resizing (e.g., resampling, downsampling, and/or upsampling) the respective user interface with the respective resolution to generate a resized user interface with a resized resolution. In some embodiments, the resized resolution is the same as the respective display resolution of the first display generation component. In some embodiments, the arrangement of the plurality of user interface elements does not change when resizing the respective user interface with the respective resolution to the resized resolution. In some embodiments, the plurality of user interface elements maintain their respective arrangement when the user interface is resized from the respective resolution to the resized resolution. In some embodiments, the method includes displaying, via the first display generation component, the resized user interface with the resized resolution. In some embodiments, the computer system uses information about various display generation components (e.g., the display resolution, the display size, and/or the display pixel density) to generate user interfaces at a resolution that is selected (e.g., calculated) for that specific display generation component such that resizing the user interface to the display resolution of that specific display generation component results in a user interface object (e.g., of the plurality of user interface objects) having the same physical size, regardless of the resolution and/or physical size of the specific display generation component. Thus, the computer system displaying user

interfaces on different displays that have different resolutions and/or different sized would display the same user interface element with the same physical size (e.g., 1”x1” or 1.1”x1.1”), regardless of which display is being used. This enables the computer system to provide a consistent user experience across a broad range of displays.

FIG. 7 is a flow diagram illustrating methods of managing stacks of widgets using a computer system, in accordance with some embodiments. Method 700 is performed at a computer system (e.g., 100, 300, 500, 600A, and/or 600B), wherein the computer system (e.g., 600B) is in communication with a first set of one or more display generation components (e.g., 602B, one or more displays, one or more touch-screen displays, one or more monitors, a holographic display system, one or more transparent displays, and/or a head-mounted display system) and one or more input devices (e.g., 602B, a touch-sensitive surface (e.g., as part of a touch-sensitive display); a mouse; a keyboard; a visual input device (e.g., one or more cameras (e.g., an infrared camera, a depth camera, a visible light camera, and/or a gaze tracking camera)); a motion sensor (e.g., an accelerometer and/or a gyroscope); and/or one or more mechanical input devices (e.g., a depressible input mechanism; a button; a rotatable input mechanism; a crown; and/or a dial)). Some operations in method 700 are, optionally, combined, the orders of some operations are, optionally, changed, and some operations are, optionally, omitted.

As described below, method 700 provides an intuitive way for managing stacks of widgets. The method reduces the cognitive burden on a user for managing stacks of widgets, thereby creating a more efficient human-machine interface. For battery-operated computing devices, enabling a user to manage stacks of widgets faster and more efficiently conserves power and increases the time between battery charges.

The devices, methods, and/or computer-readable storage mediums described below enhance the operability of the device and make the user-device interfaces more efficient (e.g., by helping the user to provide proper inputs and reducing user mistakes when operating/interacting with the device) which, additionally, reduces power usage and/or improves battery life of the device by enabling the user to use the device more quickly and efficiently. Providing improved feedback (such as by displaying ordered objects that represent widgets in stacks and by concurrently displaying the modified first stack of widgets and the modified second stack of widgets) enhances the operability of the device by reducing accidental and mistaken inputs, reducing energy usage by the device.

The computer system (e.g., 600B) displays (702), via the first set of one or more display generation components (e.g., 602B), a widget editing user interface (e.g., 670) that includes one or more options (e.g., 670A and/or 672 correspond to 618) corresponding to a first stack of widgets (e.g., a stack of two widgets, a stack of three widgets, and/or a stack of a plurality of widgets) and one or more options (e.g., 670B and/or 676 correspond to 628) corresponding to a second stack of widgets (e.g., a stack of two widgets, a stack of three widgets, and/or a stack of a plurality of widgets), wherein a configuration (e.g., 672 and/or a configuration stored in memory) of the first stack of widgets specifies an arrangement of the first stack of widgets when the first stack of widgets is displayed via a second set of one or more display generation components (e.g., one or more displays 602A, one or more touch-screen displays, one or more monitors, a holographic display system, one or more transparent displays, and/or a head-mounted display system) that is different from the first set of one or more display generation components (e.g., 602B), and wherein a configuration of the second stack of widgets (e.g., 676 and/or a configuration stored in memory), different from the configuration of the first stack of widgets, specifies an arrangement of the second stack of widgets when the second stack of widgets is displayed via the second set of one or more display generation components (e.g., 602A). In some embodiments, the computer system optionally displays, via the first set of one or more display generation components, some information about the configuration of the first stack and/or about the configuration of the second stack. In some embodiments, a respective configuration of a stack of widgets includes information about the number of widgets in the respective stack, the name and/or identifier of widgets in the respective stack, and/or the order of widgets in the respective stack. In some embodiments, the first stack of widgets and the second stack of widgets are concurrently displayed, via the second set of one or more display generation components.

While displaying the widget editing user interface, the computer system (e.g., 600B) detects (704), via the one or more input devices (e.g., integrated into a phone of the computer system), a first set of one or more inputs (e.g., directed to modifying the arrangement of the first stack of widgets to a modified arrangement) (e.g., 650R, 650S, 650T, and/or 650U). In response to detecting the first set of one or more inputs (e.g., 650R, 650S, 650T, and/or 650U), the computer system (e.g., 600B) modifies (706) the configuration of the first stack of widgets to specify a modified arrangement of the first stack of widgets.

While displaying the widget editing user interface, the computer system (e.g., 600B) detects (708), via the one or more input devices (e.g., integrated into a phone of the computer system), a second set of one or more inputs (e.g., directed to modifying the arrangement of the second stack of widgets to a modified arrangement) (e.g., 650V and/or 650W). In response to detecting the second set of one or more inputs (e.g., 650V and/or 650W), the computer system (e.g., 600B) modifies (710) the configuration of the second stack of widgets to specify a modified arrangement of the second stack of widgets.

Subsequent to detecting the first set of one or more inputs and the second set of one or more inputs, the computer system (e.g., 600A and/or 600B) concurrently displays (712), via the second set of one or more display generation components (e.g., 600A), the first stack of widgets (e.g., 618 at FIGS. 6W-6X) using the modified arrangement of the first stack of widgets and the second stack of widgets (e.g., 628 at FIGS. 6W-6X) using the modified arrangement of the second stack of widgets. In some embodiments, the widget editing user interface includes options for editing a first stack of widgets (without including options for editing a second stack of widgets) and the computer system displays, via the second set of one or more display generation components, the first stack of widgets using the modified arrangement of the first stack of widgets without displaying the second stack of widgets.

In some embodiments, prior to the computer system (e.g., 600B) detecting, via the one or more input devices, the first set of one or more inputs (and prior to modifying the configuration of the first stack of widgets to specify the modified arrangement of the first stack of widgets) (e.g., 650R, 650S, 650T, and/or 650U), the computer system (e.g., 600B) displays, via the second set of one or more display generation components (e.g., 602A), the first stack of widgets (e.g., 618 at FIGS. 6C-6J) using the (e.g., unmodified) arrangement of the first stack of widgets and the second stack of widgets (e.g., 628 at FIGS. 6C-6J) using the (e.g., unmodified) arrangement of the second stack of widgets.

In some embodiments, modifying the configuration of the first stack of widgets to specify the modified arrangement of the first stack of widgets includes adding a respective widget (e.g., a weather widget corresponding to 672E) to the first stack of widgets (e.g., as shown in FIGS. 6P-6R). In some embodiments, modifying the configuration of the second stack of widgets to specify the modified arrangement of the second stack of widgets includes adding a respective widget to the second stack of widgets.

In some embodiments, modifying the configuration of the first stack of widgets to specify the modified arrangement of the first stack of widgets includes removing a respective widget (e.g., clock widget 618A corresponding to 672A) from the first stack of widgets (e.g., as shown in FIGS. 6O-6P). In some embodiments, modifying the configuration of the second stack of widgets to specify the modified arrangement of the second stack of widgets includes removing a respective widget from the second stack of widgets.

In some embodiments, modifying the configuration of the first stack of widgets to specify the modified arrangement of the first stack of widgets includes changing an order of widgets of the first stack of widgets (e.g., as shown in FIGS. 6N-6O). In some embodiments, modifying the configuration of the second stack of widgets to specify the modified arrangement of the second stack of widgets includes changing an order of widgets of the second stack of widgets. In some embodiments, changing the order of widgets of a respective stack of widgets includes rearranging a widget within the respective stack of widgets.

In some embodiments, displaying, via the first set of one or more display generation components (e.g., 602B), the widget editing user interface (e.g., 670) that includes one or more options corresponding to the first stack of widgets (e.g., a stack of two widgets, a stack of three widgets, and/or a stack of a plurality of widgets) includes displaying, via the first set of one or more display generation components (e.g., 602B), a first object (e.g., 672A at FIG. 6N) corresponding to a first widget (e.g., 618A) of the first stack of widgets (e.g., 618) and a second object (e.g., 672B at FIG. 6N) corresponding to a second widget (e.g., 618B) of the first stack of widgets (e.g., 618). In some embodiments, the widget editing user interface includes a plurality of objects that correspond to the plurality of widgets of the first stack of widgets. In some embodiments, displaying, via the first set of one or more display generation components, the widget editing user interface that includes one or more options corresponding to the second stack of widgets (e.g., a stack of two widgets, a stack of three widgets, and/or a stack of a plurality of widgets) includes displaying, via the first set of one or more display generation components, an object corresponding to a first widget of the second stack of widgets and an object corresponding to a second widget of the second stack of widgets. In some embodiments, the widget editing user interface includes a plurality of objects that correspond to the plurality of widgets of the second stack of widgets.

In some embodiments, the computer system (e.g., 600B) detects a change in a widget suggestion option (e.g., 674H) (e.g., in response to detecting a user input directed to a widget suggestion object displayed as part of the first set of one or more display generation components). In response to detecting the change in the widget suggestion option (e.g., 674H): in accordance with a determination that the widget suggestion option is enabled: the computer system (e.g., 600B) modifies the configuration of the first stack of widgets to specify an arrangement of the first stack of widgets that includes a first suggested widget (e.g., that is suggested by the computer system and is not selected by a user of the computer system) and modifies the configuration of the second stack of widgets to specify an arrangement of the second stack of widgets that includes a second suggested widget (e.g., that is suggested by the computer system and is not selected by a user of the computer system) that is different from the first suggested widget. In response to detecting the change in the widget suggestion option (e.g., 674H): in accordance with a determination that the widget suggestion option is enabled: the computer system (e.g., 600B) modifies the configuration of the first stack of widgets to specify an arrangement of the first stack of widgets that excludes the first suggested widget (e.g., that is suggested by the computer system and is not selected by a user of the computer system) and modifies the configuration of the second stack of widgets to specify an arrangement of the second stack of widgets that excludes the second suggested widget (e.g., that is suggested by the computer system and is not selected by a user of the computer system).

In some embodiments, the second set of one or more display generation components (e.g., one or more displays 602A) are integrated into a vehicle. In some embodiments, a display generation component of the second set of one or more display generation components is integrated into a dashboard of the vehicle.

In some embodiments, widgets (e.g., 618A-618C) of the first stack of widgets (e.g., 618) have a same first display size (e.g., a first display dimension and/or a first display shape) and widgets (e.g., 628A-268D) of the second stack of widgets (e.g., 628) have a same second display size (e.g., a second display dimension and/or a second display shape). In some embodiments, the widgets of the first stack of widgets are all the same size and/or shape. In some embodiments, the widgets of the second stack of widgets are all the same size and/or shape. In some embodiments, the widgets of both the first stack of widgets are a different size and/or shape as compared to the second stack of widgets. In some embodiments, the first display size and the second display size are a same size. In some embodiments, the widgets of both the first stack of widgets and the second stack of widgets are the same size and/or shape.

In some embodiments, the computer system (e.g., 600B) detects an end of a drive of a vehicle in which the second set of one or more display generation components (e.g., 602A) is integrated. For example, the computer system detects an indication that the vehicle has been put into park, that the vehicle has stopped in a parking spot, and/or that the user of the computer system has exited the vehicle. In response to detecting the end of the drive of the vehicle, the computer system (e.g., 600B) displays, via the first set of one or more display generation components (e.g., 602B), a notification (e.g., 660A) corresponding to the widget editing user interface (e.g., 670). In some embodiments, the computer system detects an input directed to the notification and, in response, displays the widget editing user interface via the first set of one or more display generation components. In some embodiments, the notification is displayed as part of a lock screen of the computer system (e.g., a phone or tablet).

In some embodiments, a first respective widget (e.g., 618A or 618B) of the first stack of widgets displays information that corresponds to (e.g., is received from) a first respective application and a second respective widget (e.g., 618B or 618C) of the first stack of widgets displays information that corresponds to (e.g., is received from) a second respective application that is different from the first respective application. In some embodiments, respective widgets of the second stack of widgets display information that correspond to (e.g., is received from) respective applications of the computer system. In some embodiments, display contents of widgets are updated over time with information from corresponding respective applications.

Note that details of the processes described above with respect to method 700 (e.g., FIG. 7) are also applicable in an analogous manner to the methods described below. For example, methods 800, 900, and 1100 optionally includes one or more of the characteristics of the various methods described above with reference to method 700. For brevity, these details are not repeated below.

FIG. 8 is a flow diagram illustrating methods of displaying stacks of widgets, in accordance with some embodiments. Method 800 is performed at a computer system (e.g., 100, 300, 500, 600A, and/or 600B), wherein the computer system (e.g., 600A) is in communication with one or more display generation components (e.g., one or more displays 602A, one or more touch-screen displays, one or more monitors, a holographic display system, one or more transparent displays, a head-mounted display system, and/or one or more displays integrated into a vehicle, such as a car) and one or more input devices (e.g., 602A, a touch-sensitive surface (e.g., as part of a touch-sensitive display); a mouse; a keyboard; a visual input device (e.g., one or more cameras (e.g., an infrared camera, a depth camera, a visible light camera, and/or a gaze tracking camera)); a motion sensor (e.g., an accelerometer and/or a gyroscope); and/or one or more mechanical input devices (e.g., a depressible input mechanism; a button; a rotatable input mechanism; a crown; and/or a dial)). Some operations in method 800 are, optionally, combined, the orders of some operations are, optionally, changed, and some operations are, optionally, omitted.

As described below, method 800 provides an intuitive way for displaying stacks of widgets. The method reduces the cognitive burden on a user for accessing widgets of the stacks of widgets, thereby creating a more efficient human-machine interface. For battery-operated computing devices, enabling a user to manage stacks of widgets faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Providing improved feedback (such as by displaying multiple stacks of widgets in response to a user input) enhances the operability of the device by reducing accidental and mistaken inputs, reducing energy usage by the device.

The computer system (e.g., 600A) displays (802), via the one or more display generation components (e.g., 602A), a map user interface (e.g., 606 at FIGS. 6B, 6K, and/or 6V).

While displaying the map user interface (e.g., 606), the computer system (e.g., 600A) detects (804), via the one or more input devices (e.g., 602A), a user input (e.g., 650B at FIG. 6B, 650N at FIG. 6K, and/or 650Z at FIG. 6V) (e.g., a touch input and/or a voice command). In some embodiments, the user input is a touch input that does not include lift-off of the touch during the input. In some embodiments, the user input is a swipe gesture (e.g., a horizontal swipe gesture). In some embodiments, the user input is a tap input.

In response to detecting the user input (e.g., 650B at FIG. 6B, 650N at FIG. 6K, and/or 650Z at FIG. 6V) and in accordance with a determination that the user input corresponds to a first type of request (e.g., a request to display widgets, a request to access a user interface that is to the left of the home screen, and/or a request to concurrently display information from multiple applications that updates over time), the computer system (e.g., 600A) replaces display (806), via the one or more display generation components (e.g., 602A), of the map user interface (e.g., 606) with a widgets user interface (e.g., 608 at FIGS. 6C and/or 6W), wherein the widgets user interface (e.g., 608) includes (e.g., concurrent display of) a plurality of (e.g., two, three, or more) stacks of widgets, including a first stack of widgets (e.g., 618) that includes a first plurality of widgets and a second stack of widgets (e.g., 628) that includes a second plurality of widgets that are different from the first plurality of widgets.

While displaying the widgets user interface (e.g., 608) that includes the plurality of stacks of widgets (e.g., 618 and/or 628), the computer system (e.g., 600A) detects (808), via the one or more input devices (e.g., 602A), a user input (e.g., 650E-650J, 650AB, and/or 650AA) directed to a respective stack of widgets of the plurality of stacks of widgets.

In response (810) to detecting the user input directed to a respective stack of widgets of the plurality of stacks of widgets and in accordance with a determination that the user input directed to the respective stack of widgets is directed to the first stack of widgets (e.g., 618), the computer system (e.g., 600A) updates display (812), via the one or more display generation components (e.g., 602A), of the first stack of widgets (e.g., 618 at FIGS. 6C-6D) from a first widget (e.g., 618A at FIG. 6C) of the first stack of widgets to a second widget (e.g., 618B at FIG. 6D) of the first stack of widgets (e.g., 618) (e.g., based on an arrangement and/or order of widgets in the first stack of widgets) without updating display of the second stack of widgets (e.g., 628) from a first widget of the second stack of widgets to a second widget of the second stack of widgets.

In response (810) to detecting the user input directed to a respective stack of widgets of the plurality of stacks of widgets and in accordance with a determination that the user input directed to the respective stack of widgets is directed to the second stack of widgets (e.g., 628), the computer system (e.g., 600A) updates display (814), via the one or more display generation components (e.g., 602A), of the second stack of widgets (e.g., 628 at FIGS. 6F-6G) from the first widget (e.g., 628A at FIG. 6F) of the second stack of widgets to the second widget (e.g., 628B at FIG. 6G) of the second stack of widgets (e.g., based on an arrangement and/or order of widgets in the second stack of widgets) without updating display of the first stack of widgets (e.g., 618) from the first widget of the first stack of widgets to the second widget of the first stack of widgets.

In some embodiments, in response to detecting the user input and in accordance with a determination that the user input corresponds to a second type of request (e.g., 650M and/or 650O at FIG. 6K) (e.g., a request to display application icons and/or a request to access a user interface that is to the right of the home screen) that is different from the first type of request, the computer system (e.g., 600A) replaces display, via the one or more display generation components (e.g., 602A), of the map user interface (e.g., 606) with an application icon user interface (e.g., 604), wherein the application icon user interface (e.g., 604) includes (e.g., concurrent display of) a plurality of (e.g., two, three, or more) application icons (e.g., 604A-604C), including a first application icon (e.g., 604A) corresponding to a first application and a second application icon (e.g., 604B) corresponding to a second application that is different from the first application.

In some embodiments, the user input (e.g., 650O at FIG. 6K) that corresponds to the second type of request is an input directed to (e.g., touch input on) a respective object (e.g., 610E) that is displayed. In some embodiments, the map user interface (e.g., 606) includes an indication (e.g., circle inside 606 at FIG. 6K) of a current location (e.g., of a vehicle in which the one or more display generation components are integrated) on a map. In some embodiments, the map user interface includes a map of the current location. In some embodiments, the map user interface (e.g., 606 at FIG. 6K) includes navigation information (e.g., driving directions to a destination).

In some embodiments, the user input (e.g., 650B and/or 650N) that corresponds to the first type of request is a swipe input (e.g., a horizontal swipe input and/or a vertical swipe input). In some embodiments, the swipe input is on the map user interface (e.g., 606). In some embodiments, the input is on a map (e.g., 606A) of the map user interface (e.g., 606). In some embodiments, the user input that corresponds to the first type of request is not based on an orientation of the one or more display generation components, is not based on a change in orientation of a device of the computer system, and/or is not based on whether a device of the computer system is charging.

In some embodiments, the user input (e.g., 650E-650J, 650AB, and/or 650AA) directed to the respective stack of widgets of the plurality of stacks of widgets is a swipe input (e.g., a touch swipe input and/or air swipe gesture) directed to the respective stack of widgets. In some embodiments, the swipe input is a vertical swipe input (e.g., downward and/or upwards).

In some embodiments, replacing display, via the one or more display generation components (e.g., 602A), of the map user interface (e.g., 606) with the widgets user interface (e.g., 608) includes ceasing to display, via the one or more display generation components (e.g., 602A), the map user interface (e.g., 606).

In some embodiments, while displaying the widgets user interface (e.g., 608) that includes the plurality of stacks of widgets (e.g., 618 and/or 628), the computer system (e.g., 600A) detects, via the one or more input devices (e.g., 602A), a user interface navigation user input (e.g., 650K and/or 650L) (e.g., a horizontal air gesture and/or a swipe input, such as a left swipe input). In response to detecting the user interface navigation user input (e.g., 650K and/or 650L), the computer system (e.g., 600A) replaces display, via the one or more display generation components (e.g., 602A), of the widgets user interface (e.g., 608 at FIG. 6J) with the map user interface (e.g., 606 at FIG. 6K).

In some embodiments, widgets of the first stack of widgets (e.g., 618) are user-customizable (e.g., computer system receives selection of what widgets to include in the first stack and in what order) and widgets of the second stack of widgets (e.g., 628) are user-customizable (e.g., computer system receives selection of what widgets to include in the second stack and in what order). In some embodiments, the stacks of widgets are modified and/or customized using the process described above with respect to FIG. 7 (e.g., method 700).

In some embodiments, a first respective widget (e.g., 618A) of the first stack of widgets (e.g., 628) displays information that corresponds to (e.g., is received from) a first respective application and a second respective widget (e.g., 618B) of the first stack of widgets (e.g., 628) displays information that corresponds to (e.g., is received from) a second respective application that is different from the first respective application. In some embodiments, respective widgets of the second stack of widgets display information that correspond to (e.g., is received from) respective applications of the computer system. In some embodiments, display contents of widgets are updated over time with information from corresponding respective applications.

Note that details of the processes described above with respect to method 800 (e.g., FIG. 8) are also applicable in an analogous manner to the methods described above and below. For example, methods 700, 900, and 1100 optionally includes one or more of the characteristics of the various methods described above with reference to method 800. For brevity, these details are not repeated below.

FIGS. 9A-9B are a flow diagram illustrating methods of managing media playback, in accordance with some embodiments. Method 900 is performed at a computer system (e.g., 100, 300, 500, 600A, and/or 600B) (e.g., a smart phone, a smart watch, a tablet computer, a laptop computer, a desktop computer, a wearable device, and/or a head-mounted device) that is in communication with a first set of one or more display generation components (e.g., 602B) (e.g., one or more displays, one or more touch-screen displays, one or more monitors, a holographic display system, one or more transparent displays, and/or a head-mounted display system) and one or more input devices (e.g., 602B) (e.g., a touch-sensitive surface (e.g., as part of a touch-sensitive display); a mouse; a keyboard; a visual input device (e.g., one or more cameras (e.g., an infrared camera, a depth camera, a visible light camera, and/or a gaze tracking camera)); a motion sensor (e.g., an accelerometer and/or a gyroscope); and/or one or more mechanical input devices (e.g., a depressible input mechanism; a button; a rotatable input mechanism; a crown; and/or a dial)). Some operations in method 900 are, optionally, combined, the orders of some operations are, optionally, changed, and some operations are, optionally, omitted.

As described below, method 900 provides an intuitive way for managing media playback. The method reduces the cognitive burden on a user for managing media playback, thereby creating a more efficient human-machine interface. For battery-operated computing devices, enabling a user to manage media playback faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Providing improved feedback (such as by providing indications that media can be streamed to a secondary display, such as display 602A) enhances the operability of the device by reducing accidental and mistaken inputs, reducing energy usage by the device.

The computer system (e.g., 600B) detects (e.g., 902), via the one or more input devices (e.g., 602B), a request (e.g., 650AF1 and/or 650AF2) (e.g., a tap input on an icon corresponding to an application and/or voice instructions to a digital assistant of the computer system) to display a user interface of a respective application (e.g., of a phone of the computer system). In some embodiments, in response to detecting the request to display the user interface of the respective application the computer system opens and/or starts the respective application.

In response (904) to detecting the request to display the user interface of the respective application, the computer system (e.g., 600B) displays (906), via the first set of one or more display generation components (e.g., 602B), a user interface (e.g., 680 and/or 682) of the respective application.

In response (904) to detecting the request (e.g., 650AF2) to display the user interface of the respective application and in accordance with a determination that a set of one or more criteria is met, including a display criterion that is met when the computer system (e.g., 600B) is in communication with a second set of one or more display generation components (e.g., 602A) (e.g., one or more external displays, one or more displays (such as integrated into a vehicle), one or more touch-screen displays (such as integrated into a vehicle), one or more monitors, a holographic display system, one or more transparent displays, and/or a head-mounted display system) that are different from the first set of one or more display generation components (e.g., 602B), the computer system (e.g., 600B) displays (908), via the first set of one or more display generation components (e.g., 602B), an eligibility indication (e.g., 690A and/or 690B at FIG. 6AB) that indicates that visual media (e.g., videos, movies, and/or animated images) of the respective application are eligible to be displayed via the second set of one or more display generation components (e.g., 602A).

In response (904) to detecting the request (e.g., 650AF1) to display the user interface of the respective application and in accordance with a determination that the set of one or more criteria is not met (e.g., the display criterion is not met because the computer system is not in communication with a second set of one or more display generation components and/or other criterion of the set of one or more criteria are not met), the computer system (e.g., 600B) forgoes (910) display, via the first set of one or more display generation components (e.g., 602B), of the eligibility indication (e.g., as in FIG. 6AA).

While displaying, via the first set of one or more display generation components (e.g., 600B), the eligibility indication (e.g., 690A and/or 690B), the computer system (e.g., 600B) detects (912) a request (e.g., 650AG at FIG. 6AB) (e.g., based on a user input detected via the one or more input devices, a received signal, a detected trigger, and/or a detected event) to initiate playback of a first visual media using the respective application.

In response (914) to detecting the request (e.g., 650AG) to initiate playback of the first visual media using the respective application, the computer system (e.g., 600B) displays (916), via the first set of one or more display generation components (e.g., 602B), playback of visual content (e.g., 682B at FIG. 6AC) of the first visual media (e.g., playing the video, movie, and/or animated image) using the respective application (e.g., and without displaying, via the second set of one or more display generation components, playback of visual content of the first visual media).

In response (914) to detecting the request (e.g., 650AG) to initiate playback of the first visual media using the respective application, the computer system (e.g., 600B) displays (918), via the first set of one or more display generation components (e.g., 602B) (e.g., concurrently with and/or before playback of the visual media), a playback indication (e.g., 690C), different from the eligibility indication(e.g., 690A and/or 690B), that indicates that playback of the visual content the first visual media can be displayed via the second set of one or more display generation components (e.g., 602A).

While displaying, via the first set of one or more display generation components (e.g., 602B), the playback indication (e.g., 690C), the computer system (e.g., 600B) detects (920), via the one or more input devices (e.g., 602B), an input (e.g., 650AH) (e.g., a touch input, a tap input, an air gesture, and/or a gaze) directed to the playback indication (e.g., 690C).

In response (922) to detecting the input directed to the playback indication, the computer system (e.g., 600B) ceases (924) to display, via the first set of one or more display generation components (e.g., 602B), playback of the visual content (e.g., 682B) of the first visual media (e.g., as shown in FIG. 6AD) and displays (926), via the second set of one or more display generation components (e.g., 602A), playback of the visual content (e.g., 684E as in FIG. 6AD) of the first visual media (e.g., starting from the beginning of the first visual media or continuing from where playback of the first visual media was ceased at the first set of one or more display generation components).

In some embodiments, the set of one or more criteria includes a form criterion that is met when the respective application (e.g., as shown in FIG. 6AB) is configured to play long-form videos. In some embodiments, the respective application is configured to play long-form videos when the respective application provides options for playing videos that are long-form videos. In some embodiments, long-form videos are videos that have a playback duration of more than a threshold amount of time, such as more than 1 minute, more than 2 minutes, and/or more than 5 minutes. In some embodiments, the form criterion is not met (and, therefore, the set of one or more criteria is not met) when the respective application that is not configured to play long-form videos (e.g., does not play videos and/or plays only videos that are short-form videos). In some embodiments, short-form videos are videos that have a playback duration of less than the threshold amount of time, such as less than 1 minute, less than 2 minutes, and/or less than 5 minutes.

In some embodiments, the set of one or more criteria includes a status criterion that is met when a vehicle status (e.g., the vehicle into which the second set of one or more displays is integrated and/or installed into) is a first status (e.g., vehicle status indicates that video playback is approved by the vehicle, vehicle status indicates that the vehicle is parked and/or not moving, vehicle status indicates that the vehicle is in a safe situation for video playback). In some embodiments, the computer system receives the vehicle status from the vehicle. In some embodiments, the status criterion is not met (and, therefore, the set of one or more criteria is not met) when the computer system determines that the status of the vehicle is not safe for playback of video at the second set of one or more display generation components. In some embodiments, the second set of one or more display generation components (e.g., one or more displays) are integrated into a vehicle. In some embodiments, a display generation component of the second set of one or more display generation components is integrated into a dashboard of the vehicle.

In some embodiments, while displaying, via the second set of one or more display generation components (e.g., 602A), playback of the visual content (e.g., 684E) of the first visual media using the respective application, the computer system (e.g., 600B) detects that the set of one or more criteria is not met (e.g., ceases to be met and/or is no longer met). In response to detecting that the set of one or more criteria is not met, the computer system (e.g., 600B) ceases to display, via the second set of one or more display generation components (e.g., 602A), playback of the visual content of the first visual media (e.g., stop playing the video and/or pause the video).

In some embodiments, in response to detecting that the set of one or more criteria is not met, the computer system (e.g., 600B) displays, via the first set of one or more display generation components (e.g., 602B), playback of visual content of the first visual media (e.g., playing the video, movie, and/or animated image) using the respective application. In some embodiments, the computer system continues the playback of the visual content of the first visual media continues via the first set of one or more display generation components based on an elapsed playback time (e.g., from the elapsed playback time and/or a few seconds before the elapsed playback time) at which the visual content of the first visual media ceased playback via the second set of one or more display generation components.

In some embodiments, while displaying, via the first set of one or more display generation components (e.g., 602B), playback of visual content (e.g., 682B at FIG. 6AC) of the first visual media (e.g., playing the video, movie, and/or animated image) using the respective application (e.g., in response to detecting the request to initiate playback of the first visual media using the respective application), the computer system (e.g., 600B) outputs, via one or more speakers of a vehicle, audio content (e.g., 686 at FIG. 6AC) of the first visual media. In some embodiments, the speakers and the second set of one or more display generation components are integrated into and/or are installed in the same vehicle. In some embodiments, while the video visually plays using the first set of one or more display generation components (e.g., a display of a phone and/or a display of a headset), the audio of the video is output using speakers of the vehicle (and, optionally, not using speakers of the phone and/or speakers of the headset).

In some embodiments, in response to detecting the input (e.g., 650AH at FIG. 6AC) directed to the playback indication (e.g., 690C), the computer system (e.g., 600B) continues outputting, via one or more speakers of the vehicle, audio content (e.g., 686 at FIG. 6AD) of the first visual media. In some embodiments, when the video visually switches to playing using the second set of one or more display generation components (and continues to play using the second set of one or more display generation components), the audio of the video continues to be output using the speakers of the vehicle (and, optionally, not using speakers of the phone and/or speakers of the headset).

In some embodiments, while displaying, via the second set of one or more display generation components (e.g., 602A), playback of the visual content (e.g., 684E) of the first visual media using the respective application, the computer system (e.g., 600B) displays, via the first set of one or more display generation components (e.g., 602B), playback controls (e.g., 682C at FIG. 6AD) (e.g., pause, play, fast-forward, and/or rewind) for controlling playback of the visual content (e.g., 684E) of the first visual media on the second set of one or more display generation components. In some embodiments, the computer system detects an input directed to the playback controls displayed at the first set of one or more display generation components and, in response, controls playback of the first visual media on the second set of one or more display generation components.

In some embodiments, while displaying, via the second set of one or more display generation components (e.g., 602A), playback of the visual content (e.g., 684E at FIG. 6AD) of the first visual media using the respective application: the computer system (e.g., 600B) displays, via the first set of one or more display generation components (e.g., 602B), a second playback indication (e.g., 690A and/or 690B at FIG. 6AD and/or 690D at FIG. 6AE) (e.g., that is the same as or different from the first playback indication). In some embodiments, the second playback indication is displayed in response to detecting the input directed to the playback indication and/or in conjunction with displaying, via the second set of one or more display generation components, playback of the visual content of the first visual media. The computer system (e.g., 600B) detects, via the one or more input devices, a set of one or more inputs (e.g., 650AJ at FIG. 6AD and/or 650AK at FIG. 6AE) (e.g., a touch input, a tap input, and/or an air gesture) directed to the second playback indication. In response to detecting the set of one or more inputs directed to the second playback indication: the computer system (e.g., 600B) ceases to display, via the second set of one or more display generation components (e.g., 602A), playback of the visual content of the first visual media (e.g., as in FIG. 6AF) and displays, via the first set of one or more display generation components (e.g., 602B), playback of the visual content (e.g., 682B at FIG. 6AF) of the first visual media (e.g., starting from the beginning of the first visual media or continuing from where playback of the first visual media was ceased at the second set of one or more display generation components). In some embodiments, in response to detecting a first input of the set of one or more inputs, the computer system changes one or more visual properties of the second playback indication (e.g., changes a size of the second playback indication, enlarges the second playback indication, and/or displays text on to the second playback indication) and in response to detecting a second input (e.g., after the first input) of the set of one or more inputs, the computer system ceases to display, via the second set of one or more display generation components, playback of the visual content of the first visual media and displays, via the first set of one or more display generation components, playback of the visual content of the first visual media. In some embodiments, the first input and/or the second input are a tap input and/or an air gesture. In some embodiments, move display of the playback of the visual content of the first visual media back to the second set of one or more display generation components from the first set of one or more display generation components, the computer system detects an input on the first playback indication and/or an input directed to a video option (e.g., that says “Show Video”) display on the second set of one or more display generation components.

In some embodiments, in response to detecting the set of one or more inputs directed to the second playback indication, the computer system (e.g., 600B) continues outputting, via one or more speakers of a vehicle, audio content (e.g., 686 at FIG. 6AF) of the first visual media. In some embodiments, when the video visually switches to playing using the first set of one or more display generation components (and continues to play using the first set of one or more display generation components), the audio of the video continues to be output using the speakers of the vehicle (and, optionally, not using speakers of the phone and/or speakers of the headset).

Note that details of the processes described above with respect to method 900 (e.g., FIGS. 9A-9B) are also applicable in an analogous manner to the methods described above and below. For example, methods 700, 800, and 1100 optionally includes one or more of the characteristics of the various methods described above with reference to method 900. For brevity, these details are not repeated below.

FIGS. 10A-10P illustrate exemplary user interfaces for accessing event notifications, in accordance with some embodiments. The user interfaces in these figures are used to illustrate the processes described below, including the processes in FIG. 11.

FIG. 10A illustrates computer system 600A, which includes display 602A. In some embodiments, computer system 600A is integrated into a vehicle, such as a car or truck. In some embodiments, display 602A is integrated into a dashboard or console of the vehicle, such as in the center console. FIG. 10A also illustrates computer system 600B, which includes touch-sensitive display 602B. In some embodiments, computer system 600B is not integrated into a vehicle, and/or is not integrated into a dashboard or console of the vehicle. In some embodiments, computer system 600A and computer system 600B are separate computer systems. In some embodiments, computer system 600A and computer system 600B are part of the same computer system.

At FIG. 10A, computer system 600B displays, via touch-sensitive display 602B, navigation user interface 1000. In some embodiments, navigation user interface 1000 displays one or more navigation instructions for navigating to a destination (e.g., Bloom Coffee & Kitchen). At FIG. 10A, computer system 600B also displays live activity representation 1001. In some embodiments, live activity representation 1001 displays information pertaining to a live activity that provides time-sensitive updates to a current and/or ongoing event. In some embodiments, a live activity provides time-sensitive updates for a live and/or ongoing event of a limited time duration, such that live activity representations and/or live activities are not meant to be permanent user interface fixtures, and are only displayed during the time-limited duration of the live and/or ongoing event. For example, in various embodiments, live activities can include updates pertaining to an ongoing sporting event, an ongoing weather event, a currently active timer and/or alarm, a delivery (e.g., a food delivery and/or package that is out for delivery), a current ride and/or ride request for a ride hailing application, and/or a current workout session. In FIG. 10A, live activity representation 1001 displays the score for a current sporting event. Additionally, at FIG. 10A, computer system 600A is off and/or display 602A is off. In some embodiments, a vehicle that includes computer system 600A is off. At FIG. 10A, a user provides user input 1004 via start button 1002 to turn computer system 600A and/or a vehicle that includes computer system 600A on.

At FIG. 10B, computer system 600A and/or a vehicle that includes computer system 600A has been turned on, and display 602A is turned on. Additionally, at FIG. 10B, computer system 600B detects that one or more criteria for displaying content via display 602A (e.g., in some embodiments, via communication with computer system 600A) are satisfied. In some embodiments, the determination that the one or more criteria for displaying content via display 602A have been satisfied includes one or more of the following: a determination that computer system 600B is connected with computer system 600A; a determination that computer system 600A and/or a vehicle that includes computer system 600A has been turned on; a determination that computer system 600A and/or that computer system 600B has received one or more user inputs corresponding to a user request to display content of computer system 600B via display 602A; and/or a determination that computer system 600B is configured to automatically display content via display 602A when display 602A is turned on and/or is connected to and/or is in communication with computer system 600B.

At FIG. 10B, based on a determination that the one or more criteria for displaying content via display 602A have been satisfied, computer system 600B causes display 602A (e.g., in some embodiments, via communication with computer system 600A) to display dock 610 (various embodiments and features of which were described above) and user interface 1006. In some embodiments, computer system 600A causes display 602A to display user interface 1006. In some embodiments, computer system 600A causes display 602A to display user interface 1006 based on information received from computer system 600B, such that both computer system 600A and computer system 600B cause display 602A to display user interface 1006. In the depicted embodiments, user interface 1006 is a dashboard user interface that includes user interface 1008, navigation options 1010A, media playback options 1010B, and live activity representation 1010C. User interface 1008 is a navigation user interface that is provided by computer system 600B for display on display 602A. Navigation options 1010A include one or more pre-set navigation destinations for the user of computer system 600B based on user-specific information stored in computer system 600B. Media playback options 1010B include controls for controlling playback of media that is provided by computer system 600B to computer system 600A. In the scenario shown in FIG. 10B, live activity representation 1010C corresponds to live activity representation 1001, and is included in user interface 1006 based a live activity being active on computer system 600B.

FIGS. 10C-10D depict an alternative scenario in which computer system 600B does not have an active and/or ongoing live activity when it is connected to display 602A. At FIG. 10C, computer system 600B displays navigation user interface 1000, but does not display live activity representation 1001 and does not have an active and/or ongoing live activity. At FIG. 10C, a user provides user input 1014 via start button 1002 to turn computer system 600A and/or a vehicle that includes computer system 600A on. At FIG. 10D, computer system 600A and/or a vehicle that includes computer system 600A has been turned on, and display 602A is turned on, and computer system 600B detects that one or more criteria for displaying content via display 602A are satisfied. At FIG. 10D, based on the determination that the one or more criteria for displaying content via display 602A have been satisfied, computer system 600B and/or computer system 600A causes display 602A (e.g., in some embodiments, via communication with computer system 600A) to display dock 610 and user interface 1006. User interface 1006 in FIG. 10D is the same as user interface 1006 in FIG. 10C, except for the fact that user interface 1006 in FIG. 10D does not include live activity representation 1010C because computer system 600B in FIG. 10D does not have an active and/or ongoing live activity. Additionally, in FIG. 10D, media playback options 1010B occupy a greater area of user interface 1006, for example, based on user interface 1006 not include live activity representation 1010C and/or another user interface object in the bottom right corner of user interface 1006. At FIG. 10D, computer system 600B (or, in some embodiments, computer system 600A) detects user input 1016, which is a spoken input asking about the score of the Barcelona game. While FIGS. 10D-10P do not explicitly show computer system 600B, it should be understood that in these figures, computer system 600B continues to be connected to and/or in communication with computer system 600A and/or display 602A.

At FIG. 10E, in response to detecting user input 1016, computer system 600B and/or computer system 600A causes display 602A to display overlay 1018. Overlay 1018 displays the score and remaining time of the requested sporting event, and also includes option 1018A to follow the live sporting event (e.g., to follow the live activity and/or to create a live activity representation for the live sporting event). At FIG. 10E, computer system 600A detects user input 1020 (e.g., a touch input) corresponding to selection of option 1018A. In some embodiments, computer system 600B receives an indication of user input 1020 and/or detects user input 1020 based on communications with touch-sensitive display 602A and/or computer system 600A.

At FIG. 10F, in response to user input 1020, computer system 600B and/or computer system 600A causes display 602A to display live activity representation 1010C, which provides real-time and/or time-sensitive updates for the live activity (e.g., the ongoing sporting event). In some embodiments, in response to user input 1020, computer system 600B also displays, via touch-sensitive display 602B, live activity representation 1001, as was depicted above in FIG. 10B. In FIG. 10F, media playback options 1010B are decreased in size to accommodate live activity representation 1010C. At FIG. 10F, computer system 600A detects user input 1022 (e.g., a touch input) corresponding to selection of live activity representation 1010C. In some embodiments, computer system 600B detects user input 1022 based on communications with touch-sensitive display 602A and/or computer system 600A.

At FIG. 10G, in response to user input 1020, computer system 600B and/or computer system 600A causes display 602A to display user interface 1024, which includes options 1024a-1024d. Option 1024a, when selected, causes computer system 600B and/or computer system 600A to remove live activity representation 1010C from user interface 1006. Option 1024b, when selected, causes computer system 600B and/or computer system 600A to turn off automatic display of sports-related live activities via display 602A. For example, in FIGS. 10A-10B described above, had sported-related live activities been disabled from being displayed via display 602A, in FIG. 10B, user interface 1006 would not include live activity representation 1010C despite the live activity (e.g., represented by live activity representation 1001) being active on computer system 600B. In this way, a user is able to disable certain categories of live activities (e.g., sporting events, weather events, navigation events, delivery events, rideshare events, and/or timer events) from being displayed and/or automatically displayed via display 602A. In some embodiments, when option 1024b is selected, other categories of live activities (e.g., non-sporting event live activities) continue to be enabled for display on display 602A. Option 1024c, when selected, causes computer system 600B and/or computer system 600A to display (e.g., via display 602A), a full screen user interface corresponding to live activity representation 1010C (e.g., corresponding to the live activity represented by live activity representation 1010C). Option 1024d, when selected, causes computer system 600B and/or computer system 600A to cease display of user interface 1024 on display 602A. At FIG. 10G, computer system 600A detects user input 1026 (e.g., a touch input) corresponding to selection of option 1024c. In some embodiments, computer system 600B detects user input 1026 based on communications with touch-sensitive display 602A and/or computer system 600A.

At FIG. 10H, in response to user input 1026, computer system 600B and/or computer system 600A causes display 602A to display user interface 1028. User interface 1028 includes score information 1028A for the sporting event live activity represented by live activity representation 1010C. In FIG. 10H, user interface 1028 also includes play-by-play update information 1028B for the sporting event. As mentioned above, in some embodiments, computer system 600A and/or display 602A are integrated into a vehicle. In some embodiments, play-by-play update information 1028B is displayed while the vehicle that includes computer system 600A and/or display 602A is not in motion and/or is not being drive, but is not displayed while the vehicle is in motion and/or is being driven (e.g., so as not to distract the driver). At FIG. 10I, computer system 600A and/or computer system 600B detects that the vehicle is in motion, and computer system 600A and/or computer system 600B causes display 602A to cease display of play-by-play update information 1028B. At FIG. 10I, computer system 600A detects user input 1030 (e.g., a touch input) corresponding to selection of icon 610A in dock 610. In some embodiments, computer system 600B detects user input 1030 based on communications with touch-sensitive display 602A and/or computer system 600A.

At FIG. 10J, in response to user input 1030, computer system 600B and/or computer system 600A causes display 602A to display navigation user interface 1032. In the depicted embodiment, navigation user interface 1032 is a full screen user interface, and does not include live activity representation 1010C (and/or navigation options 1010A and/or media playback options 1010B). However, in FIG. 10J, dock 610 is displayed with indication 1031 to indicate that a live activity is currently being followed and/or is currently in progress. At FIG. 10K, computer system 600B and/or computer system 600A receives an update pertaining to the ongoing live activity (e.g., a final score). In response to receiving the update pertaining to the ongoing live activity, computer system 600B and/or computer system 600A causes display 602A to display overlay 1034, which displays information pertaining to the update to the ongoing live activity.

FIG. 10L depicts an alternative embodiment of user interface 1032 and dock 610, in which live activity representations are displayed concurrently with user interface 1032. In FIG. 10L, display 602A displays (e.g., based on instructions from computer system 600A and/or computer system 600B) user interface 1032 concurrently with live activity representation 1036A and live activity representation 1036B. Live activity representation 1036A corresponds to a weather-related live activity, indicating that it will begin raining in 38 minutes. Live activity representation 1036B corresponds to a sporting event in which the score is 1-0. At FIG. 10L, computer system 600A detects user input 1038 (e.g., a touch input) corresponding to selection of live activity representation 1038A. In some embodiments, computer system 600B detects user input 1038 based on communications with touch-sensitive display 602A and/or computer system 600A.

At FIG. 10M, in response to user input 1038, computer system 600B and/or computer system 600A causes display 602A to display user interface 1040, which displays additional information and/or more detailed information about the weather-related live activity (e.g., displaying how much rain is expected in each two-minute interval for the next forty minutes).

FIGS. 10N-10P depict an example embodiment in which live activity representation 1010C is automatically replaced in user interface 1006 based on detection of one or more higher-priority events. At FIG. 10N, computer system 600A and/or computer system 600B causes display 602A to display user interface 1006, as described above, including live activity representation 1010C. In FIG. 10N, live activity representation 1010C indicates that the sporting event has concluded, with a final score of 1-0. In some embodiments, computer system 600A and/or computer system 600B causes display 602A to automatically cease display of live activity representation 1010C after a threshold amount of time has passed after the live activity and/or the live event (e.g., the sporting event) is concluded. In some embodiments, live activity representation 1010C continues to be displayed until the user manually clears live activity representation 1010C and/or until display 602A is turned off and/or disconnected from computer system 600A.

At FIG. 10O, computer system 600B and/or computer system 600A detects that computer system 600B and/or computer system 600A (or, in some embodiments, a vehicle that includes computer system 600A) is within a threshold distance of a point of interest (e.g., the user’s home). At FIG. 10O, based on a determination that computer system 600B and/or computer system 600A is within a threshold distance of the point of interest, computer system 600A and/or computer system 600B causes display 602A to replace display of live activity representation 1010C with option 1010D. In the depicted embodiments, option 1010D is a garage door option that, when selected, causes computer system 600A, computer system 600B, and/or a vehicle that includes computer system 600A to open the garage door of the home of the user. In this way, option 1010D is a location-specific option that is automatically displayed when computer system 600A, computer system 600B, and/or a vehicle that includes computer system 600A is within a threshold distance of the user’s home.

At FIG. 10P, computer system 600B detects that the current time is within a threshold amount of time from a scheduled calendar event (e.g., the current time is within one hour of a scheduled team lunch at 11:30). Based on this determination, computer system 600A and/or computer system 600B causes display 602A to replace display of live activity representation 1010C with reminder notification 1010E, which indicates that a scheduled calendar event is coming up soon (e.g., in the next hour).

FIG. 11 is a flow diagram illustrating a method for accessing event notifications using a computer system in accordance with some embodiments. Method 1100 is performed at a computer system (e.g., 100, 300, 500, and/or 600B) (e.g., a smart phone, a smart watch, a tablet, a laptop, a desktop, a wearable device, and/or head-mounted device) that is in communication with one or more display generation components (e.g., 602B) (e.g., a visual output device, a 3D display, a display having at least a portion that is transparent or translucent on which images can be projected (e.g., a see-through display), a projector, a heads-up display, and/or a display controller). In some embodiments, the computer system is, optionally, in communication with one or more input devices (e.g., 602A and/or 602B) (e.g., a touch-sensitive surface (e.g., a touch-sensitive display); a mouse; a keyboard; a remote control; a visual input device (e.g., one or more cameras (e.g., an infrared camera, a depth camera, a visible light camera, and/or a gaze tracking camera)); an audio input device; a biometric sensor (e.g., a fingerprint sensor, a face identification sensor, a gaze tracking sensor, and/or an iris identification sensor) one or more mechanical input devices (e.g., a depressible input mechanism; a button; a rotatable input mechanism; a crown; and/or a dial); and/or one or more light sensors). Some operations in method 1100 are, optionally, combined, the orders of some operations are, optionally, changed, and some operations are, optionally, omitted.

As described below, method 1100 provides an intuitive way for accessing event notifications. The method reduces the cognitive burden on a user for accessing event notifications, thereby creating a more efficient human-machine interface. For battery-operated computing devices, enabling a user to access event notifications faster and more efficiently conserves power and increases the time between battery charges.

The computer system (e.g., 600B) displays (1102), via the one or more display generation components (e.g., 602B), first content (e.g., 1000 and/or 1001). While displaying the first content via the one or more display generation components (e.g., 602B) (1104), the computer system (e.g., 600B) detects (1106) that a first set of criteria for displaying content via a first external display (e.g., 602A) is satisfied, wherein the first external display (e.g., 602A) is separate from the computer system (e.g., 600B) and the one or more display generation components (e.g., 602B). In some embodiments, the first external display (e.g., 602A) is part of a separate computer system (e.g., 600A) separate from the computer system (e.g., 600B). In some embodiments, the first external display (e.g., 602A) is part of a center console and/or a media console of a vehicle. In some embodiments, the first external display (e.g., 602A) is integrated into a vehicle, is in wired communication with a vehicle (e.g., a vehicle computer system), and/or is in wireless communication with a vehicle (e.g., a vehicle computer system). In some embodiments, the one or more display generation components (e.g., 602B) are integrated into the computer system (e.g., 600B) and/or are contained in a housing of the computer system (e.g., 600B), while the first external display (e.g., 602A) is not integrated into the computer system (e.g., 600B) and/or is not contained within the housing of the computer system (e.g., 600B). In response to detecting that the first set of criteria for displaying content via the first external display (e.g., 602A) is satisfied (e.g., 1108), the computer system (e.g., 600B) causes (1110) the first external display (e.g., 602A) to display a first user interface (e.g., 1006 and/or 1008) from the computer system (e.g., 600B) (e.g., a first user interface that is defined by the computer system, a first user interface that is generated by the computer system, and/or a first user interface that is specified by the computer system), including: in accordance with a determination that an activity of a first type (e.g., a time-based activity, an activity with constant, periodic, and/or frequent updates, a task, a live event, an external event, an internal event, a user-initiated action, an action with updates at a predetermined frequency, an action with updates at regular intervals, and/or an action with updates at irregular intervals) is in progress on the computer system (e.g., live activity representation 1001) (1112) (e.g., a timer is counting down, an alarm has been snoozed, a recommendation has been suggested, a workout is in progress, navigation is in progress, tracking with a compass is in progress, a phone call is in

progress, a voice memo is in progress, tracking a sporting event is in progress, a ride is in progress, a delivery is in progress, and/or tracking progress toward a destination is in progress) (e.g., at the time of detecting that the first set of criteria for display content via the first external display are satisfied and/or at the time of causing the first external display to display the first user interface from the computer system), the computer system (e.g., 600B) causes (1114) the first external display (e.g., 602A) to display the first user interface (e.g., 1008) concurrently with a representation of the activity of the first type (e.g., 1010C) (in FIG. 10B); and in accordance with a determination that an activity of the first type is not in progress on the computer system (e.g., 600B in FIG. 10C and FIG. 10D) (1116) (e.g., at the time of detecting that the first set of criteria for display content via the first external display are satisfied and/or at the time of causing the first external display to display the first user interface from the computer system), the computer system (e.g., 600B) causes (1118) the first external display (e.g., 602A) to display the first user interface (e.g., 1008) without displaying the representation of the activity of the first type (e.g., FIG. 10D). In some embodiments, the representation of the activity of the first type (e.g., 1010C) includes important, useful, and/or time-sensitive information regarding the activity of the first type. In some embodiments, an activity of a first type can include, but is not limited to, timer activities, navigation/map direction activities, phone or videoconference activities, ride-sharing activities, and/or delivery (e.g., of food and/or packages) activities. In some embodiments, an activity of a first type is an activity that includes frequent content and/or status updates. In some embodiments, an activity of a first type receives content and/or updates at a rate and/or of a volume that would be inefficient and/or ineffective to present via a push notification system (e.g., because doing so would generate too many notifications in a short span of time and/or because doing so would consume large amounts of system resources (e.g., battery power)). In some embodiments, an activity of a first type is referred to as an ongoing activity. In some embodiments, the first user interface includes first respective content that is representative of the first content and/or that corresponds to the first content. Performing an operation when a set of conditions has been met without requiring further user input (such as by automatically causing the first external display to display a representation of the activity of the first type when an activity of a first type is in progress on the computer system or forgoing causing the first external display to display a representation of the activity of the first type when an activity of the first type is not in progress on the computer system) enhances the operability of

the device by reducing unnecessary inputs and/or steps to navigate through different user interfaces or sets of controls, reducing energy usage by the device.

In some embodiments, the first external display (e.g., 602A) is integrated into a vehicle. In some embodiments, the first external display is part of a center console and/or a media console of a vehicle. In some embodiments, the first external display is integrated into a vehicle, is in wired communication with a vehicle (e.g., a vehicle computer system), and/or is in wireless communication with a vehicle (e.g., a vehicle computer system). Performing an operation when a set of conditions has been met without requiring further user input (such as by automatically causing the first external display to display a representation of the activity of the first type when an activity of a first type is in progress on the computer system or forgoing causing the first external display to display a representation of the activity of the first type when an activity of the first type is not in progress on the computer system) enhances the operability of the device by reducing unnecessary inputs and/or steps to navigate through different user interfaces or sets of controls, reducing energy usage by the device.

In some embodiments, the computer system (e.g., 600B) displays, via the one or more display generation components (e.g., 602B), a first representation of the activity of the first type (e.g., 1001) (e.g., a representation that is indicative of the activity of the first type being active and/or in progress on the computer system; and/or a representation that displays live activity information and/or information pertaining to the activity of the first type that is updated in real-time and/or that is updated as additional information about the activity of the first type is received); and while displaying the first representation of the activity of the first type (e.g., 1001) via the one or more display generation components (e.g., 602B), the computer system (e.g., 600B) causes the first external display (e.g., 602A) to display the representation of the activity of the first type (e.g., 1010C) (e.g., FIG. 10B) (e.g., a representation of the activity of the first type that is different from or the same as the first representation of the activity of the first type). In some embodiments, the computer system (e.g., 600B) displays, via the one or more display generation components (e.g., 602B), a first representation of the activity of the first type (e.g., 1001) while also causing the first external display (e.g., 602A) to display a representation of the activity of the first type (e.g., 1010C). Performing an operation when a set of conditions has been met without requiring further user input (such as by automatically causing the first external display to display a representation of the activity of the first type when an activity of a first type is in progress on the computer system or forgoing causing the first external display to display a representation of the activity of the first type when an activity of the first type is not in progress on the computer system) enhances the operability of the device by reducing unnecessary inputs and/or steps to navigate through different user interfaces or sets of controls, reducing energy usage by the device.

In some embodiments, displaying the first representation of the activity of the first type (e.g., 1001) comprises displaying the representation of the activity of the first type within a lock screen user interface that is indicative of the computer system being in a locked state (e.g., in some embodiments, representation 1001 is displayed within and/or concurrently with a lock screen user interface rather than user interface 1000 shown in FIG. 10B) (e.g., a locked state in which user authentication information (e.g., biometric authentication information and/or passcode-based authentication information) is required to transition the computer system to an unlocked state). Performing an operation when a set of conditions has been met without requiring further user input (such as by automatically causing the first external display to display a representation of the activity of the first type when an activity of a first type is in progress on the computer system or forgoing causing the first external display to display a representation of the activity of the first type when an activity of the first type is not in progress on the computer system) enhances the operability of the device by reducing unnecessary inputs and/or steps to navigate through different user interfaces or sets of controls, reducing energy usage by the device.

In some embodiments, causing the first external display (e.g., 602A) to display the first user interface (e.g., 1008) comprises causing the first external display to display the first user interface (e.g., 1008) without displaying information pertaining to the first user interface (e.g., without displaying the first user interface and/or a version of the first user interface) on the one or more display generation components (e.g., 602B) (e.g., in some embodiments, display 602A displays user interface 1008 while computer system 600B and/or display 602B displays a different user interface (e.g., other than navigation user interface 1000) and/or does not display any content). In some embodiments, the computer system causes the first external display to display the first user interface without displaying the first user interface (and/or information pertaining to the first user interface) via the one or more display generation components. Performing an operation when a set of conditions has been met without requiring further user input (such as by automatically causing the first external display to display a representation of the activity of the first type when an activity of a first type is in progress on the computer system or forgoing causing the first external display to display a representation of the activity of the first type when an activity of the first type is not in progress on the computer system) enhances the operability of the device by reducing unnecessary inputs and/or steps to navigate through different user interfaces or sets of controls, reducing energy usage by the device.

In some embodiments, while the first user interface is displayed (e.g., 1008) on the first external display (e.g., 602A), the computer system (e.g., 600B) detects, via one or more input devices that are in communication with the computer system, a first verbal input (e.g., 1016) (e.g., a first spoken input, a first audio input, and/or a first input that includes one or more spoken and/or audible words) corresponding to a user request to display information pertaining to a second activity of the first type (e.g., a time-based activity, an activity with constant, periodic, and/or frequent updates, a task, a live event, an external event, an internal event, a user-initiated action, an action with updates at a predetermined frequency, an action with updates at regular intervals, and/or an action with updates at irregular intervals) (e.g., in some embodiments, a second activity of the first type that is not in progress and/or that is not active on the computer system at the time of receiving the first verbal input). In response to detecting the first verbal input, the computer system (e.g., 600A) causes the first external display (e.g., 602A) to display information pertaining to the second activity of the first type (e.g., 1018). Providing additional control options (such as by allowing a user to access information via spoken input) without cluttering the UI with additional displayed controls enhances the operability of the device by reducing unnecessary inputs and/or steps to navigate through different user interfaces or sets of controls, reducing energy usage by the device.

In some embodiments, the information pertaining to the second activity of the first type (e.g., 1018) is overlaid on the first user interface (e.g., 1008) (e.g., overlays and/or obscures at least a portion of the first user interface). Providing additional control options (such as by allowing a user to access information via spoken input) without cluttering the UI with additional displayed controls enhances the operability of the device by reducing unnecessary inputs and/or steps to navigate through different user interfaces or sets of controls, reducing energy usage by the device.

In some embodiments, while the information pertaining to the second activity of the first type (e.g., 1018) is displayed overlaid on the first user interface (e.g., 1008) on the first external display (e.g., 602A), the computer system (e.g., 600B) detects, via the one or more input devices (e.g., 602A and/or 602B), one or more user inputs (e.g., 1020) (e.g., one or more touch inputs, one or more spoken inputs, one or more hardware control inputs, and/or one or more gesture inputs) corresponding to a user request to continue receiving updates pertaining to the second activity of the first type (e.g., a user request to follow the second activity of the first type). In response to detecting the one or more user inputs (e.g., 1020) corresponding to a user request to continue receiving updates pertaining to the second activity of the first type, the computer system (e.g., 600B) causes the first external display (e.g., 602A) to: cease displaying the information pertaining to the second activity of the first type (e.g., 1018) overlaid on the first user interface (e.g., 1008); and display a representation of the second activity of the first type (e.g., 1010C) concurrently with the first user interface (e.g., 1008) and that is not overlaid on the first user interface (e.g., FIG. 10F). Providing additional control options (such as by allowing a user to access information via spoken input) without cluttering the UI with additional displayed controls enhances the operability of the device by reducing unnecessary inputs and/or steps to navigate through different user interfaces or sets of controls, reducing energy usage by the device.

In some embodiments, the first external display (e.g., 602A) is a touch-sensitive display; and detecting the one or more user inputs corresponding to a user request to continue receiving updates pertaining to the second activity of the first type comprises receiving an indication of one or more touch inputs (e.g., 1020) detected at the first external display (e.g., 602A) corresponding to a user request to continue receiving updates pertaining to the second activity of the first type (e.g., one or more touch inputs at the first external display corresponding to user selection of one or more displayed objects displayed by the first external display). Providing additional control options (such as by allowing a user to access information via spoken input and/or allowing the user to provide user inputs via the first external display) without cluttering the UI with additional displayed controls enhances the operability of the device by reducing unnecessary inputs and/or steps to navigate through different user interfaces or sets of controls, reducing energy usage by the device.

In some embodiments, in response to detecting the one or more user inputs (e.g., 1020) corresponding to a user request to continue receiving updates pertaining to the second activity of the first type, the computer system (e.g., 600B) causes the first external display (e.g., 602A) to: resize a first displayed object (e.g., 1010B in FIGS. 10E-10F) to accommodate the representation of the second activity of the first type (e.g., 1010C) (e.g., display a first displayed object at a smaller size to accommodate the representation of the second activity of the first type; and/or decrease the size of a first displayed object, and display the representation of the second activity of the first type in a display region that was at least partially occupied by the first displayed object prior to detecting the one or more user inputs). Providing additional control options (such as by allowing a user to access information via spoken input) without cluttering the UI with additional displayed controls enhances the operability of the device by reducing unnecessary inputs and/or steps to navigate through different user interfaces or sets of controls, reducing energy usage by the device.

In some embodiments, while the first user interface (e.g., 1008) and the representation of the activity of the first type (e.g., 1010C) are concurrently displayed on the first external display (e.g., 602A), the computer system (e.g., 600B) detects, via one or more input devices (e.g., 602A and/or 602B) that are in communication with the computer system, one or more user inputs (e.g., user input 1030, and/or selection of icon 610A in FIG. 10B and/or FIG. 10F) (e.g., one or more touch inputs, one or more spoken inputs, one or more hardware control inputs, and/or one or more gesture inputs) corresponding to a user request to display a first application user interface (e.g., 1032) via the first external display (e.g., 602A) (e.g., in some embodiments, a first application user interface that pertains to and/or is generated by an application that is installed on and/or running on the computer system). In response to detecting the one or more user inputs corresponding to a user request to display the first application user interface via the first external display (e.g., 602A), the computer system (e.g., 600B) causes the first external display (e.g., 602A) to: cease display of the first user interface (e.g., 1008) and the representation of the activity of the first type (e.g., 1010C); and display the first application user interface (e.g., 1032) without displaying the representation of the activity of the first type (e.g., 1010C) (e.g., in some embodiments, from FIG. 10F and/or FIG. 10B, selection of icon 610A in dock 610 would result in the state shown in FIG. 10J). Performing an operation when a set of conditions has been met without requiring further user input (such as by automatically causing the first external display to display a representation of the activity of the first type when an activity of a first type is in progress on the computer system or forgoing causing the first external display to display a representation of the activity of the first type when an activity of the first type is not in progress on the computer system) enhances the operability of the device by reducing unnecessary inputs and/or steps to navigate through different user interfaces or sets of controls, reducing energy usage by the device.

In some embodiments, in response to detecting the one or more user inputs corresponding to a user request to display the first application user interface (e.g., 1032) via the first external display (e.g., 602A), the computer system (e.g., 600B) causes the first external display (e.g., 602A) to display, concurrently with the first application user interface (e.g., 1032), an indication (e.g., 1031, 1036A, and/or 1036B) that the activity of the first type is ongoing (e.g., is still active; and/or is still being followed), wherein the indication that the activity of the first type is ongoing excludes at least a subset of information about the activity of the first type that was included in the representation of the activity of the first type (e.g., 1010C). Providing improved feedback (such as by displaying an indication of an ongoing activity of the first type) enhances the operability of the device by reducing accidental and mistaken inputs, reducing energy usage by the device.

In some embodiments, while causing the first external display (e.g., 602A) to concurrently display the first application user interface (e.g., 1032) and the indication that the activity of the first type is ongoing (e.g., 1031, 1036A, and/or 1036B), the computer system detects, via the one or more input devices (e.g., 602A and/or 602B) that are in communication with the computer system (e.g., 600B), one or more user inputs (e.g., 1038 and/or selection of indication 1031) (e.g., one or more touch inputs, one or more spoken inputs, one or more hardware control inputs, and/or one or more gesture inputs) corresponding to selection of the indication that the activity of the first type is ongoing. In response to detecting the one or more user inputs corresponding to selection of the indication that the activity of the first type is ongoing, the computer system (e.g., 600B) causes the first external display (e.g., 602A) to display a first window (e.g., 1040) (e.g., a first banner and/or a first overlay) overlaid on the first application user interface (e.g., 1032) (e.g., a first window that at least partially overlays and/or obscures the first application user interface), wherein the first window displays information pertaining to the activity of the first type that is not displayed in the indication (e.g., 1031, 1036A, and/or 1036B) that the activity of the first type is ongoing. In some embodiments, selection of indication 1031 in FIG. 10J causes display of an overlay that includes additional information about the live activity, such as overlay 1034 in FIG. 10K. Providing improved feedback (such as by displaying an indication of an ongoing activity of the first type) enhances the operability of the device by reducing accidental and mistaken inputs, reducing energy usage by the device.

In some embodiments, while causing the first external display (e.g., 602A) to concurrently display the first application user interface (e.g., 1032) and the indication (e.g., 1031) that the activity of the first type is ongoing, the computer system (e.g., 600B) receives updated information pertaining to the activity of the first type (e.g., receiving one or more updates and/or new information pertaining to the activity of the first type). In response to receiving the updated information pertaining to the activity of the first type, the computer system (e.g., 600B) causes the first external display (e.g., 602A) to display a second window (e.g., 1034) (e.g., a banner, a notification, and/or an overlay) that displays an indication of the updated information pertaining to the activity of the first type. In some embodiments, the second window overlays and/or at least partially overlays the first application user interface. In some embodiments, the second window displays information pertaining to the activity of the first type that is not displayed in the indication that the activity of the first type is ongoing. Providing improved feedback (such as by displaying an indication of an ongoing activity of the first type) enhances the operability of the device by reducing accidental and mistaken inputs, reducing energy usage by the device.

In some embodiments, subsequent to causing the first external display (e.g., 602A) to display the second window (e.g., 1034): in accordance with a determination that a threshold duration of time has elapsed after causing the first external display to display the second window (e.g., the second window has been displayed for a threshold duration of time) (e.g., 3 seconds, 5 seconds, 10 seconds, 20 seconds, or 30 seconds), the computer system (e.g., 600B) causes the first external display (e.g., 602A) to cease display of the second window (e.g., 1034) (e.g., automatically and/or without user input). Providing improved feedback (such as by displaying an indication of an ongoing activity of the first type) enhances the operability of the device by reducing accidental and mistaken inputs, reducing energy usage by the device. Performing an operation when a set of conditions has been met without requiring further user input (such as by automatically ceasing display of the second window) enhances the operability of the device by reducing unnecessary inputs and/or steps to navigate through different user interfaces or sets of controls, reducing energy

In some embodiments, while the second window (e.g., 1034) is displayed on the first external display (e.g., 602A), the computer system (e.g., 600B) detects, via the one or more input devices (e.g., 602A and/or 602B), one or more user inputs (e.g., one or more touch inputs, one or more spoken inputs, one or more hardware control inputs, and/or one or more gesture inputs) corresponding to a user request to cease display of the second window (e.g., a swipe up input on touch-sensitive display 602A in FIG. 10K). In response to detecting the one or more user inputs corresponding to a user request to cease display of the second window, the computer system (e.g., 600B) causes the first external display (e.g., 602A) to cease display of the second window (e.g., 1034). Providing improved feedback (such as by displaying an indication of an ongoing activity of the first type) enhances the operability of the device by reducing accidental and mistaken inputs, reducing energy usage by the device.

In some embodiments, while the first user interface (e.g., 1008) and the representation of the activity of the first type (e.g., 1010C) are displayed on the first external display (e.g., 602A), the computer system (e.g., 600B) detects, via one or more input devices (e.g., 602A and/or 602B) that are in communication with the computer system (e.g., 600B), one or more user inputs (e.g.,1022) (e.g., one or more touch inputs, one or more spoken inputs, one or more hardware control inputs, and/or one or more gesture inputs) corresponding to selection of the representation of the activity of the first type (e.g., 1010C). In response to detecting the one or more user inputs corresponding to selection of the representation of the activity of the first type, the computer system (e.g., 600B) causes the first external display (e.g., 602A) to display a clear option (e.g., 1024a) that, when selected, causes the computer system (e.g., 600B) to initiate a process for ceasing display of the representation of the activity of the first type (e.g., 1010C) on the first external display (e.g., 602A) (e.g., in some embodiments, while display of the first user interface on the first external display is maintained). In some embodiments, the clear option, when selected, causes the computer system to cause the first external display to cease display of the representation of the first type. In some embodiments, while displaying the clear option, the computer system detects one or more user inputs corresponding to selection of the clear option; and in response to detecting the one or more user inputs corresponding to selection of the clear option, the computer system causes the first external display to cease display of the representation of the activity of the first type (e.g., in some embodiments, while display of the first user interface on the first external display is maintained). Performing an operation when a set of conditions has been met without requiring further user input (such as by automatically causing the first external display to display a representation of the activity of the first type when an activity of a first type is in progress on the computer system or forgoing causing the first external display to display a representation of the activity of the first type when an activity of the first type is not in progress on the computer system) enhances the operability of the device by reducing unnecessary inputs and/or steps to navigate through different user interfaces or sets of controls, reducing energy usage by the device.

In some embodiments, the activity of the first type belongs to a first category (e.g., sports updates, delivery updates, logistics updates, navigation updates, fitness updates, news, updates, timer updates, calendar updates, stopwatch updates and/or media consumption updates) of activities of the first type (e.g., a first category of a plurality of categories of activities of the first type). In some embodiments, in response to detecting the one or more user inputs (e.g., 1022) corresponding to selection of the representation of the activity of the first type (e.g., 1010C), the computer system (e.g., 600B) causes the first external display (e.g., 602A) to display (e.g., concurrently with the clear option) a disable option (e.g., 1024b) that, when selected, causes the computer system to initiate a process for disabling automatic display of the first category of activities of the first type via external displays (e.g., in some embodiments, via vehicle displays) (e.g., in some embodiments, while maintaining and/or continuing to enable automatic display of a second category of activities of the first type via external displays). In some embodiments, the disable option, when selected, causes the computer system to disable automatic display of the first category of activities of the first type via external displays (e.g., in some embodiments, while maintaining and/or continuing to enable automatic display of a second category of activities of the first type via external displays). In some embodiments, the disable option, when selected, causes the computer system to cause the first external display to cease display of the representation of the first type. Performing an operation when a set of conditions has been met without requiring further user input (such as by automatically causing the first external display to display a representation of the activity of the first type when an activity of a first type is in progress on the computer system or forgoing causing the first external display to display a representation of the activity of the first type when an activity of the first type is not in progress on the computer system) enhances the operability of the device by reducing unnecessary inputs and/or steps to navigate through different user interfaces or sets of controls, reducing energy usage by the device.

In some embodiments, while a third activity of the first type is in progress on the computer system (e.g., FIG. 10A, as indicated by representation 1001), wherein the third activity of the first type belongs to the first category of activities of the first type, the computer system detects that the first set of criteria for displaying content via a first external display (e.g., 602A) is satisfied. In response to detecting that the first set of criteria for displaying content via the first external display (e.g., 602A) is satisfied, the computer system (e.g., 600B) causes the first external display (e.g., 602A) to display a second user interface (e.g., 1008) from the computer system (e.g., a second user interface that is defined by the computer system, a second user interface that is generated by the computer system, and/or a second user interface that is specified by the computer system) (e.g., a second user interface that is the same as or different from the first user interface), including: in accordance with a determination that automatic display of the first category of activities of the first type via external displays is not disabled (e.g., in some embodiments, is enabled), causing the first external display to display the first user interface (e.g., 1008) concurrently with a representation of the third activity of the first type (e.g., 1010C); and in accordance with a determination that automatic display of the first category of activities of the first type via external displays is disabled (e.g., in some embodiments, is not enabled), causing the first external display to display the first user interface without displaying the representation of the third activity of the first type (e.g., FIG. 10D). Performing an operation when a set of conditions has been met without requiring further user input (such as by automatically causing the first external display to display a representation of the activity of the first type when an activity of a first type is in progress on the computer system or forgoing causing the first external display to display a representation of the activity of the first type when an activity of the first type is not in progress on the computer system) enhances the operability of the device by reducing unnecessary inputs and/or steps to navigate through different user interfaces or sets of controls, reducing energy usage by the device.

In some embodiments, while the first user interface (e.g., 1008) and the representation of the activity of the first type (e.g., 1010C) are concurrently displayed on the first external display (e.g., 602A), the computer system (e.g., 600B) detects that a first event satisfies one or more display criteria (e.g., FIG. 10O and/or FIG. 10P). In response to detecting that the first event satisfies the one or more display criteria, the computer system (e.g., 600B) causes the first external display (e.g., 602A) to: cease display of the representation of the activity of the first type (e.g., 1010C) (e.g., FIG. 10O and/or FIG. 10P); and display a representation of the first event (e.g., 1010D and/or 1010E) (e.g., in some embodiments, replace display of the representation of the activity of the first type with display of a representation of the first event). Performing an operation when a set of conditions has been met without requiring further user input (such as by automatically replacing a lower priority event representation with a higher priority event representation) enhances the operability of the device by reducing unnecessary inputs and/or steps to navigate through different user interfaces or sets of controls, reducing energy usage by the device.

In some embodiments, the first event is a location-based event pertaining to a first location (e.g., FIG. 10O); and detecting that the first event satisfies one or more display criteria comprises a determination that the computer system is within a threshold distance of the first location (e.g., within 2 miles, within one mile, or within half a mile) (e.g., FIG. 10O). In some embodiments, the representation of the first event (e.g., 1010D) includes information and/or one or more selectable options pertaining to the first location. Performing an operation when a set of conditions has been met without requiring further user input (such as by automatically replacing a lower priority event representation with a higher priority event representation) enhances the operability of the device by reducing unnecessary inputs and/or steps to navigate through different user interfaces or sets of controls, reducing energy usage by the device.

In some embodiments, the first event is a time-based event pertaining to a first scheduled time (e.g., a first date and/or time; and/or a first scheduled event) (e.g., FIG. 10P); and detecting that the first event satisfies one or more display criteria comprises a determination that a current time is within a threshold time of the first scheduled time (e.g., the current time is within one hour, 30 minutes, 15 minutes 10 minutes, or 5 minutes of the first scheduled time) (e.g., FIG. 10P). In some embodiments, the representation of the first event (e.g., 1010E) includes information and/or one or more selectable options pertaining to the first scheduled time. Performing an operation when a set of conditions has been met without requiring further user input (such as by automatically replacing a lower priority event representation with a higher priority event representation) enhances the operability of the device by reducing unnecessary inputs and/or steps to navigate through different user interfaces or sets of controls, reducing energy usage by the device.

In some embodiments, while the representation of the first event (e.g., 1010D and/or 1010E) is displayed on the first external display (e.g., 602A), the computer system (e.g., 600B) detects that the first event no longer satisfies the one or more display criteria. In response to detecting that the first event no longer satisfies the one or more display criteria, the computer system (e.g., 600B) causes the first external display (e.g., 602A) to: cease display of the representation of the first event (e.g., 1010D and/or 1010E); and display the representation of the activity of the first type (e.g., 1010C) (e.g., in some embodiments, replace display of the representation of the first event with display of the representation of the activity of the first type). Performing an operation when a set of conditions has been met without requiring further user input (such as by automatically replacing a lower priority event representation with a higher priority event representation) enhances the operability of the device by reducing unnecessary inputs and/or steps to navigate through different user interfaces or sets of controls, reducing energy usage by the device.

In some embodiments, while the first user interface (e.g., 1008) and the representation of the activity of the first type (e.g., 1010C) are concurrently displayed on the first external display (e.g., 602A), the computer system (e.g., 600B) detects, via one or more input devices (e.g., 602A) that are in communication with the computer system, one or more user inputs (e.g., 1022 and/or 1026) (e.g., one or more touch inputs, one or more spoken inputs, one or more hardware control inputs, and/or one or more gesture inputs) corresponding to a user request to expand the representation of the activity of the first type (e.g., a user request to display a larger user interface that pertains to the activity of the first type). In response to detecting the one or more user inputs corresponding to a user request to expand the representation of the activity of the first type, the computer system (e.g., 600B) causes the first external display (e.g., 602A) to display an activity user interface (e.g., 1028) that pertains to the activity of the first type, wherein the activity user interface (e.g., 1028) is larger than (e.g., occupies a greater display area than) the representation of the activity of the first type (e.g., 1010C). In some embodiments, the activity user interface is a full screen user interface. In some embodiments, the activity user interface includes at least a portion of the information (e.g., 1028A) that is displayed in the representation of the activity of the first type (e.g., 1010C). In some embodiments, the activity user interface includes information (e.g., 1028B) pertaining to the activity of the first type that is not displayed in the representation of the activity of the first type (e.g., 1010C). Performing an operation when a set of conditions has been met without requiring further user input (such as by automatically causing the first external display to display a representation of the activity of the first type when an activity of a first type is in progress on the computer system or forgoing causing the first external display to display a representation of the activity of the first type when an activity of the first type is not in progress on the computer system) enhances the operability of the device by reducing unnecessary inputs and/or steps to navigate through different user interfaces or sets of controls, reducing energy usage by the device.

In some embodiments, the first external display (e.g., 602A) is integrated into a vehicle; and causing the first external display to display the activity user interface (e.g., 1028) further comprises: in accordance with a determination that the vehicle is moving (e.g., the vehicle is being driven), causing the first external display to display a first set of information (e.g., 1028A) pertaining to the activity of the first type within the activity user interface (e.g., 1028 in FIG. 10I); and in accordance with a determination that the vehicle is not moving (e.g., the vehicle is not being driven), causing the first external display to display a second set of information (e.g., 1028A and/or 1028B) pertaining to the activity of the first type within the activity user interface (e.g., 1028), wherein the second set of information is different from the first set of information, and includes at least some information that is not included in the first set of information (e.g., 1028 in FIG. 10H). In some embodiments, the activity user interface includes more information when the vehicle is not moving, and includes less information when the vehicle is moving. Performing an operation when a set of conditions has been met without requiring further user input (such as by automatically displaying less information when it is determined that the user is driving and/or a vehicle is moving) enhances the operability of the device by reducing unnecessary inputs and/or steps to navigate through different user interfaces or sets of controls, reducing energy usage by the device.

Note that details of the processes described above with respect to method 1100 (e.g., FIG. 11) are also applicable in an analogous manner to the methods described above. For example, methods 700, 800, and 900 optionally includes one or more of the characteristics of the various methods described above with reference to method 1100. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve access and display of information. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user’s health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to have calculated control of the delivered content. Further, other uses for personal information data that benefit the user are also contemplated by the present disclosure. For instance, health and fitness data may be used to provide insights into a user’s general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of displaying content on secondary displays, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A computer system that is configured to communicate with a first set of one or more display generation components and one or more input devices, the computer system comprising:
one or more processors; and
memory storing one or more programs configured to be executed by the one or more processors, the one or more programs including instructions for:
displaying, via the first set of one or more display generation components, a widget editing user interface that includes one or more options corresponding to a first stack of widgets and one or more options corresponding to a second stack of widgets, wherein a configuration of the first stack of widgets specifies an arrangement of the first stack of widgets when the first stack of widgets is displayed via a second set of one or more display generation components that is different from the first set of one or more display generation components, and wherein a configuration of the second stack of widgets, different from the configuration of the first stack of widgets, specifies an arrangement of the second stack of widgets when the second stack of widgets is displayed via the second set of one or more display generation components;
while displaying the widget editing user interface, detecting, via the one or more input devices, a first set of one or more inputs;
in response to detecting the first set of one or more inputs, modifying the configuration of the first stack of widgets to specify a modified arrangement of the first stack of widgets;
while displaying the widget editing user interface, detecting, via the one or more input devices, a second set of one or more inputs;
in response to detecting the second set of one or more inputs, modifying the configuration of the second stack of widgets to specify a modified arrangement of the second stack of widgets; and
subsequent to detecting the first set of one or more inputs and the second set of one or more inputs, concurrently displaying, via the second set of one or more display generation components, the first stack of widgets using the modified arrangement of the first stack of widgets and the second stack of widgets using the modified arrangement of the second stack of widgets.

2. The computer system of claim 1, wherein the one or more programs further include instructions for:
prior to detecting, via the one or more input devices, the first set of one or more inputs, displaying, via the second set of one or more display generation components, the first stack of widgets using the arrangement of the first stack of widgets and the second stack of widgets using the arrangement of the second stack of widgets.

3. The computer system of claim 1, wherein modifying the configuration of the first stack of widgets to specify the modified arrangement of the first stack of widgets includes adding a respective widget to the first stack of widgets.

4. The computer system of claim 1, wherein modifying the configuration of the first stack of widgets to specify the modified arrangement of the first stack of widgets includes removing a respective widget from the first stack of widgets.

5. The computer system of claim 1, wherein modifying the configuration of the first stack of widgets to specify the modified arrangement of the first stack of widgets includes changing an order of widgets of the first stack of widgets.

6. The computer system of claim 1, wherein displaying, via the first set of one or more display generation components, the widget editing user interface that includes one or more options corresponding to the first stack of widgets includes displaying, via the first set of one or more display generation components, a first object corresponding to a first widget of the first stack of widgets and a second object corresponding to a second widget of the first stack of widgets.

7. The computer system of claim 1, wherein the one or more programs further include instructions for:
detecting a change in a widget suggestion option; and
in response to detecting the change in the widget suggestion option:
in accordance with a determination that the widget suggestion option is enabled:
modifying the configuration of the first stack of widgets to specify an arrangement of the first stack of widgets that includes a first suggested widget; and
modifying the configuration of the second stack of widgets to specify an arrangement of the second stack of widgets that includes a second suggested widget that is different from the first suggested widget; and
in accordance with a determination that the widget suggestion option is enabled:
modifying the configuration of the first stack of widgets to specify an arrangement of the first stack of widgets that excludes the first suggested widget; and
modifying the configuration of the second stack of widgets to specify an arrangement of the second stack of widgets that excludes the second suggested widget.

8. The computer system of claim 1, wherein the second set of one or more display generation components are integrated into a vehicle.

9. The computer system of claim 1, wherein widgets of the first stack of widgets have a same first display size and widgets of the second stack of widgets have a same second display size.

10. The computer system of claim 9, wherein the first display size and the second display size are a same size.

11. The computer system of claim 1, wherein the one or more programs further include instructions for:
detecting an end of a drive of a vehicle in which the second set of one or more display generation components is integrated; and
in response to detecting the end of the drive of the vehicle, displaying, via the first set of one or more display generation components, a notification corresponding to the widget editing user interface.

12. The computer system of claim 1, wherein:
a first respective widget of the first stack of widgets displays information that corresponds to a first respective application; and
a second respective widget of the first stack of widgets displays information that corresponds to a second respective application that is different from the first respective application.

13. A non-transitory computer-readable storage medium storing one or more programs configured to be executed by one or more processors of a computer system that is in communication with a first set of one or more display generation components and one or more input devices, the one or more programs including instructions for:
displaying, via the first set of one or more display generation components, a widget editing user interface that includes one or more options corresponding to a first stack of widgets and one or more options corresponding to a second stack of widgets, wherein a configuration of the first stack of widgets specifies an arrangement of the first stack of widgets when the first stack of widgets is displayed via a second set of one or more display generation components that is different from the first set of one or more display generation components, and wherein a configuration of the second stack of widgets, different from the configuration of the first stack of widgets, specifies an arrangement of the second stack of widgets when the second stack of widgets is displayed via the second set of one or more display generation components;
while displaying the widget editing user interface, detecting, via the one or more input devices, a first set of one or more inputs;
in response to detecting the first set of one or more inputs, modifying the configuration of the first stack of widgets to specify a modified arrangement of the first stack of widgets;
while displaying the widget editing user interface, detecting, via the one or more input devices, a second set of one or more inputs;
in response to detecting the second set of one or more inputs, modifying the configuration of the second stack of widgets to specify a modified arrangement of the second stack of widgets; and
subsequent to detecting the first set of one or more inputs and the second set of one or more inputs, concurrently displaying, via the second set of one or more display generation components, the first stack of widgets using the modified arrangement of the first stack of widgets and the second stack of widgets using the modified arrangement of the second stack of widgets.

14. A method, comprising:
at a computer system, wherein the computer system is in communication with a first set of one or more display generation components and one or more input devices:
displaying, via the first set of one or more display generation components, a widget editing user interface that includes one or more options corresponding to a first stack of widgets and one or more options corresponding to a second stack of widgets, wherein a configuration of the first stack of widgets specifies an arrangement of the first stack of widgets when the first stack of widgets is displayed via a second set of one or more display generation components that is different from the first set of one or more display generation components, and wherein a configuration of the second stack of widgets, different from the configuration of the first stack of widgets, specifies an arrangement of the second stack of widgets when the second stack of widgets is displayed via the second set of one or more display generation components;
while displaying the widget editing user interface, detecting, via the one or more input devices, a first set of one or more inputs;
in response to detecting the first set of one or more inputs, modifying the configuration of the first stack of widgets to specify a modified arrangement of the first stack of widgets;
while displaying the widget editing user interface, detecting, via the one or more input devices, a second set of one or more inputs;
in response to detecting the second set of one or more inputs, modifying the configuration of the second stack of widgets to specify a modified arrangement of the second stack of widgets; and
subsequent to detecting the first set of one or more inputs and the second set of one or more inputs, concurrently displaying, via the second set of one or more display generation components, the first stack of widgets using the modified arrangement of the first stack of
widgets and the second stack of widgets using the modified arrangement of the second stack of widgets.
